(19) United States
(12) Patent Application Publication
(10) Pub. No.: US 2025/0355471 A1
(43) Pub. Date: Nov. 20, 2025

(54) ELECTRONIC DEVICE

(71) Applicants: K-TRONICS (SUZHOU) TECHNOLOGY CO., LTD., Suzhou, Jiangsu (CN); BOE Technology Group Co., Ltd., Beijing (CN)

(72) Inventors: Hui XING, Beijing (CN); Cheng ZHANG, Beijing (CN); Chenxiang LI, Beijing (CN); Zhongcai DONG, Beijing (CN); Zhe WANG, Beijing (CN); Lei GUO, Beijing (CN); Gang SUN, Beijing (CN)

(21) Appl. No.: 18/995,225

(22) PCT Filed: May 5, 2023
(86) PCT No.: PCT/CN2023/092373

§ 371 Date: Jan. 16, 2025

(51) Int. Cl. G06F 1/16

(52) U.S. Cl. CPC G06F 1/1677; G06F 1/1686

(57) ABSTRACT

Disclosed is an electronic device, comprising: a camera module, which comprises a camera and a first connector, the first connector comprising first to M-th connecting contacts, wherein M is an integer; a display apparatus, which comprises a second connector, the second connector comprising first to N-th connecting pins, wherein N is an integer, and N≥1; and a detection control circuit, which is connected to the second connector, and is configured to determine in response to the first to M-th connecting contacts being mounted onto a-th to (a+M−1)th connecting pins among the first to N-th connecting pins that the camera is mounted onto the display apparatus in a front-facing manner, and to determine in response to the M-th to first connecting contacts being mounted onto b-th to (b+M−1)th connecting pins among the first to N-th connecting pins that the camera is mounted onto the display apparatus in a rear-facing manner.

### CROSS REFERENCE TO RELATED APPLICATIONS

This application is a national phase entry under 35 U.S.C. § 371 of International Application No. PCT/CN2023/092373, filed on May 5, 2023, the entire content of which is incorporated herein by reference.

### TECHNICAL FIELD

The disclosure relates to the field of display technology, and in particular to an electronic device.

### BACKGROUND

As the technology continues to advance and people's standard of living continues to be improved, most homes are equipped with electronic devices with display functions, such as computers and the like. However, most of the cameras on electronic devices are fixed in position. For example, the camera is set in a part of space at the top of the display screen of the electronic device. Although the camera can be made relatively thin and narrow, but together with the supporting structure of the camera, the space it occupies still causes the display screen to be difficult to be made to achieve the effect of extremely narrow bezel at three sides, which affects the user's experience of using the device.

### SUMMARY

Embodiments of the disclosure provide an electronic device, including:
a camera module, including a camera and a first connector, where the first connector includes a 1^{st} connection contact to an M^{th} connection contact, and M is an integer and M≥1;
a display device, including a second connector, where the second connector includes a 1^{st} connection pin to an N^{th} connection pin, and N is an integer and N≥1; and
a detection control circuit, connected with the second connector, and configured to:
in response to that the 1^{st} connection contact to the M^{th} connection contact are mounted to an a^{th} connection pin to an (a+M−1)^{th} connection pin of the 1^{st} connection pin to the N^{th} connection pin, determine that the camera is forward-mounted to the display device; and
in response to that the M^{th} connection contact to the 1^{st} connection contact are mounted to the b^{th} connection pin to the (b+M−1)^{th} connection pin of the 1^{st} connection pin to the N^{th} connection pin, determine that the camera is reverse-mounted to the display device; wherein a is an integer and 1≤a≤N, and b is an integer and 1≤b≤N.

In some possible embodiments, the detection control circuit is further configured to:
obtain a camera detection signal;
based on determining that the camera detection signal is a forward access detection signal, determine that the 1^{st} connection contact to the M^{th} connection contact are mounted to the a^{th} connection pin to the (a+M−1)^{th} connection pin; and
based on determining that the camera detection signal is a reverse access detection signal, determine that the M^{th} connection contact to the 1^{st} connection contact are mounted to the b^{th} connection pin to the (b+M−1)^{th} connection pin.

In some possible embodiments, M=N and the detection control circuit includes: a logic controller, and a gating circuit; where
the logic controller is configured to: obtain the camera detection signal, output a first mode configuration signal based on determining that the camera detection signal is the forward access detection signal, and output a second mode configuration signal based on determining that the camera detection signal is the reverse access detection signal; and
the gating circuit is connected with the logic controller and the 1^{st} connection pin to the N^{th} connection pin, respectively, and is configured to:
receive the first mode configuration signal, and in response to the first mode configuration signal, provide a camera power supply voltage to the a^{th} connection pin and connect the (a+M−1)^{th} connection pin with a ground terminal; and
receive the second mode configuration signal, and in response to the second mode configuration signal, provide the camera power supply voltage to the (b+M−1)^{th} connection pin and connect the b^{th} connection pin with the ground terminal.

In some possible embodiments, the gating circuit is further configured to:
in response to the first mode configuration signal, connect the (a+1)^{th} connection pin to the (a+M−2)^{th} connection pin with an image data transmission terminal; and
in response to the second mode configuration signal, connect the (b+1)^{th} connection pin to the (b+M−2)^{th} connection pin with the image data transmission terminal.

In some possible embodiments, the image data transmission terminal includes: a first differential signal transmission terminal and a second differential signal transmission terminal;
N=4, and the gating circuit is further configured to:
in response to the first mode configuration signal, provide the camera power supply voltage to the 1^{st} connection pin, establish a conducting path between the 2^{nd} connection pin and the first differential signal transmission terminal, establish a conducting path between the 3^{rd} connection pin and the second differential signal transmission terminal, and connect the 4^{th} connection pin with the ground terminal; and
in response to the second mode configuration signal, provide the camera power supply voltage to the 4^{th} connection pin, establish a conducting path between the 2^{nd} connection pin and the second differential signal transmission terminal, establish a conducting path between the 3^{rd} connection pin and the first differential signal transmission terminal, and connect the 1^{st} connection pin with the ground terminal.

In some possible embodiments, the camera module further includes a first wireless communication component, and the camera module sends captured image data via the first wireless communication component.

In some possible embodiments, the gating circuit includes: a multiplexer and a first switch circuit;
the logic controller is further configured to output a voltage output enable signal;
the first switch circuit is connected with the logic controller and the multiplexer, respectively, and is configured to: receive the voltage output enable signal, and in response to the voltage output enable signal, provide a camera power supply voltage to the multiplexer; and
the multiplexer is connected with the logic controller and the 1^{st} connection pin to the N^{th} connection pin, respectively, and is configured to:
receive the first mode configuration signal; and in response to the first mode configuration signal, provide the camera power supply voltage to the a^{th} connection pin, connect the (a+1)^{th} connection pin to the (a+M−2)^{th} connection pin with the image data transmission terminal, and connect the (a+M−1)^{th} connection pin with the ground terminal; and
receive the second mode configuration signal; and in response to the second mode configuration signal, provide the camera power supply voltage to the (b+M−1)^{th} connection pin, connect the (b+1)^{th} connection pin to the (b+M−2)^{th} connection pin with the image data transmission terminal, and connect the b^{th} connection pin with the ground terminal.

In some possible embodiments, the logic controller is further configured to, based on determining that the camera detection signal is an un-access detection signal, output a third mode configuration signal and a voltage output disable signal;
the first switch circuit is further configured to receive the voltage output disable signal, and in response to the voltage output disable signal, stop operation; and the multiplexer is further configured to receive the third mode configuration signal, and in response to the third mode configuration signal, stop operation.

In some possible embodiments, the logic controller is further configured to, based on determining that the display device is in a sleep state or a hibernate state, send the voltage output disable signal to the first switch circuit.

In some possible embodiments, the electronic device further includes: a system controller, where the system controller is connected with the logic controller;
the system controller is configured to: based on recognizing that the display device is in the sleep state, output a sleep recognition signal to the logic controller, and based on recognizing that the display device is in the hibernate state, output a hibernate recognition signal to the logic controller; and
the logic controller is further configured to: based on receiving the sleep recognition signal, determine that the display device is in the sleep state, and based on receiving the hibernate recognition signal, determine that the display device is in the hibernate state.

In some possible embodiments, the logic controller is further configured to: based on determining that the display device is in a closed state, send the voltage output disable signal to the first switch circuit, and based on determining that the display device is not in the closed state, obtain the camera detection signal.

In some possible embodiments, the display device further includes: a second magnetic field sensor and a closure magnet;
the second magnetic field sensor is configured to: in response to the closure magnet, output a first screen state recognition signal to the logic controller, and by default, output a second screen state recognition signal to the logic controller; and
the logic controller is further configured to: based on determining that the first screen state recognition signal is received, determine that the display device is in the closed state, and based on determining that the second screen state recognition signal is received, determine that the display device is not in the closed state.

In some possible embodiments, the second magnetic field sensor and a first magnetic field sensor are the same one magnetic field sensor.

In some possible embodiments, the electronic device further includes: a system controller, wherein the system controller is connected with the logic controller;
the system controller is configured to: based on recognizing that the display device is in an operating state, output an operation recognition signal to the logic controller; and
the logic controller is further configured to: based on receiving the operation recognition signal, determine whether the display device is in a closed state.

In some possible embodiments, the display device further includes: a first magnetic field sensor;
the camera module further includes: a first camera magnet and a second camera magnet, wherein a north pole (N pole) of the first camera magnet is provided facing the second connector and a south pole (S pole) of the second camera magnet is provided facing the second connector; and
the first magnetic field sensor is configured to: when the first connector is mounted to the second connector, in response to the N pole of the first camera magnet, output a camera detection signal corresponding to the forward access detection signal to the detection control circuit and in response to the S pole of the second camera magnet, output a camera detection signal corresponding to the reverse access detection signal to the detection control circuit.

In some possible embodiments, the M^{th} connection contact is connected with the (M−1)^{th} connection contact via an electromagnetic switch;
the display device further includes: a first pull-up resistor, a second pull-up resistor, and a switch control circuit; wherein a first pull-up voltage is provided to the 1^{st} connection pin through the first pull-up resistor, and a second pull-up voltage is provided to the N^{th} connection pin through the second pull-up resistor; and the 1^{st} connection pin and the N^{th} connection pin are connected with the logic controller through the switch control circuit, and the 2^{nd} connection pin to the (N−1)^{th} connection pin is connected with the ground terminal through the switch control circuit; and
the logic controller is further configured to: when a conducting path is established between the logic controller and the 1^{st} connection pin and a conducting path is established between the logic controller and the N^{th} connection pin, via the switch control circuit respectively, obtain a pin level signal of the 1^{st} connection pin and a pin level signal of the N^{th} connection pin, and take the pin level signal of the 1^{st} connection pin and the pin level signal of the N^{th} connection pin as the camera detection signal; when the pin level signal of the 1^{st} connection pin is a first level signal and the pin level signal of the N^{th} connection pin is a second level signal, determine that the camera detection signal is the forward access detection signal, and when the pin level signal of the 1^{st} connection pin is the second level signal and the pin level signal of the N^{th} connection pin is the first level signal, determine that the camera detection signal is the reverse access detection signal.

In some possible embodiments, the switch control circuit is further configured to: in response to a switch control enable signal, establish the conducting path between the 1^{st} connection pin and the logic controller as well as the conducting path between the N^{th} connection pin and the logic controller, and establish a conducting path between each of the 2^{nd} connection pin to (N−1)^{th} connection pin and the ground terminal; and in response to a switch control disable signal, disconnect the 1^{st} connection pin and the N^{th} connection pin from the logic controller, and disconnect the 2^{nd} connection pin to the (N−1)^{th} connection pin from the ground terminal.

In some possible embodiments, the logic controller is further configured to: based on determining that the camera detection signal is the forward access detection signal and based on determining that the camera detection signal is the reverse access detection signal, output the switch control disable signal to the switch control circuit.

In some possible embodiments, the logic controller is further configured to: based on determining that the first connector is disconnected from the second connector, output the switch control enable signal to the switch control circuit.

In some possible embodiments, the electronic device further includes: a system controller, wherein the system controller is configured to: based on recognizing that the first connector is disconnected from the second connector, output a camera disconnect signal to the logic controller; and
the logic controller is further configured to: in response to the camera disconnect signal, determine that the first connector is disconnected from the second connector.

In some possible embodiments, N≥M, N is an odd number, and the detection control circuit includes: a logic controller, and a gating circuit; wherein
the logic controller is configured to: obtain a camera presence detection signal based on determining that the display device is in an operating state, output a voltage output enable signal based on determining that the camera presence detection signal is a valid signal, and output a voltage output disable signal based on determining that the camera presence detection signal is an invalid signal; and
the gating circuit is connected with the logic controller and the ((N+1)/2)^{th} connection pin, respectively, and is configured to:
receive the voltage output enable signal, and in response to the voltage output enable signal, provide the camera power supply voltage to the ((N+1)/2)^{th} connection pin; and
receive the voltage output disable signal, and in response to the voltage output disable signal, stop providing the camera power supply voltage to the ((N+1)/2)^{th} connection pin.

In some possible embodiments, the 2^{nd} connection pin to the ((N−1)/2)^{th} connection pin and the ((N+3)/2)^{th} connection pin to the (N−1)^{th} connection pin are connected with the image data transmission terminal; and
connection pins corresponding to the image data transmission terminal with the same performance, among the 2^{nd} connection pin to the ((N−1)/2)^{th} connection pin and the ((N+3)/2)^{th} connection pin to the (N−1)^{th} connection pin, are provided in mirror symmetry with respect to the ((N+1)/2)^{th} connection pin.

In some possible embodiments, M=N, the 1^{st} connection contact is connected with the M^{th} connection contact, the M^{th} connection contact is configured to be connected with a ground terminal, and the ((M+1)/2)^{th} connection contact is configured to be provided with the camera power supply voltage; and
the 2^{nd} connection contact to the ((M−1)/2)^{th} connection contact are configured to be connected with the image data transmission terminal, and the ((M+3)/2))^{th} connection contact to the (N−1)^{th} connection contact are configured as virtual connection contacts; or
the 2^{nd} connection contact to the ((M−1)/2)^{th} connection contact are configured as virtual connection contacts, and the ((M+3)/2))^{th} connection contact to the (N−1)^{th} connection contact are configured to be connected with the image data transmission terminal.

In some possible embodiments, M<N, the 1^{st} connection contact is connected with the M^{th} connection contact, and the M^{th} connection contact is configured to be connected with a ground terminal;
the 2^{nd} connection contact to the (N−2)^{th} connection contact are configured to be connected with the image data transmission terminal, the (M−1)^{th} connection contact is configured to be provided with the camera power supply voltage, a first spacing distance is provided between the (N−1)^{th} connection contact and the N^{th} connection contact, the first spacing distance is substantially (N−M+1)*h, and h is a spacing distance between two adjacent connection contacts; or
the 3^{rd} connection contact to the (N−1)^{th} connection contact are configured to be connected with the image data transmission terminal, the 2^{nd} connection contact is configured to be provided with the camera power supply voltage, a second spacing distance is provided between the 1^{st} connection contact and the 2^{nd} connection contact, the second spacing distance is substantially (N−M+1)*h, and h is a spacing distance between two adjacent connection contacts.

In some possible embodiments, N=7, and the image data transmission terminal includes: a first differential signal transmission terminal and a second differential signal transmission terminal; and
the 2^{nd} connection pin and the 6^{th} connection pin are connected with the first differential signal transmission terminal, and the 3^{rd} connection pin and the 5^{th} connection pin are connected with the second differential signal transmission terminal.

In some possible embodiments, the camera module further includes a first wireless communication component, and the camera module sends captured image data via the first wireless communication component.

In some possible embodiments, the display device further includes: a third pull-up resistor; a third pull-up voltage is provided to the 1^{st} connection pin through the third pull-up resistor; and the N^{th} connection pin is connected with a ground terminal; and
the logic controller is further connected with the 1^{st} connection pin, and is further configured to obtain a third pin level signal of the 1^{st} connection pin and take the third pin level signal as the camera presence detection signal.

In some possible embodiments, the logic controller is further configured to, based on determining that the display device is in a sleep state or a hibernate state, send the voltage output disable signal to the gating circuit; and
the gating circuit is further configured to receive the voltage output disable signal, and in response to the voltage output disable signal, stop providing the camera power supply voltage to the ((N+1)/2)^{th} connection pin.

In some possible embodiments, the electronic device further includes a system controller, and the system controller is connected with the logic controller; wherein
the system controller is configured to: based on recognizing that the display device is in a sleep state, output a sleep recognition signal to the logic controller, and based on recognizing that the display device is in a hibernate state, output a hibernate recognition signal to the logic controller; and
the logic controller is further configured to: based on receiving the sleep recognition signal, determine that the display device is in the sleep state, and based on receiving the hibernate recognition signal, determine that the display device is in the hibernate state.

In some possible embodiments, the logic controller is further configured to: based on determining that the display device is in a closed state, send the voltage output disable signal to the gating circuit; and
the gating circuit is further configured to receive the voltage output disable signal, and in response to the voltage output disable signal, stop providing the camera power supply voltage to the ((N+1)/2)^{th} connection pin.

In some possible embodiments, the display device further includes: a second magnetic field sensor and a closure magnet;
the second magnetic field sensor is configured to: in response to the closure magnet, output a first screen state recognition signal to the logic controller, and by default, output a second screen state recognition signal to the logic controller; and
the logic controller is further configured to: based on determining that the first screen state recognition signal is received, determine that the display device is in the closed state, and based on determining that the second screen state recognition signal is received, determine that the display device is not in the closed state.

In some possible embodiments, N≥M, N is an odd number, and connection pins corresponding to the same function are in mirror symmetric with respect to the ((N+1)/2)^{th} connection pin.

In some possible embodiments, the ((N+1)/2)^{th} connection pin is connected with a ground terminal, and the detection control circuit includes: a logic controller, and a gating circuit; wherein
the logic controller is configured to obtain the camera detection signal, output a first mode configuration signal and a voltage output enable signal based on determining that the camera detection signal is the forward access detection signal, and output a second mode configuration signal and a voltage output enable signal based on determining that the camera detection signal is the reverse access detection signal; and
the gating circuit is connected with the logic controller, the (a+M−1)^{th} connection pin, and the b^{th} connection pin, respectively, and is configured to:
receive the first mode configuration signal and the voltage output enable signal, and in response to the first mode configuration signal and the voltage output enable signal, provide the camera power supply voltage to the (a+M−1)^{th} connection pin; and
receive the second mode configuration signal and the voltage output enable signal, and in response to the second mode configuration signal and the voltage output enable signal, provide the camera power supply voltage to the b^{th} connection pin.

In some possible embodiments, the gating circuit includes: a second switch circuit and a third switch circuit; wherein
the second switch circuit is connected with the logic controller and the (a+M−1)th connection pin, respectively, and is configured to: receive the voltage output enable signal, and in response to the voltage output enable signal, provide the camera power supply voltage to the (a+M−1)^{th} connection pin; and
the third switch circuit is connected with the logic controller and the b^{th} connection pin, respectively, and is configured to: receive the voltage output enable signal, and in response to the voltage output enable signal, provide the camera power supply voltage to the b^{th} connection pin.

In some possible embodiments, the display device further includes: a fourth pull-up resistor and a fifth pull-up resistor; wherein a fourth pull-up voltage is provided to the (a+M−1)^{th} connection pin through the fourth pull-up resistor, and a fifth pull-up voltage is provided to the b^{th} connection pin through the fifth pull-up resistor; and
the logic controller is further configured to obtain a pin level signal of the (a+M−1)^{th} connection pin and a pin level signal of the b^{th} connection pin, and take the pin level signal of the (a+M−1)^{th} connection pin and the pin level signal of the b^{th} connection pin as the camera detection signal.

In some possible embodiments, the detection control circuit includes: a logic controller, and a gating circuit; wherein
the logic controller is configured to obtain the camera detection signal, output a first mode configuration signal and a voltage output enable signal based on determining that the camera detection signal is the forward access detection signal, and output a second mode configuration signal and a voltage output enable signal based on determining that the camera detection signal is the reverse access detection signal; and
the gating circuit is connected with the logic controller and the 1^{st} connection pin to the N^{th} connection pin, respectively, and is configured to:
receive the first mode configuration signal and the voltage output enable signal, and in response to the first mode configuration signal and the voltage output enable signal, provide the camera power supply voltage to the ((N+1)/2)^{th} connection pin and connect the a^{th} connection pin with the ground terminal; and
receive the second mode configuration signal and the voltage output enable signal, and in response to the second mode configuration signal and the voltage output enable signal, provide the camera power supply voltage to the ((N+1)/2)^{th} connection pin and connect the (b+M−1)^{th} connection pin with the ground terminal.

In some possible embodiments, the gating circuit includes: a fourth switch circuit and a fifth switch circuit; wherein
the fourth switch circuit is connected with the logic controller and the a^{th} connection pin, respectively, and is configured to: receive the voltage output enable signal, and in response to the voltage output enable signal, connect the a^{th} connection pin with the ground terminal;
the fifth switch circuit is connected with the logic controller and the (b+M−1)^{th} connection pin, respectively, and is configured to: receive the voltage output enable signal, and in response to the voltage output enable signal, connect the (b+M−1)^{th} connection pin with the ground terminal.

In some possible embodiments, the display device further includes: a sixth pull-up resistor and a seventh pull-up resistor; wherein a sixth pull-up voltage is provided to the a^{th} connection pin through the sixth pull-up resistor, and a seventh pull-up voltage is provided to the (b+M−1)^{th} connection pin through the seventh pull-up resistor; and
the logic controller is further configured to obtain a pin level signal of the a^{th} connection pin and a pin level signal of the (b+M−1)^{th} connection pin, and take the pin level signal of the a^{th} connection pin and the pin level signal of the (b+M−1)^{th} connection pin as the camera detection signal.

In some possible embodiments, the gating circuit further includes: a multiplexer; wherein
the multiplexer is connected with the logic controller, the (a+1)^{th} connection pin to the ((N−1)/2)^{th} connection pin, and the ((N+3)/2)^{th} connection pin to the (N−1)^{th} connection pin, respectively, and is configured to:
receive the first mode configuration signal, and in response to the first mode configuration signal, connect the (a+1)^{th} connection pin to the ((N−1)/2)^{th} connection pin and the ((N+3)/2)^{th} connection pin to the (N−1)^{th} connection pin with the image data transmission terminal; and
receive the second mode configuration signal, and in response to the second mode configuration signal, connect the (a+1)^{th} connection pin to the ((N−1)/2)^{th} connection pin and the ((N+3)/2)^{th} connection pin to the (N−1)^{th} connection pin with the image data transmission terminal.

In some possible embodiments, the image data transmission terminal includes: a first differential signal transmission terminal and a second differential signal transmission terminal; wherein
N=5, and the multiplexer is further configured to:
in response to the first mode configuration signal, establish a conducting path between the 2^{nd} connection pin and the first differential signal transmission terminal and establish a conducting path between the 4^{th} connection pin and the second differential signal transmission terminal; and
in response to the second mode configuration signal, establish a conducting path between the 2^{nd} connection pin and the second differential signal transmission terminal and establish a conducting path between the 4^{th} connection pin and the first differential signal transmission terminal.

In some possible embodiments, the camera module further includes a first wireless communication component, and the camera module sends captured image data via the first wireless communication component.

In some possible embodiments, N≥M, N is an odd number, the ((N+1)/2)^{th} connection pin is provided with a camera power supply voltage, the 1^{st} connection pin and the N^{th} connection pin are connected with a ground terminal, and the 2^{nd} connection pin to the ((N−1)/2)^{th} connection pin and the ((N+3)/2)^{th} connection pin to the (N−1)^{th} connection pin are connected with an image data transmission terminal; and
connection pins corresponding to the image data transmission terminal with the same performance, among the 2^{nd} connection pin to the ((N−1)/2)^{th} connection pin and the (N+3)/2 connection pin to the (N−1)^{th} connection pin, are provided in mirror symmetry with respect to the ((N+1)/2)^{th} connection pin.

In some possible embodiments, M=N, the 1^{st} connection contact and the M^{th} connection contact are configured to be connected with a connection terminal, and the ((M+1)/2)^{th} connection contact is configured to be provided with the camera power supply voltage; and
the 2^{nd} connection contact to the ((M−1)/2)^{th} connection contact are configured to be connected with the image data transmission terminal, and the ((M+3)/2))^{th} connection contact to the (N−1)^{th} connection contact are configured as virtual connection contacts; or
the 2^{nd} connection contact to the ((M−1)/2)^{th} connection contact are configured as virtual connection contacts, and the ((M+3)/2))^{th} connection contact to the (N−1)^{th} connection contact are configured to be connected with the image data transmission terminal.

In some possible embodiments, N≥M, and the 1^{st} connection contact and the M^{th} connection contact are configured to be connected with a connection terminal; and
the 2^{nd} connection contact to the (N−2)^{th} connection contact are configured to be connected with the image data transmission terminal, the (M−1)^{th} connection contact is configured to be provided with the camera power supply voltage, a third spacing distance is provided between the (N−1)^{th} connection contact and the N^{th} connection contact, the third spacing distance is substantially (N−M+1)*h, and h is a spacing distance between two adjacent connection contacts; or
the 3^{rd} connection contact to the (N−1)^{th} connection contact are configured to be connected with the image data transmission terminal, the 2^{nd} connection contact is configured to be provided with the camera power supply voltage, a fourth spacing distance is provided between the 1^{st} connection contact and the 2^{nd} connection contact, the fourth spacing distance is substantially (N−M+1)*h, and h is a spacing distance between two adjacent connection contacts.

In some possible embodiments, N≥M, N is an odd number, the ((N+1)/2)^{th} connection pin is connected with a ground terminal, the 1^{st} connection pin and the N^{th} connection pin are provided with a camera power supply voltage, and the 2^{nd} connection pin to the ((N−1)/2)^{th} connection pin and the ((N+3)/2)^{th} connection pin to the (N−1)^{th} connection pin are connected with an image data transmission terminal; and
connection pins corresponding to the image data transmission terminal with the same performance, among the 2^{nd} connection pin to the ((N−1)/2)^{th} connection pin and the (N+3)/2 connection pin to the (N−1)^{th} connection pin, are provided in mirror symmetry with respect to the ((N+1)/2)^{th} connection pin.

In some possible embodiments, M=N, the 1^{st} connection contact and the M^{th} connection contact are configured to be provided with the camera power supply voltage, and the ((M+1)/2)^{th} connection contact is configured to be connected with a connection terminal; and
the 2^{nd} connection contact to the ((M−1)/2)^{th} connection contact are configured to be connected with the image data transmission terminal, and the ((M+3)/2))^{th} connection contact to the (N−1)^{th} connection contact are configured as virtual connection contacts; or
the 2^{nd} connection contact to the ((M−1)/2)^{th} connection contact are configured as virtual connection contacts, and the ((M+3)/2))^{th} connection contact to the (N−1)^{th} connection contact are configured to be connected with the image data transmission terminal.

In some possible embodiments, M<N, the 1^{st} connection contact and the M^{th} connection contact are configured to be provided with the camera power supply voltage; and
the 2^{nd} connection contact to the (N−2)^{th} connection contact are configured to be connected with the image data transmission terminal, the (M−1)^{th} connection contact is configured to be connected with the ground terminal, a third spacing distance is provided between the (N−1)^{th} connection contact and the N^{th} connection contact, the third spacing distance is substantially (N-M+1)*h, and h is a spacing distance between two adjacent connection contacts; or
the 3^{rd} connection contact to the (N−1)^{th} connection contact are configured to be connected with the image data transmission terminal, the 2^{nd} connection contact is configured to be connected with the ground terminal, a fourth spacing distance is provided between the 1^{st} connection contact and the 2^{nd} connection contact, the fourth spacing distance is substantially (N-M+1)*h, and h is a spacing distance between two adjacent connection contacts.

In some possible embodiments, N=7, and the image data transmission terminal includes: a first differential signal transmission terminal and a second differential signal transmission terminal; and
the 2^{nd} connection pin and the 6^{th} connection pin are connected with the first differential signal transmission terminal, and the 3^{rd} connection pin and the 5^{th} connection pin are connected with the second differential signal transmission terminal.

In some possible embodiments, the camera module further includes a first wireless communication component, and the camera module sends captured image data via the first wireless communication component.

### BRIEF DESCRIPTION OF FIGURES

FIG. 1 shows a schematic diagram of some structures of an electronic device provided by embodiments of the disclosure.

FIG. 2 shows another schematic diagram of some structures of an electronic device provided by embodiments of the disclosure.

FIG. 3 shows a schematic diagram of some structures of a camera module provided by embodiments of the disclosure.

FIG. 4A shows another schematic diagram of some structures of a camera module provided by embodiments of the disclosure.

FIG. 4B shows an exploded structural diagram of a camera module provided by embodiments of the disclosure.

FIG. 4C shows another schematic diagram of some structures of an electronic device provided by embodiments of the disclosure.

FIG. 4D shows a partially enlarged view of the electronic device in FIG. 4C.

FIG. 5 shows another schematic diagram of some structures of an electronic device provided by embodiments of the disclosure.

FIG. 6 shows another schematic diagram of some structures of an electronic device provided by embodiments of the disclosure.

FIG. 7 shows another schematic diagram of some structures of an electronic device provided by embodiments of the disclosure.

FIG. 8 shows another schematic diagram of some structures of a camera module provided by embodiments of the disclosure.

FIG. 9 shows another schematic diagram of some structures of an electronic device provided by embodiments of the disclosure.

FIG. 10A shows another schematic diagram of some structures of an electronic device provided by embodiments of the disclosure.

FIG. 10B shows another schematic diagram of some structures of an electronic device provided by embodiments of the disclosure.

FIG. 11A shows another schematic diagram of some structures of an electronic device provided by embodiments of the disclosure.

FIG. 11B shows another schematic diagram of some structures of an electronic device provided by embodiments of the disclosure.

FIG. 12 shows another schematic diagram of some structures of an electronic device provided by embodiments of the disclosure.

FIG. 13A shows another schematic diagram of some structures of an electronic device provided by embodiments of the disclosure.

FIG. 13B shows another schematic diagram of some structures of an electronic device provided by embodiments of the disclosure.

FIG. 14A shows another schematic diagram of some structures of an electronic device provided by embodiments of the disclosure.

FIG. 14B shows another schematic diagram of some structures of an electronic device provided by embodiments of the disclosure.

FIG. 15A shows another schematic diagram of some structures of an electronic device provided by embodiments of the disclosure.

FIG. 15B shows another schematic diagram of some structures of an electronic device provided by embodiments of the disclosure.

FIG. 16A shows another schematic diagram of some structures of an electronic device provided by embodiments of the disclosure.

FIG. 16B shows another schematic diagram of some structures of an electronic device provided by embodiments of the disclosure.

FIG. 17A shows another schematic diagram of some structures of an electronic device provided by embodiments of the disclosure.

FIG. 17B shows another schematic diagram of some structures of an electronic device provided by embodiments of the disclosure.

FIG. 18 shows another schematic diagram of some structures of an electronic device provided by embodiments of the disclosure.

FIG. 19A shows another schematic diagram of some structures of an electronic device provided by embodiments of the disclosure.

FIG. 19B shows another schematic diagram of some structures of an electronic device provided by embodiments of the disclosure.

FIG. 20 shows another schematic diagram of some structures of an electronic device provided by embodiments of the disclosure.

FIG. 21A shows another schematic diagram of some structures of an electronic device provided by embodiments of the disclosure.

FIG. 21B shows another schematic diagram of some structures of an electronic device provided by embodiments of the disclosure.

FIG. 22A shows another schematic diagram of some structures of an electronic device provided by embodiments of the disclosure.

FIG. 22B shows another schematic diagram of some structures of an electronic device provided by embodiments of the disclosure.

FIG. 23A shows another schematic diagram of some structures of an electronic device provided by embodiments of the disclosure.

FIG. 23B shows another schematic diagram of some structures of an electronic device provided by embodiments of the disclosure.

FIG. 24A shows another schematic diagram of some structures of an electronic device provided by embodiments of the disclosure.

FIG. 24B shows another schematic diagram of some structures of an electronic device provided by embodiments of the disclosure.

FIG. 25A shows another schematic diagram of some structures of an electronic device provided by embodiments of the disclosure.

FIG. 25B shows another schematic diagram of some structures of an electronic device provided by embodiments of the disclosure.

FIG. 26A shows another schematic diagram of some structures of an electronic device provided by embodiments of the disclosure.

FIG. 26B shows another schematic diagram of some structures of an electronic device provided by embodiments of the disclosure.

FIG. 27A shows another schematic diagram of some structures of an electronic device provided by embodiments of the disclosure.

FIG. 27B shows another schematic diagram of some structures of an electronic device provided by embodiments of the disclosure.

FIG. 28A shows another schematic diagram of some structures of an electronic device provided by embodiments of the disclosure.

FIG. 28B shows another schematic diagram of some structures of an electronic device provided by embodiments of the disclosure.

FIG. 29A shows another schematic diagram of some structures of an electronic device provided by embodiments of the disclosure.

FIG. 29B shows another schematic diagram of some structures of an electronic device provided by embodiments of the disclosure.

### DETAILED DESCRIPTION

In order to make the objects, technical solutions and advantages of the embodiments of the disclosure clearer, the technical solutions of the embodiments of the disclosure will be described clearly and completely in the following in conjunction with the accompanying drawings of the embodiments of the disclosure. Obviously, the described embodiments are a part of the embodiments of the disclosure, and not all of the embodiments. Additionally, the embodiments of the disclosure and the features in the embodiments can be combined with each other without conflict. Based on the described embodiments of the disclosure, all other embodiments obtained by a person of ordinary skill in the art without the need for creative labor are within the claimed scope of the disclosure.

Unless otherwise defined, technical or scientific terms used in the disclosure shall have the ordinary meaning understood by those of ordinary skill in the art to which the disclosure belongs. The terms “first”, “second”, and the like as used in the disclosure do not indicate any order, number, or significance, but are only used to distinguish different components. Words “include” or “contain” and the like are intended to mean that the component or object preceded by the word encompasses the components or objects listed after the word and their equivalents, without excluding other components or objects. Words such as “connected” or “coupled” are not limited to physical or mechanical connections, but may include electrical connections, whether direct or indirect.

It should be noted that the dimensions and shapes of the figures in the accompanying drawings do not reflect true proportions, but are intended to be illustrative of the disclosure.

Additionally, same or similar reference signs indicate same or similar elements or elements with the same or similar function throughout the disclosure.

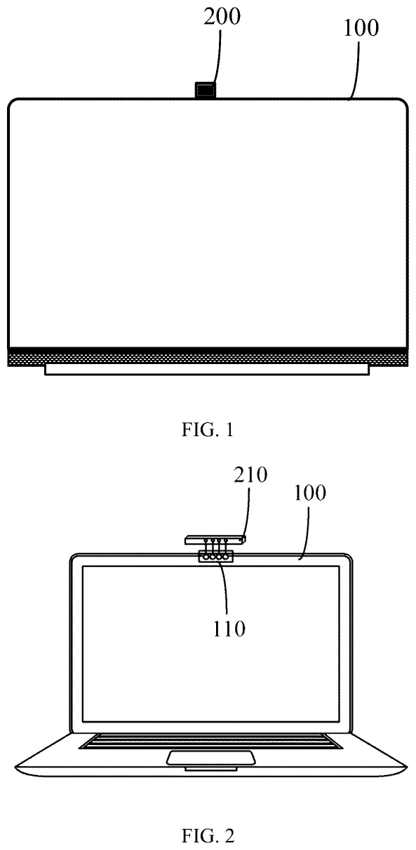

In some embodiments of the disclosure, as shown in FIGS. 1 and 2, the electronic device includes a display device 100. The display device 100 includes a display screen capable of displaying an image. Exemplarily, the display device 100 may include, but is not limited to, any product or component having a display screen, such as a tablet computer, a television, a laptop computer, an all-in-one computer, and the like. Other essential components of the display device should be understood by those of ordinary skill in the art, and are not described herein, nor should they be taken as limitations on the disclosure.

In embodiments of the disclosure, as shown in FIGS. 1 and 2, the electronic device further includes a camera module 200. The camera module 200 is external, detachable, and separate from the display device 100. When the user needs to use the camera module 200 for image acquisition, the camera module 200 can be taken from a storage bin or other object holding the camera module, and mounted to the display device 100. When the user does not need to use the camera for image acquisition, the camera module 200 can be removed from the display device 100 and placed in the storage bin or other object holding the camera module to store the camera module 200. In this way, there is no need to embed and fix the camera module 200 at the top of the display screen, and the position of the top of the display screen is freed up, making it possible to realize the design of an extremely narrow bezel at the top of the display screen. In particular, it can satisfy the current demand for a higher screen-to-body ratio for the display screen of the laptop computer, and realize an extremely narrow bezel on three sides of the screen of the laptop computer, as well as an extremely ultra-thin effect at the screen end.

Additionally, since the user can decide whether to install the camera module 200 on the display device 100 according to the needs, the camera module 200 is removed while the camera module 200 is not in use, so that the camera module 200 is completely separated from the display device 100, thereby realizing a relatively reliable privacy security protection.

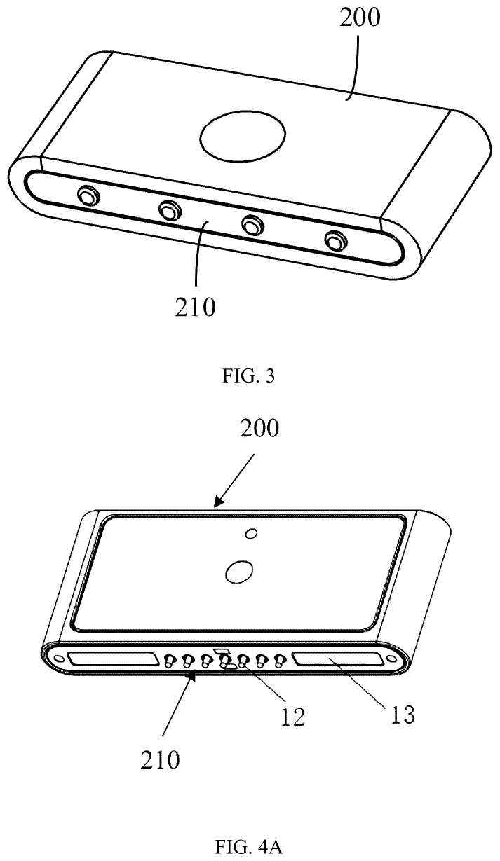

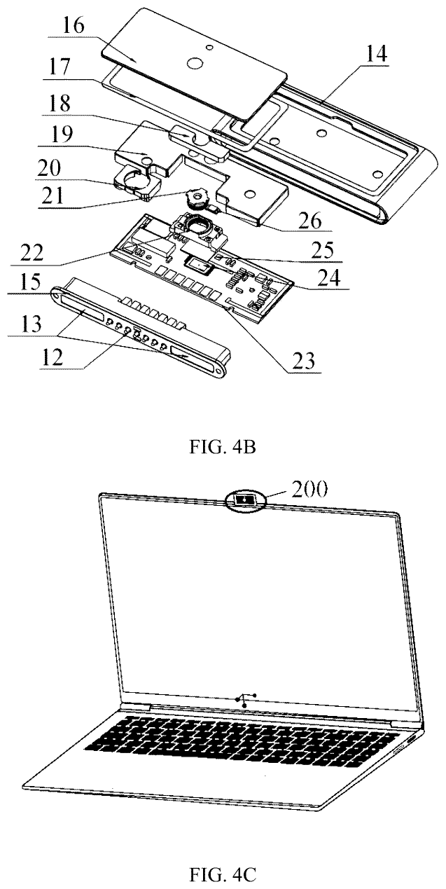

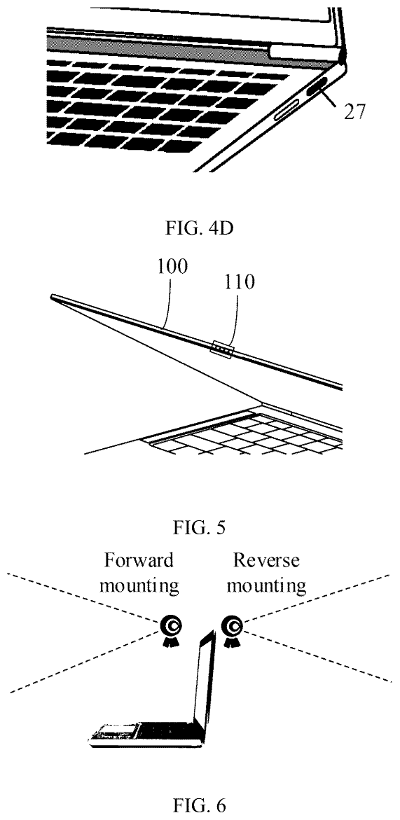

The camera module in the embodiments of the disclosure may be an external magnetic suction camera. Exemplarily, in the embodiment of the disclosure, the camera module 200 may be provided with a first connector 210 for electrically connecting with the display device, as shown in FIGS. 3 and 4A. Exemplarily, the first connector 210 may include a plurality of connection contacts 12, and magnetic assemblies 13 are provided at both sides of the plurality of connection contacts 12. The connection contacts 12 may include, but are not limited to, spring probes, and the magnetic assemblies 13 are used to be attached to the display device. In application, the camera module 200 can be electrically connected, forward or reverse, with the display device for front imaging or rear imaging through the connection contacts 12 and the magnetic assemblies 13. That is, the camera module 200 can be used as a front camera when the camera light-transmission hole faces a user in front of the display device (i.e., the camera light-transmission hole faces the front of the display screen), and can be used as a rear camera when the camera light-transmission hole faces away from the user (i.e., the camera light-transmission hole faces the back of the display screen).

In the camera module in the embodiments of the disclosure, the spring probes are used as an electrically conductive line between the camera module and the display device, and magnetic assemblies at two sides of the spring probes are used to realize a stable communication circuit between the external camera module and the display device, thereby realizing a narrow bezel of the display device. Meanwhile, the camera module may be used as a front or rear camera by being electrically connected, forward or reverse, with the display device, making the application more flexible.

As shown in FIGS. 4A and 4B, in embodiments of the disclosure, the camera module 200 includes a housing 14 and a camera component (not labeled in the drawings) inside the housing 14, the connection contacts 12 disposed at the top and/or bottom of the housing 14, and magnetic assemblies 13 embedded-installed at two sides of the connection contacts, respectively. Here, an area of the housing 14 corresponding to a light-transmission surface of a camera of the camera component is encapsulated by a transparent acrylic panel or a hard tempered glass. For example, in FIG. 4B, a glass cover plate 16 is provided to encapsulate the area of the housing 14 corresponding to the light-transmission surface of the camera, and the glass cover plate 16 is sealed to the housing 14 by the double-sided adhesive 17.

In some examples, the plurality of connection contacts 12 are four to eight groups of linearly arranged spring probes (i.e., POGO PINs, with springs inside the POGO PINs). One terminal of the spring probe disposed inside the housing is fixed on the PCB (printed circuit board) 23 of the camera component by welding, and the other terminal of the spring probe disposed outside the housing 14 is configured to be electrically connected with the display device. In a possible embodiment, the connection contacts 12 are provided at both the top and the bottom of the housing 14, and the connection contacts 12 at the top and the connection contacts 12 at the bottom are arranged symmetrically. Magnetic assemblies are provided at two sides of the connection contacts 12 at the top and at two sides of the connection contacts 12 at the bottom, so that the camera can have a communication circuit conduction with the display device in two directions, thereby realizing the connection between the camera and the display device, and ensuring normally imaging of the camera. Meanwhile, imaging of the camera by reversing the front and rear (i.e., as a front camera and a rear camera) can be realized.

In the disclosure, the number of probes per group of connection contacts 12 is not limited. Exemplarily, it may be 7 spring probes arranged in a straight line, or 4 spring probes arranged in a straight line, or 5 spring probes arranged in a straight line. In this way, the communication can be more stable, and the camera can have a communication circuit conduction with the display device in two directions, thereby realizing the connection between the camera and the display device, and ensuring normally imaging of the camera.

Referring to FIG. 4B, in an optional embodiment, the housing 14 includes a metal cavity opened at the top and/or the bottom, and plastic parts (plastic lower housing 15 and plastic upper housing (not labeled)) correspondingly encapsulating the top and/or the bottom. The connection contacts 12 and the magnetic assemblies 13 are provided on the plastic parts, the plastic parts (plastic lower housing 15 and plastic upper housing (not labeled)) and the metal cavity can be fixed together via screws and sealed by glue.

In embodiments of the disclosure, the camera module is magnetically attached to the display device means of magnetic assemblies on the camera module and corresponding magnetic assemblies on the display device, which forces the springs inside the spring probes to be compressed, so that after attachment, the spring probes are in contact with the corresponding contacts of the display device in a one-to-one manner. The POGO PINs can accurately and stably establish the communication circuit between the camera and the whole machine.

In a possible embodiment, the housing 14 is made of aluminum alloy. The magnetic assemblies 13 are magnet irons or magnet ores.

Referring again to FIG. 4B, the camera component may include a camera 21, a lens holder 22, a light filter 25, a sensor 24, and an LED (light-emitting diode). Specifically, a shield 19 may be provided between the top of the camera component and the housing 14, and the shield 19 may be supported by an upper layer of rubber and a lower layer of rubber. The camera 21 is supported by the lens holder (Holder) 22.

As shown in FIGS. 4C and 4D, in some embodiments of the disclosure, the display device is provided with a first connector, the first connector has magnetic assemblies corresponding to magnetic assemblies of the camera module 200, and contacts corresponding to connection contacts of the camera module 200.

As shown in FIG. 4D, the display device is further provided with an accommodation slot 27 for accommodating the external magnetic camera, so that the camera module can be stored in the accommodation slot when the camera module is in use.

Since the electronic device provided in the embodiment of the disclosure includes the display device and the above camera module, the electronic device provided in the embodiment of the disclosure also has all the advantages of the above camera module.

Meanwhile, since the display device adopts the external camera module, the display device can be flexibly equipped with the camera modules with different specifications. For example, the conventional NB camera module is 1M 720P or 2M 1080P, and 5M 2K and 8M 4K camera assemblies can be customized as separate optional accessories with different configurations according to the disclosure.

In addition, since the camera module is externally magnetized, it is more convenient when replacing or carrying out repairs without having to dismantle the display device.

In embodiments of the disclosure, as shown in FIGS. 2 and 5, a second connector 110 is placed on the display device 100, and serves as a signal access port between the camera module 200 and the display device 100. When the user needs to use the camera module 200 for image acquisition, the first connector 210 of the camera module 200 can be mounted to the second connector 110 on the display device 100, so that the camera module 200 is mounted to the display device 100. When the user does not need to use the camera for image acquisition, the first connector 210 can be disconnected from the second connector 110 so that the camera module 200 is detached from the display device 100.

In the embodiment of the disclosure, as shown in FIGS. 2 and 5, an accommodation slot is provided at the top bezel of the display screen, and the second connector 110 can be provided in the accommodation slot. Exemplarily, the second connector 110 includes one or more connection pins. Exemplarily, the second connector 110 includes N connection pins, and the N connection pins are indicated as the 1^{st} connection pin to the N^{th} connection pin along a direction from the left side of the display screen to the right side of the display screen.

Optionally, N may be set to 1, 2, 3, 4, 5, 6, 7, 8, 9 or more, which may be determined according to the requirements of the actual application and is not limited herein.

At present, the camera module is generally fixed at the top of the display screen and embedded in the display screen, resulting that it can only take pictures in the front of the display screen, and the use scenario is not flexible and convenient enough. In this regard, for the electronic device provided by embodiments of the disclosure, by setting the camera module and the display device to be separate and detachable, the camera module is mounted to the display device when there is a need for image acquisition via the camera module. When image acquisition via the camera module is not required, the camera module is removed from the display device. Additionally, according to the requirements, the camera module can be forward-mounted to the display device so that the camera faces toward the front of the display screen, and, the camera module can be reverse-mounted to the display device so that the camera faces toward the back of the display screen. In order to determine whether the camera module faces toward the front of the display screen or toward the back of the display screen, the electronic device provided in the embodiments of the disclosure is further provided with a detection control circuit, so that the orientation of the camera module can be determined by the detection control circuit, and the flexibility and convenience of the use scenario of the camera module are improved.

In embodiments of the disclosure, the detection control circuit can be provided on a circuit main board of the display device.

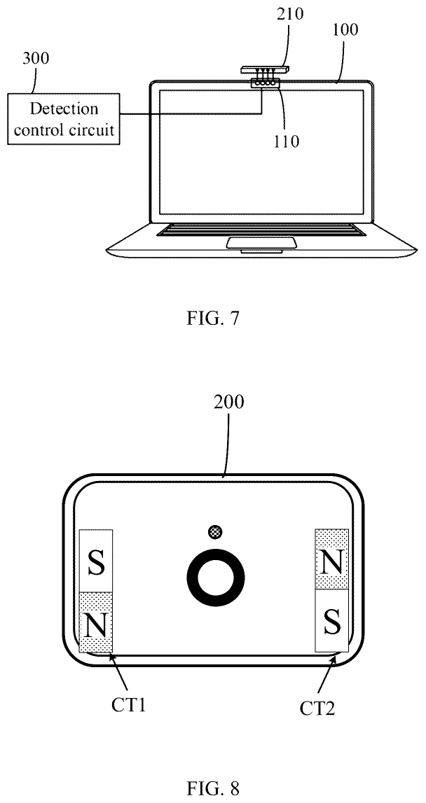

In the embodiments of the disclosure, the detection control circuit 300 is connected with the second connector 110, as shown in FIGS. 6 and 7. Here, the detection control circuit 300 is configured to, in response to that the 1^{st} connection contact to an M^{th} connection contact are mounted to an a^{th} connection pin to an (a+M−1)^{th} connection pin among the 1^{st} connection pin to the N^{th} connection pin, determine that the camera faces the front of the display device 100 (the front refers to a side of the display surface of the display screen). That is, the 1^{st} connection contact is mounted to the a^{th} connection pin, a 2^{nd} connection contact is mounted to an (a+1)^{th} connection pin, a 3^{rd} connection contact is mounted to an (a+2)^{th} connection pin, . . . , an (M−1)^{th} connection contact is mounted to an (a+M−2)^{th} connection pin, and the M^{th} connection contact is mounted to the (a+M−1)^{th} connection pin, so that the camera module 200 is forward-mounted to the display device 100, which can indicate that the camera faces the display surface of the display screen, i.e., forward access, meaning that the camera is used as a front camera for shooting, which in turn realizes that the camera captures a picture in the front of the display surface of the display screen.

Further, the detection control circuit 300 is further configured to, in response to that the M^{th} connection contact to the 1^{st} connection contact are mounted to a b^{th} connection pin to a (b+M−1)^{th} connection pin among the 1^{st} connection pin to the N^{th} connection pin, determine that the camera faces the back of the display device 100 (the back refers to a side of the non-display surface of the display screen). That is, the M^{th} connection contact is mounted to the b^{th} connection pin, a (M−1)^{th} connection contact is mounted to a (b+1)^{th} connection pin, a (M−2)^{th} connection contact is mounted to a (b+2)^{th} connection pin, . . . , the 2^{nd} connection contact is mounted to a (b+M−2)^{th} connection pin, and the 1^{st} connection contact is mounted to the (b+M−1)^{th} connection pin, so that the camera module 200 is reverse-mounted to the display device 100, which may indicate that the camera faces the non-display surface of the display screen, i.e., the reverse access, meaning that the camera is used as a rear camera for shooting, which in turn realizes that the camera captures a picture in the back of the display screen.

In embodiments of the disclosure, a is an integer and 1≤a≤N. That is to say, a specific value of a can be selected from 1 to N, which is not limited herein.

In embodiments of the disclosure, b is an integer and 1≤b≤N. That is to say, a specific value of b can be selected from 1 to N, which is not limited herein.

In the embodiments of the disclosure, according to the order that the 1^{st} connection contact to the M^{th} connection contact are mounted to the 1^{st} connection pin to the N^{th} connection pin, the camera can be determined to be used as a front or rear camera. This allows the camera module to meet more personalized application scenarios and can lead to more reliable and secure privacy protection.

When the display device provided in the embodiments of the disclosure is a laptop computer or an all-in-one computer, since the camera module can be separated from the laptop computer or the all-in-one computer, more individualized application scenarios can be applied, thereby providing more reliable and safer privacy protection. Further, according to the order that the 1^{st} connection contact to the M^{th} connection contact are mounted to the 1^{st} connection pin to the N^{th} connection pin, the camera can be determined to be used as a front or rear camera, which realizes the front and rear imaging via the camera by only forward and reverse mounting the camera module without moving the entire laptop computer or all-in-one computer, and solves the problem of imaging for only one side via the built-in camera of the current laptop computer or all-in-one computer.

In some embodiments of the disclosure, a detection signal may be used to determine the order that the 1^{st} connection contact to the M^{th} connection contact are mounted to the 1^{st} connection pin to the N^{th} connection pin. Exemplarily, the detection control circuit is further configured to obtain the camera detection signal. Optionally, the camera detection signal may be an analog voltage signal or a digital voltage signal, which is not limited herein.

In some examples, the detection control circuit 300, based on determining that the camera detection signal is a forward access detection signal, may determine that the 1^{st} connection contact to the M^{th} connection contact are mounted to the a^{th} connection pin to the (a+M−1)^{th} connection pin, and determine that the camera module 200 is forward-mounted to the display device 100.

In yet other examples, the detection control circuit 300, based on determining that the camera detection signal is a reverse access detection signal, determines that the M^{th} connection contact to the 1^{st} connection contact are mounted to the b^{th} connection pin to the (b+M−1)^{th} connection pin, and determines that the camera module 200 is reverse-mounted to the display device 100.

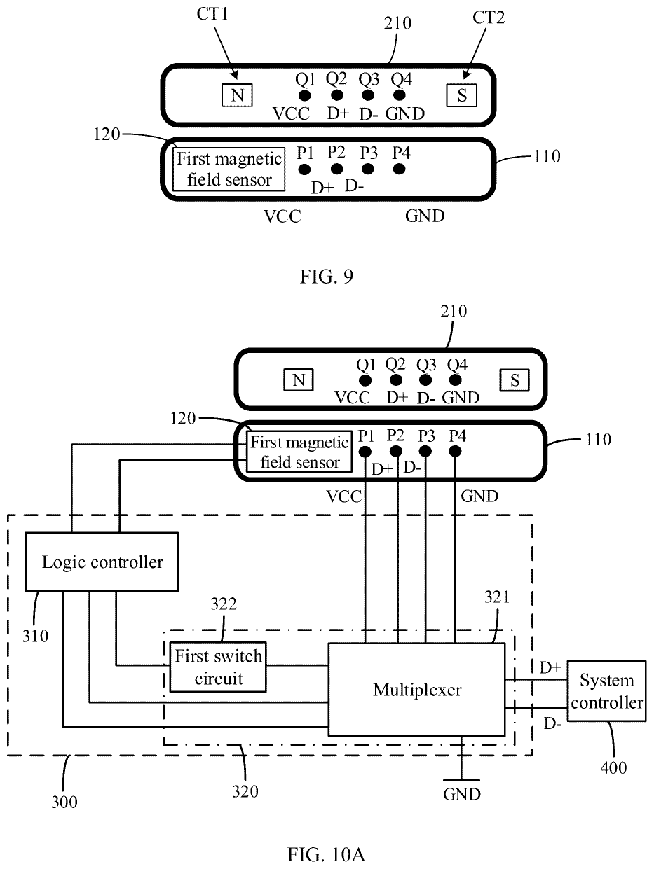

Exemplarily, as shown in FIGS. 8 and 9, the camera module 200 further includes: a first camera magnet CT1 and a second camera magnet CT2, where a north pole (N pole) of the first camera magnet CT1 is arranged facing the second connector 110 and a south pole (S pole) of the second camera magnet CT2 is arranged facing the second connector 110. Optionally, the first camera magnet CT1 and the second camera magnet CT2 may be disposed at both ends of the first connector 210. For example, the first camera magnet CT1 is provided at a side of the 1^{st} connection contact Q1 away from the N^{th} connection contact, and the second camera magnet CT2 is provided at a side of the N^{th} connection contact away from the 1^{st} connection contact Q1. This allows the first camera magnet CT1 and the second camera magnet CT2 to be arranged at the left and right ends of the camera module 200, respectively. For example, the first camera magnet CT1 is arranged at the left end of the camera module 200, and the N pole (north pole) of the first camera magnet CT1 is made to face downward (meaning facing toward the outer side of the first connector 210) and the S pole (south pole) of the first camera magnet CT1 is made to face upward. The second camera magnet CT2 is provided at the right end of the camera module 200, and the S pole (south pole) of the second camera magnet CT2 is made to face downward (meaning facing toward the outer side of the first connector 210) and the N pole (north pole) of the second camera magnet CT2 is made to face upward.

Exemplarily, the magnetic field strengths of the first camera magnet CT1 and the second camera magnet CT2 may be the same or may be different, which are not limited herein.

Exemplarily, as shown in FIGS. 8 and 9, the display device 100 further includes: a first magnetic field sensor 120. Optionally, the second connector 110 may be welded to a flexible printed circuit (FPC), and the first magnetic field sensor 120 is provided on the FPC. When the camera module 200 is forward-mounted to the display device 100, a region where the first magnetic field sensor 120 is located is provided opposite to a region where the first camera magnet CT1 is located. When the camera module 200 is reverse-mounted to the display device 100, the region where the first magnetic field sensor 120 is located is provided opposite to a region where the second camera magnet CT2 is located.

In a specific implementation, when the camera module 200 is forward-mounted to the display device 100, the first connector 210 is mounted to the second connector 110, and the N pole of the first camera magnet CT1 is close to the first magnetic field sensor 120, so that the first magnetic field sensor 120 is triggered and in response to the N pole of the first camera magnet CT1, outputs a camera detection signal corresponding to the forward access detection signal. The first magnetic field sensor 120 is connected with the detection control circuit 300, so that the camera detection signal corresponding to the forward access detection signal can be obtained from the first magnetic field sensor 120.

In a specific implementation, when the camera module 200 is reverse-mounted to the display device 100, the first connector 210 is mounted to the second connector 110, and the S pole of the second camera magnet CT2 is close to the first magnetic field sensor 120, so that the first magnetic field sensor 120 is triggered, and in response to the S pole of the second camera magnet CT2, outputs the camera detection signal corresponding to the reverse access detection signal. The first magnetic field sensor 120 is connected with the detection control circuit 300, so that the camera detection signal corresponding to the reverse access detection signal can be obtained from the first magnetic field sensor 120.

In a specific implementation, when the camera module 200 is not mounted to the display device 100, the first connector 210 is far away from the second connector 110, and the first magnetic field sensor 120 is not triggered and outputs a camera detection signal corresponding to an un-access detection signal. The first magnetic field sensor 120 is connected with the detection control circuit 300, so that the camera detection signal corresponding to the un-access detection signal can be obtained from the first magnetic field sensor 120. Based on determining that the camera detection signal is the un-access detection signal, it is determined that the first connector 210 is not mounted to the second connector 110, thereby determining that the camera module 200 is not connected with the display device 100.

In the embodiments of the disclosure, specific implementations of the first magnetic field sensor are not limited. Exemplarily, the first magnetic field sensor may be a Hall effect based sensor. For example, the first magnetic field sensor includes, but is not limited to, a Hall sensor.

Optionally, the Hall sensor may be a dual output Hall sensor, where a first output terminal and a second output terminal of the dual output Hall sensor are connected with the detection control circuit 300 respectively. When the camera module 200 is forward-mounted to the display device 100, the first connector 210 is mounted to the second connector 110, and the N pole of the first camera magnet CT1 is close to the dual output Hall sensor. In response to the N pole of the first camera magnet CT1, the first output terminal of the dual output Hall sensor is triggered to output a first level signal (e.g., a low level signal, indicated as “0”), and the second output terminal of the dual output Hall sensor is triggered to output a second level signal (e.g., a high level signal, indicated as “1”). The first level signal (e.g., the low level signal, indicated “0”) and the second level signal (e.g., the high level signal, indicated as “1”) are sent to the detection control circuit 300 as the camera detection signal (e.g., “01”) corresponding to the forward access detection signal.

Further, when the camera module 200 is reverse-mounted to the display device 100, the first connector 210 is mounted to the second connector 110. In response to the S pole of the second camera magnet CT2, the first output terminal of the dual output Hall sensor is triggered to output a second level signal (e.g., a high level signal, indicated as “1”), and the second output terminal of the dual output Hall sensor is triggered to output a first level signal (e.g., a high level signal, indicated as “1”). The second level signal (e.g., the high level signal, indicated as “1”) and the first level signal (e.g., the low level signal, indicated as “0”) are sent to the detection control circuit 300 as the camera detection signal (e.g., “10”) corresponding to the reverse access detection signal.

Further, when the camera module 200 is not mounted to the display device 100, the first connector 210 is not mounted to the second connector 110, and the dual output Hall sensor is not triggered. The first output terminal of the dual output Hall sensor outputs a second level signal (e.g., a high level signal, indicated as “1”) and the second output terminal of the dual output Hall sensor outputs the second level signal (e.g., the high level signal, indicated as “1”). The second level signal (e.g., the high level signal, indicated as “1”) and the second level signal (e.g., the high level signal, indicated as “1”) are sent to the detection control circuit 300 as the camera detection signal (e.g., “11”) corresponding to the un-access detection signal. Alternatively, the first output terminal of the dual output Hall sensor outputs a first level signal (e.g., a low level signal, indicated as “0”), and the second output terminal of the dual output Hall sensor outputs the first level signal (e.g., the low level signal, indicated as “0”). The first level signal (e.g., the low level signal, indicated as “0”) and the first level signal (e.g., the low level signal, indicated as “0”) are sent to the detection control circuit 300 as the camera detection signal (e.g., “00”) corresponding to the un-access detection signal.

Based on this, the detection control circuit 300 may pre-store the forward access detection signal, the reverse access detection signal, and the un-access detection signal. For example, the pre-stored forward access detection signal may be a digital voltage signal of “01”, and the pre-stored reverse access detection signal may be a digital voltage signal of “10”, and the pre-stored un-access detection signal may be a digital voltage signal of “11”. In this way, the received camera detection signal can be compared with the pre-stored forward access detection signal, reverse access detection signal, and un-access detection signal, respectively. If the camera detection signal is the same as the forward access detection signal, it can be determined that the camera detection signal is a forward access detection signal. If the camera detection signal is the same as the reverse access detection signal, it can be determined that the camera detection signal is a reverse access detection signal. If the camera detection signal is the same as the un-access detection signal, it can be determined that the camera detection signal is an un-access detection signal.

In the embodiments of the disclosure, the detection control circuit may include: a logic controller, and a gating circuit. The logic controller is connected with the first magnetic field sensor, and the gating circuit is connected with the logic controller and the 1^{st} connection pin to the N^{th} connection pin, respectively. Further, the logic controller is configured to: obtain the camera detection signal, output a first mode configuration signal and a voltage output enable signal in response to determining that the camera detection signal is the forward access detection signal, and output a second mode configuration signal and the voltage output enable signal in response to determining that the camera detection signal is the reverse access detection signal. The gating circuit is configured to: receive the first mode configuration signal and the voltage output enable signal, and in response to the first mode configuration signal and the voltage output enable signal, provide a camera power supply voltage VCC to the a^{th} connection pin and connect the (a+M−1)^{th} connection pin with the ground terminal GND; and receive the second mode configuration signal and the voltage output enable signal, and in response to the second mode configuration signal and the voltage output enable signal, provide the camera power supply voltage VCC to the (b+M−1)^{th} connection pin and connect the b^{th} connection pin with the ground terminal GND. In this way, a voltage can be provided to the forward or reverse mounted camera through the cooperation of the logic controller and the gating circuit.

Exemplarily, the number of connection contacts in the first connector 210 can be the same as the number of connection pins in the second connector 110, i.e., N=M, which can reduce the number of signal lines as much as possible, so that as few signal lines as possible can be used to realize the signal transmission in both directions of the forward and reverse mounting, and realize the detection of the position of the camera for the front or rear shooting. When the camera module 200 is forward-mounted to the display device 100, the 1^{st} connection contact is mounted to the 1^{st} connection pin, the 2^{nd} connection contact is mounted to the 2^{nd} connection pin, the 3^{rd} connection contact is mounted to the 3^{rd} connection pin, . . . , the (M−1)^{th} connection contact is mounted to the (N−1)^{th} connection pin, and the M^{th} connection contact is mounted to the N^{th} connection pin. When the camera module 200 is reverse-mounted to the display device 100, the 1^{st} connection contact is mounted to the N^{th} connection pin, the 2^{nd} connection contact is mounted to the (N−1)^{th} connection pin, the 3^{rd} connection contact is mounted to the (N−2)^{th} connection pin, . . . , the (M−1)^{th} connection contact is mounted to the 2^{nd} connection pin, and the M^{th} connection contact is mounted to the 1^{st} connection pin.

In some embodiments of the disclosure, the image data captured by the camera may be communicated based on the wireless communication technology. The camera module may further include a first wireless communication component, and the camera module may send the captured image data via the first wireless communication component. Further, the display device further includes a second wireless communication component. The display device communicates data with the first communication component via the second wireless communication component to obtain the image data sent from the first wireless communication component.

In some embodiments of the disclosure, the image data captured by the camera may be communicated via a signal line (e.g., universal serial bus (USB)). Exemplarily, the gating circuit may be further configured to: in response to the first mode configuration signal, cause the (a+1)^{th} connection pin to the (a+M−2)^{th} connection pin to be connected with the image data transmission terminal, and in response to the second mode configuration signal, cause the (b+1)^{th} connection pin to the (b+M−2)^{th} connection pin to be connected with the image data transmission terminal.

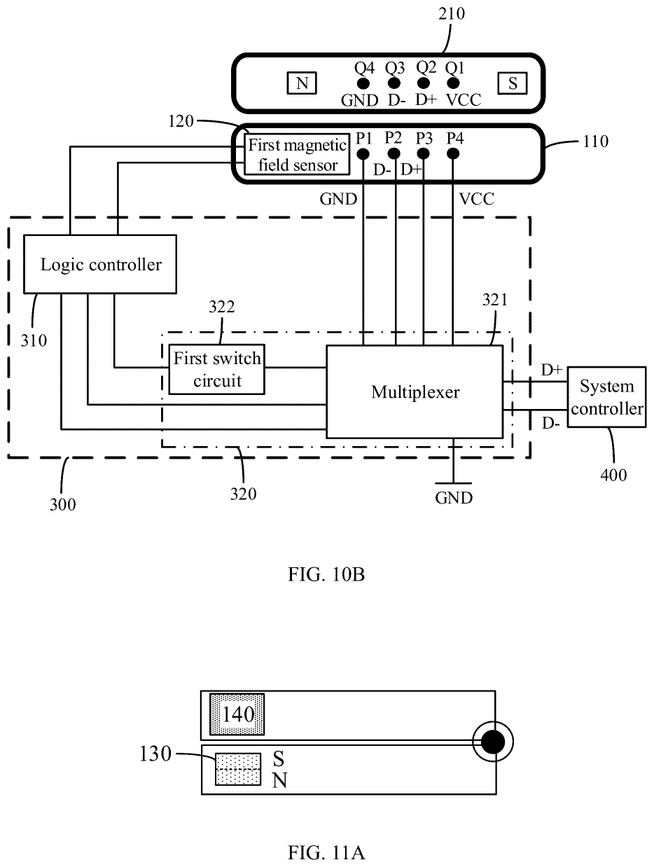

Exemplarily, taking N=M=4 as an example, as shown in FIGS. 10A and 10B, the 1^{st} connection contact Q1 can be configured to be provided with the camera power supply voltage VCC, the 4^{th} connection contact Q4 can be configured to be connected with the ground terminal GND, and the 2^{nd} connection contact Q2 and the 3^{rd} connection contact Q3 can be configured to be connected with the image data transmission terminal. Optionally, the image data transmission terminal includes: a first differential signal transmission terminal D+ and a second differential signal transmission terminal D−. The 2^{nd} connection contact Q2 can be connected with the first differential signal transmission terminal D+, and the 3^{rd} connection contact Q3 can be connected with the second differential signal transmission terminal D−.

Exemplarily, as shown in FIGS. 10A and 10B, for example, N=M=4, the detection control circuit 300 may include: a logic controller 310 and a gating circuit 320. The logic controller 310 is connected with the first magnetic field sensor 120, and the gating circuit 320 is connected with the logic controller 310 and the 1^{st} connection pin P1 to the 4^{th} connection pin P4, respectively. The logic controller 310 is configured to obtain a camera detection signal from the first magnetic field sensor 120. Additionally, the logic controller 310 pre-stores a forward access detection signal (e.g., a digital voltage signal of “01”), a reverse access detection signal (e.g., a digital voltage signal of “10”), and an un-access detection signal (e.g., a digital voltage signal of “11”).

Exemplarily, as shown in FIG. 10A, when the camera is forward-mounted to the display device 100, the 1^{st} connection contact Q1 is connected with the 1^{st} connection pin P1, the 2^{nd} connection contact Q2 is connected with the 2^{nd} connection pin P2, the 3^{rd} connection contact Q3 is connected with the 3^{rd} connection pin P3, and the 4^{th} connection contact Q4 is connected with the 4^{th} connection pin P4. The camera detection signal is the digital voltage signal of “01”, and the logic controller 310 is configured to compare the received camera detection signal with the forward access detection signal, the reverse access detection signal, and the un-access detection signal, respectively. If the camera detection signal is the same as the forward access detection signal, it can be determined that the camera detection signal is a forward access detection signal, so that the first mode configuration signal and the voltage output enable signal can be output. The gating circuit 320 is configured to receive the first mode configuration signal and the voltage output enable signal, and in response to the first mode configuration signal and the voltage output enable signal, provide the camera power supply voltage VCC to the 1^{st} connection pin P1 and connect the 4^{th} connection pin P4 with the ground terminal GND. Additionally, the 2^{nd} connection pin P2 and the 3^{rd} connection pin P3 are connected with the image data transmission terminal, and the image data captured by the camera is communicated via the 2^{nd} connection pin P2 and the 3^{rd} connection pin P3.

Exemplarily, as shown in FIG. 10B, when the camera is reverse-mounted to the display device 100, the 4^{th} connection contact Q4 is mounted to the 1^{st} connection pin P1, the 3^{rd} connection contact Q3 is mounted to the 2^{nd} connection pin P2, the 2^{nd} connection contact Q2 is mounted to the 3^{rd} connection pin P3, and the 1^{st} connection contact Q1 is mounted to the 4^{th} connection pin P4. The camera detection signal is the digital voltage signal of “10”, and the logic controller 310 is configured to compare the received camera detection signal with the forward access detection signal, the reverse access detection signal, and the un-access detection signal, respectively. If the camera detection signal is the same as the reverse access detection signal, it can be determined that the camera detection signal is a reverse access detection signal, so that the second mode configuration signal and the voltage output enable signal can be output. The gating circuit 320 is configured to receive the second mode configuration signal and the voltage output enable signal, and in response to the second mode configuration signal and the voltage output enable signal, provide the camera power supply voltage VCC to the 4^{th} connection pin P4 and connect the 1^{st} connection pin P1 with the ground terminal GND. Additionally, the 2^{nd} connection pin P2 and the 3^{rd} connection pin P3 are connected with the image data transmission terminal, and the image data captured by the camera is communicated via the 2^{nd} connection pin P2 and the 3^{rd} connection pin P3.

Exemplarily, when the camera is not connected with the display device 100, the camera detection signal is a digital voltage signal of “11”, and the logic controller 310 is configured to compare the received camera detection signal with the forward access detection signal, the reverse access detection signal, and the un-access detection signal, respectively. If the camera detection signal is the same as the un-access detection signal, it can be determined that the camera detection signal is the un-access detection signal, so that the third mode configuration signal and the voltage output disable signal can be output. The gating circuit 320 is configured to receive the third mode configuration signal and the voltage output disable signal, and in response to the third mode configuration signal and the voltage output disable signal, stop operation, i.e., stop providing the camera power supply voltage VCC to the 4^{th} connection pin P4, disconnect the 1^{st} connection pin P1 from the grounding terminal GND, and disconnect the 2^{nd} connection pin P2 and the 3^{rd} connection pin P3 from the image data transmission terminal, thereby saving power consumption.

Exemplarily, the logic controller 310 can be provided in a main board of the display device 100, the power-on sequence and the power-off sequence of the display device 100, the keyboard of the display device 100, the display brightness, the indicator lights of the display device 100, the fan of the display device 100, and the like can be controlled via the logic controller 310. Of course, the logic controller 310 can also realize other functions, which will not be listed herein. Although the logic controller 310 is capable of realizing these functions, it also has some reserved pin. In the embodiments of the disclosure, the reserved pins in the logic controller 310 are reused to be connected with the first magnetic field sensor 120 and the gating circuit 320, respectively, so as to communicate corresponding signals.

Exemplarily, the logic controller 310 includes, but is not limited to, an embedded controller (EC).

Exemplarily, the image data captured by the camera may be communicated in the form of differential signals. Optionally, the image data transmission terminal includes: a first differential signal transmission terminal D+ and a second differential signal transmission terminal D−. The first differential signal transmission terminal D+ and the second differential signal transmission terminal D− may communicate differential signals. Exemplarily, as shown in FIG. 10A, the gating circuit 320 may be further configured to, in response to the first mode configuration signal, provide the camera power supply voltage VCC to the 1^{st} connection pin P1, establish a conducting path between the 2^{nd} connection pin P2 and the first differential signal transmission terminal D+, establish a conducting path between the 3^{rd} connection pin P3 and the second differential signal transmission terminal D−, and connect the 4^{th} connection pin P4 with the ground terminal GND.

Exemplarily, as shown in FIG. 10B, the gating circuit 320 may be further configured to: in response to the second mode configuration signal, provide the camera power supply voltage VCC to the 4^{th} connection pin P4, establish a conducting path between the 2^{nd} connection pin P2 with the second differential signal transmission terminal D−, establish a conducting path between the 3^{rd} connection pin P3 with the first differential signal transmission terminal D+, and connect the 1^{st} connection pin P1 with the ground terminal GND.

In the embodiments of the disclosure, the electronic device further includes: a system controller 400, the system controller may be disposed on the main board of the display device 100. Exemplarily, the system controller may control the operation of the display device 100. For example, the system controller includes, but is not limited to, a system-on-chip (SOC), a central processing unit (CPU).

In the embodiment of the disclosure, the image data captured by the camera may be communicated via a signal line to the system controller 400. The system controller 400 can perform a series of processing on the received image data and then send it out by way of wired communication or wireless communication, or it may control the display screen to perform image display. The above image data transmission terminal may be a pin(s) of the system controller. For example, when the image data transmission terminal includes a first differential signal transmission terminal D+ and a second differential signal transmission terminal D−, one pin of the system controller 400 serves as the first differential signal transmission terminal D+ and another pin of the system controller 400 serves as the second differential signal transmission terminal D−.

In some embodiments of the disclosure, the gating circuit 320 includes: a multiplexer 321 and a first switch circuit 322. The first switch circuit 322 is connected with the logic controller 310 and the multiplexer 321, respectively, and the multiplexer 321 is connected with the logic controller 310 and the 1^{st} connection pin P1 to the N^{th} connection pin, respectively. The first switch circuit 322 is configured to: receive the voltage output enable signal, and in response to the voltage output enable signal, provide the camera power supply voltage VCC to the multiplexer 321. The multiplexer 321 is configured to: receive the first mode configuration signal, and in response to the first mode configuration signal, provide the camera power supply voltage VCC to the a^{th} connection pin, connect the (a+1)^{th} connection pins to the (a+M−2)^{th} connection pin with the image data transmission terminal, and connect the (a+M−1)^{th} connection pin with the ground terminal GND. The multiplexer 321 is further configured to: receive the second mode configuration signal, and in response to the second mode configuration signal, provide the camera power supply voltage VCC to the (a+M−1)^{th} connection pin, connect the (b+1)^{th} connection pin to the (b+M−2)^{th} connection pin with the image data transmission terminal, and connect the a^{th} connection pin with the ground terminal GND.

Exemplarily, as shown in FIGS. 10A and 10B, the gating circuit 320 includes: a multiplexer 321 and a first switch circuit 322. The first switch circuit 322 is connected with the logic controller 310 and the multiplexer 321, respectively, and the multiplexer 321 is connected with the logic controller 310 and the 1^{st} connection pin P1 to the 4^{th} connection pin P4, respectively. The first switch circuit 322 is configured to: receive the voltage output enable signal, and in response to the voltage output enable signal, provide the camera power supply voltage VCC to the multiplexer 321. The multiplexer 321 is configured to: receive the first mode configuration signal, and in response to the first mode configuration signal, provide the camera power supply voltage VCC to the 1^{st} connection pin P1, connect the 2^{nd} connection pin P2 with the first differential signal transmission terminal D+ of the image data transmission terminal, connect the 3^{rd} connection pin P3 with the second differential signal transmission terminal D− of the image data transmission terminal, and connect the 4^{th} connection pin P4 with the ground terminal GND. The multiplexer 321 is further configured to: receive the second mode configuration signal, and in response to the second mode configuration signal, provide the camera power supply voltage VCC to the 4^{th} connection pin P4, connect the 3^{rd} connection pin P3 with the first differential signal transmission terminal D+ of the image data transmission terminal, connect the 2^{nd} connection pin P2 wtih the second differential signal transmission terminal D− of the image data transmission terminal, and connect the 1^{st} connection pin P1 with the ground terminal GND.

In some embodiments of the disclosure, the logic controller 310 is further configured to: based on determining that the camera detection signal is the un-access detection signal, output the third mode configuration signal and the voltage output disable signal. The first switch circuit 322 is further configured to: receive the voltage output disable signal, and in response to the voltage output disable signal, stop operation, stop providing the camera power supply voltage VCC to the multiplexer 321. The multiplexer 321 is further configured to: receive the third mode configuration signal, and in response to the third mode configuration signal, stop operation and disconnect the multiplexer 321 from the 1^{st} connection pin P1 to the 4^{th} connection pin P4, so as to reduce power consumption.

Exemplarily, a control terminal of the first switch circuit 322 is configured to receive the voltage output enable signal and the voltage output disable signal, and a first terminal of the first switch circuit 322 is configured to receive the camera power supply voltage VCC, and a second terminal of the first switch circuit 322 is connected with the multiplexer 321. The first switch circuit 322 is turned on under the control of the voltage output enable signal to provide the camera power supply voltage VCC to the multiplexer 321. The first switch circuit 322 is turned off under the control of the voltage output disable signal to stop providing the camera power supply voltage VCC to the multiplexer 321. Optionally, the first switch circuit 322 includes, but is not limited to, a transistor(s), a triode(s), a digital switch(es), an analog switch(es).

Generally, when the display device 100 is not in use for a time duration, the display device 100 can be manually or automatically controlled to enter a sleep state, so as to reduce power consumption. In some embodiments of the disclosure, the system controller is configured to: based on recognizing that the display device 100 is in the sleep state, output a sleep recognition signal to the logic controller 310, and the logic controller 310 is further configured to: in response to receiving the sleep recognition signal, determine that the display device 100 is in the sleep state, and in response to determining that the display device 100 is in the sleep state, send the voltage output disable signal to the first switch circuit 322. This can be configured to have a first priority, regardless of whether the first connector 210 is mounted to the second connector 110, as long as determining that the display device 100 is in the sleep state, the voltage output disable signal can be sent to the first switch circuit 322, which forcibly turning off the first switch circuit 322, thereby stop the supply of the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

Generally, when the display device 100 is not in use for a time duration, the display device 100 can be manually or automatically controlled to enter a hibernate state, so as to reduce power consumption. In some embodiments of the disclosure, the system controller 400 is configured to: base on recognizing that the display device 100 is in the hibernate state, output a hibernate recognition signal to the logic controller 310, and the logic controller 310 is further configured to: in response to receiving the hibernate recognition signal, determine that the display device 100 is in the hibernate state, and in response to determining that the display device 100 is in the hibernate state, send the voltage output disable signal to the first switch circuit 322. This can be configured to have a first priority, regardless of whether the first connector 210 is mounted to the second connector 110, as long as determining that the display device 100 is in the hibernate state, the voltage output disable signal can be sent to the first switch circuit 322, which forcibly turns off the first switch circuit 322, thereby stop the supply of the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

Exemplarily, when the display device 100 is a laptop computer and when the display device 100 is in a normal operating state, the logic controller 310 recognizes a scenario with the screen being closed and a scenario with the screen being open by a screen state recognition signal. In the screen closed scenario which means that the user does not need to use the camera function, in this case, it is necessary to prioritize forcibly turning off the first switch circuit 322 to cut off the power supply to the camera module 200, so as to improve the reliability and safety of the power supply of the camera module 200. In the screen unclosed scenario, the user may use the camera function, and in this case, the camera detection signal will be used as the basis for determining whether to turn on the first switch circuit 322. In the embodiments of the disclosure, the system controller 400 is configured to: based on recognizing that the display device 100 is in an operating state, output an operation recognition signal to the logic controller 310. The logic controller 310 is further configured to: in response to receiving the operation recognition signal, determine whether the display device 100 is in a closed state. The logic controller 310, in response to determining that the display device 100 is in the closed state, sends the voltage output disable signal to the first switch circuit 322. This can be configured to have a second priority, regardless of whether the first connector 210 is mounted to the second connector 110, as long as determining that the display device 100 is in the closed state, the voltage output disable signal can be sent to the first switch circuit 322, which forcibly turning off the first switch circuit 322, thereby stop the supply of the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

Further, the logic controller 310, in response to determining that the display device 100 is not in a closed state, may determine whether the first switch circuit 322 needs to be turned on by obtaining the camera detection signal and using the camera detection signal as a basis.

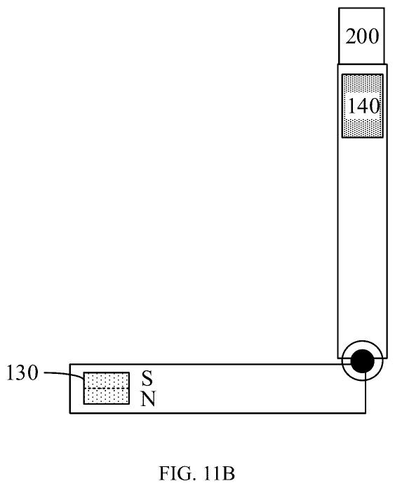

Exemplarily, as shown in FIGS. 11A and 11B, the display device 100 further includes: a closure magnet 130 and a second magnetic field sensor 140. Exemplarily, when the display device 100 is a laptop computer, the closure magnet 130 may be disposed under the touchpad next to the keyboard. The second magnetic field sensor 140 is provided at a bezel at the top of the display screen, and the position of the second magnetic field sensor 140 is opposite to the position of the closure magnet 130, so that the second magnetic field sensor 140 can be employed for signal acquisition.

Exemplarily, the magnetic field strength of the closure magnet 130 can be different from the magnetic field strengths of the first camera magnet CT1 and the second camera magnet CT2, so that the first magnetic field sensor 120 and the second magnetic field sensor 140 can be set to be the same one magnetic field sensor, so that the same one magnetic field sensor can be employed for the signal acquisition, so as to reduce the number of magnetic field sensors. Of course, the first magnetic field sensor 120 and the second magnetic field sensor 140 can be two mutually independent magnetic field sensors respectively, which is not limited herein.

Exemplarily, as shown in FIG. 11A, when the display screen is closed, the S pole of the closure magnet 130 can be close to the display screen and the N pole of the closure magnet 130 can be far away from the display screen. Of course, when the display screen is closed, the N pole of the closure magnet 130 can be close to the display screen and the S pole of the closure magnet 130 can be far away from the display screen, which is not limited herein.

Exemplarily, as shown in FIG. 11A, taking the first magnetic field sensor 120 and the second magnetic field sensor 140 being set as the same one magnetic field sensor as an example, when the display screen is closed, the closure magnet 130 is close to the first magnetic field sensor 120, and the first magnetic field sensor 120 may be configured to: in response to the closure magnet 130, output a first screen state recognition signal to the logic controller 310. The logic controller 310 is further configured to: receive the first screen state recognition signal, and determine that the display device 100 is in the closed state in response to determining that the first screen state recognition signal is received.

Exemplarily, as shown in FIG. 11B, taking the first magnetic field sensor 120 and the second magnetic field sensor 140 being set as the same one magnetic field sensor as an example, when the display screen is not closed, the closure magnet 130 is far away from the first magnetic field sensor 120, and the first magnetic field sensor 120 may be configured to: output by default, a second screen state recognition signal to the logic controller 310. The logic controller 310 is further configured to: receive the second screen state recognition signal, and determine that the display device 100 is not in a closed state in response to determining that the second screen state recognition signal is received.

In some examples, taking the first magnetic field sensor 120 and the second magnetic field sensor 140 being set as the same one magnetic field sensor as an example, when the first magnetic field sensor 120 is a dual output Hall sensor, if the first connector 210 is not mounted to the second connector 110 and the display screen is not closed, a first output terminal of the dual output Hall sensor outputs a second level signal (e.g., a high level signal, indicated as “1”) and a second output terminal of the dual output Hall sensor outputs the second level signal (e.g., the high-level signal, indicated as “1”). The second level signal (e.g., the high-level signal, indicated as “1”) and the second level signal (e.g., the high level signal, indicated as “1”) not only can be sent to the logic controller 310 as the camera detection signal (e.g., “11”) corresponding to the un-access detection signal, but also can be sent to the logic controller 310 as the second screen state recognition signal (e.g., “11”), to enable the logic controller 310, in response to determining that the second screen state recognition signal is received, to determine that the display device 100 is currently in the open state.

Optionally, taking the first magnetic field sensor 120 and the second magnetic field sensor 140 being set as the same one magnetic field sensor as an example, when the first magnetic field sensor 120 is a dual output Hall sensor and when the first connector 210 is mounted to the second connector 110 and the display screen is not closed, if the camera module 200 is forward-mounted to the display device 100, the first output terminal of the dual output Hall sensor is triggered to output a first level signal (e.g., a low level signal, indicated as “0”), and the second output terminal of the dual output Hall sensor is triggered to output a second level signal (e.g., a high level signal, indicated as “1”). The first level signal (e.g., the low level signal, indicated as “0”) and the second level signal (e.g., the high level signal, indicated as “1”) not only can be sent to the logic controller 310 as the camera detection signal (e.g., “01”) corresponding to the forward access detection signal, but also can be sent to the logic controller 310 as the second screen state recognition signal (e.g., “01”), to enable the logic controller 310, in response to determining that the second screen state recognition signal is received, to determine that the display device 100 is currently in the non-closed state.

Optionally, taking the first magnetic field sensor 120 and the second magnetic field sensor 140 being set as the same one magnetic field sensor as an example, when the first magnetic field sensor 120 is a dual output Hall sensor and when the first connector 210 is mounted to the second connector 110 and the display screen is not closed, if the camera module 200 is reverse-mounted to the display device 100, the first output terminal of the dual output Hall sensor is triggered to output a second level signal (e.g., a high level signal, indicated as “1”), and the second output terminal of the dual output Hall sensor is triggered to output a first level signal (e.g., a low level signal, indicated as “0”). The second level signal (e.g., the high level signal, indicated as “1”) and the first level signal (e.g., the low level signal, indicated as “0”) not only can be sent to the logic controller 310 as the camera detection signal (e.g., “10”) corresponding to the reverse access detection signal, but also can be sent to the logic controller 310 as the second screen state recognition signal (e.g., “10”), to enable the logic controller 310, in response to determining that the second screen state recognition signal is received, to determine that the display device 100 is currently in the non-closed state.

In some examples, taking the first magnetic field sensor 120 and the second magnetic field sensor 140 being set as the same one magnetic field sensor as an example, when the first magnetic field sensor 120 is a dual-output Hall sensor, if the display screen is closed, regardless of whether the first connector 210 is mounted to the second connector 110, the dual-output Hall sensor can, in response to the closure magnet 130, output a signal. For example, the first output terminal of the dual output Hall sensor outputs a first level signal (e.g., a low level signal, indicated as “0”), and the second output terminal of the dual output Hall sensor outputs a first level signal (e.g., a low level signal, indicated as “0”). The first level signal (e.g., the low level signal, indicated as “0”) and the first level signal (e.g., the low level signal, indicated as “0”) can be sent to the logic controller 310 as the first screen state recognition signal (e.g., “00”), to enable the logic controller 310, in response to determining that the first screen state recognition signal is received, to determine that the display device 100 is currently in the closed state.

The above are only examples of some possible implementations for determining whether the display screen in a closed state or open state. In practice, there are other ways to determine whether the display screen is in a closed state or open state, which are not limited herein.

The working process of the electronic device provided by embodiments of the disclosure is described below in connection with FIGS. 10A to 11B.

The system controller 400, based on recognizing that the display device 100 is in an operating state, outputs an operation recognition signal to the logic controller 310. The logic controller 310, in response to receiving the operation recognition signal, determines whether the display device 100 is in a closed state. If the first magnetic field sensor 120, in response to the closure magnet 130, outputs the first screen state recognition signal to the logic controller 310, then the logic controller 310 can, based on the first screen state recognition signal, determine that the display device 100 is in the closed state. Regardless of whether the first connector 210 is mounted to the second connector 110, once determining that the display device 100 is in the closed state, the logic controller 310 can send the voltage output disable signal to the first switch circuit 322 to cause the first switch circuit 322 to be turned off, thereby stopping the supply of the camera power supply voltage VCC.

Since the closure magnet 130 is far away from the first magnetic field sensor 120, the second magnetic field sensor 140 is not triggered by the closure magnet 130 and outputs the second screen state recognition signal to the logic controller 310. The logic controller 310 may, based on the second screen state recognition signal, determine that the display device 100 is not in the closed state.

If the first output terminal of the dual output Hall sensor outputs a second level signal (e.g., a high level signal, indicated as “1”) and the second output terminal of the dual output Hall sensor output outputs the second level signal (e.g., the high level signal, indicated as “1”), the second level signal ((e.g., the high level signal, indicated as “1”) and the second level signal (e.g., the high level signal, indicated as “1”) not only can be sent to the logic controller 310 as the camera detection signal (e.g., “11”) corresponding to the un-access detection signal, but also can be sent to the logic controller 310 as the second screen state recognition signal (e.g., “11”), to enable the logic controller 310, in response to determining that the second screen state recognition signal is received, to determine that the display device 100 is currently in the non-closed state. The logic controller 310 compares the received camera detection signal (e.g., “11”) with the forward access detection signal, the reverse access detection signal, and the un-access detection signal, respectively, and if the camera detection signal is the same as the un-access detection signal (e.g., “11”), it can be determined that the camera detection signal is the un-access detection signal, and it indicates that the camera is not mounted to the display device 100. Then the logic controller 310 outputs the third mode configuration signal and the voltage output disable signal. The first switch circuit 322, in response to the voltage output disable signal, stops operation and stops providing the camera power supply voltage VCC to the multiplexer 321. The multiplexer 321, in response to the third mode configuration signal, stops operation, and disconnects the multiplexer 321 from the 1^{st} connection pin P1 to the 4^{th} connection pin P4, respectively, so as to reduce power consumption.

If the camera module 200 is forward-mounted to the display device 100, the first output terminal of the dual output Hall sensor is triggered to output a first level signal (e.g., a low level signal, indicated as “0”), and the second output terminal of the dual output Hall sensor is triggered to output a second level signal (e.g., a high level signal, indicated as “1”). The first level signal (e.g., the low level signal, indicated as “0”) and the second level signal (e.g., the high level signal, indicated as “1”) not only can be sent to the logic controller 310 as the camera detection signal (e.g., “01”) corresponding to the forward access detection signal, but also can be sent to the logic controller 310 as the second screen state recognition signal (e.g., “01”), to enable the logic controller 310, in response to determining that the second screen state recognition signal is received, to determine that the display device 100 is currently in the non-closed state. The logic controller 310 compares the received camera detection signal (e.g., “01”) with the forward access detection signal, the reverse access detection signal, and the un-access detection signal, respectively, and if the camera detection signal is the same as the forward access detection signal (e.g., “01”), it can be determined that the camera detection signal is the forward access detection signal, and it indicates that the camera is forward-mounted to the display device 100. Then the logic controller 310 outputs the first mode configuration signal and the voltage output enable signal. The first switch circuit 322, in response to the voltage output enable signal, is turned on and provides the camera power supply voltage VCC to the multiplexer 321. The multiplexer 321 operates in response to the first mode configuration signal, to provide the camera power supply voltage VCC to the 1^{st} connection pin P1, connect the 2^{nd} connection pin P2 with the first differential signal transmission terminal D+ of the image data transmission terminal, connect the 3^{rd} connection pin P3 with the second differential signal transmission terminal D− of the image data transmission terminal, and connect the 4^{th} connection pin P4 with the ground terminal GND. This allows the camera to capture an image in front of the display screen of the display device 100 and send the captured image data.

If the system controller 400 recognizes that the display device 100 is in a sleep state when the camera module 200 is forward-mounted to the display device 100, the system controller 400 outputs a sleep recognition signal to the logic controller 310. The logic controller 310, in response to receiving the sleep recognition signal, determines that the display device 100 is in the sleep state, and then sends the voltage output disable signal to the first switch circuit 322 to cause the first switch circuit 322 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

If the system controller 400 recognizes that the display device 100 is in a hibernate state when the camera module 200 is forward-mounted to the display device 100, the system controller 400 outputs a hibernate recognition signal to the logic controller 310. The logic controller 310, in response to receiving the hibernate recognition signal, determines that the display device 100 is in the hibernate state, and then sends the voltage output disable signal to the first switch circuit 322 to cause the first switch circuit 322 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

If the system controller 400 recognizes that the display device 100 is in an operating state when the camera module 200 is forward-mounted to the display device 100, the system controller 400 outputs an operation recognition signal to the logic controller 310. The logic controller 310, in response to receiving the first screen state recognition signal when it receives the operation recognition signal, can determine that the display device 100 is in a closed state, and then sends a voltage output disable signal to the first switch circuit 322 to cause the first switch circuit 322 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved. When the display screen changes from a closed state to a non-closed state, the closure magnet 130 is far away from the first magnetic field sensor 120, and the second magnetic field sensor 140 is not triggered by the closure magnet 130 and outputs the second screen state recognition signal to the logic controller 310. The logic controller 310, in response to receiving the second screen state recognition signal, can determine that the display device 100 is not in the closed state. The logic controller 310 may obtain the camera detection signal again, and based on the camera detection signal, determine whether the first switch circuit 322 needs to be turned on and whether the multiplexer 321 needs to be turned on. If there is no need to turn on the first switch circuit 322, the voltage output disable signal may be sent to the first switch circuit 322. If there is no need to turn on the multiplexer 321, the third mode configuration signal may be sent to the multiplexer 321. If the first switch circuit 322 needs to be turned on, the voltage output enable signal may be sent to the first switch circuit 322. If the multiplexer 321 needs to be turned on, the first mode configuration signal may be sent to the multiplexer 321.

If the camera module 200 is reverse-mounted to the display device 100, the first output terminal of the dual output Hall sensor is triggered to output a second level signal (e.g., a high level signal, indicated as “1”), and the second output terminal of the dual output Hall sensor is triggered to output a first level signal (e.g., a low level signal, indicated as “0”). The second level signal (e.g., the high level signal, indicated as “1”) and the first level signal (e.g., the low level signal, indicated as “0”) not only can be sent to the logic controller 310 as the camera detection signal (e.g., “10”) corresponding to the reverse access detection signal, but also can be sent to the logic controller 310 as the second screen state recognition signal (e.g., “10”), to enable the logic controller 310, in response to determining that the second screen state recognition signal is received, to determine that the display device 100 is currently in the non-closed state. The logic controller 310 compares the received camera detection signal (e.g., “10”) with the forward access detection signal, the reverse access detection signal, and the un-access detection signal, respectively, and if the camera detection signal is the same as the reverse access detection signal (e.g., “10”), it can be determined that the camera detection signal is the reverse access detection signal, and it indicates that the camera is reverse-mounted to the display device 100. Then the logic controller 310 outputs the second mode configuration signal and the voltage output enable signal. The first switch circuit 322, in response to the voltage output enable signal, is turned on and provides the camera power supply voltage VCC to the multiplexer 321. The multiplexer 321 operates in response to the second mode configuration signal, to provide the camera power supply voltage VCC to the 4^{th} connection pin P4, connect the 3^{rd} connection pin P3 with the first differential signal transmission terminal D+ of the image data transmission terminal, connect the 2^{nd} connection pin P2 with the second differential signal transmission terminal D− of the image data transmission terminal, and connect the 1^{st} connection pin P1 with the ground terminal GND. This allows the camera to capture an image of the back of the display screen of the display device 100 and send the captured image data.

If the system controller 400 recognizes that the display device 100 is in a sleep state when the camera module 200 is reverse-mounted to the display device 100, the system controller 400 outputs a sleep recognition signal to the logic controller 310. The logic controller 310, in response to receiving the sleep recognition signal, determines that the display device 100 is in the sleep state, and then sends the voltage output disable signal to the first switch circuit 322 to cause the first switch circuit 322 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

If the system controller 400 recognizes that the display device 100 is in a hibernate state when the camera module 200 is reverse-mounted to the display device 100, the system controller 400 outputs a hibernate recognition signal to the logic controller 310. The logic controller 310, in response to receiving the hibernate recognition signal, determines that the display device 100 is in the hibernate state, and then sends the voltage output disable signal to the first switch circuit 322 to cause the first switch circuit 322 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

If the system controller 400 recognizes that the display device 100 is in an operating state when the camera module 200 is forward-mounted to the display device 100, the system controller 400 outputs an operation recognition signal to the logic controller 310. The logic controller 310, if it receives the first screen state recognition signal when it receives the operation recognition signal, can determine that the display device 100 is in a closed state, and then sends a voltage output disable signal to the first switch circuit 322 to cause the first switch circuit 322 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved. When the display screen changes from the closed state to a non-closed state, the closure magnet 130 is far away from the first magnetic field sensor 120, and the second magnetic field sensor 140 is not triggered by the closure magnet 130 and outputs the second screen state recognition signal to the logic controller 310. The logic controller 310, in response to receiving the second screen state recognition signal, can determine that the display device 100 is not in the closed state. The logic controller 310 may obtain the camera detection signal again, and based on the camera detection signal, determine whether the first switch circuit 322 needs to be turned on and whether the multiplexer 321 needs to be turned on. If the first switch circuit 322 does not need to be turned on, the voltage output disable signal may be sent to the first switch circuit 322. If the multiplexer 321 does not need to be turned on, the third mode configuration signal may be sent to the multiplexer 321. If the first switch circuit 322 needs to be turned on, the voltage output enable signal may be sent to the first switch circuit 322. If the multiplexer 321 needs to be turned on, the second mode configuration signal may be sent to the multiplexer 321.

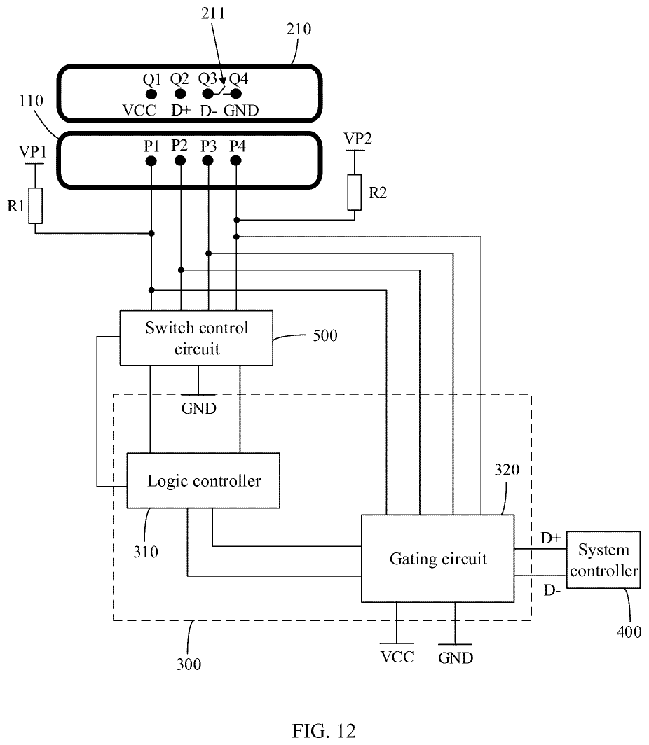

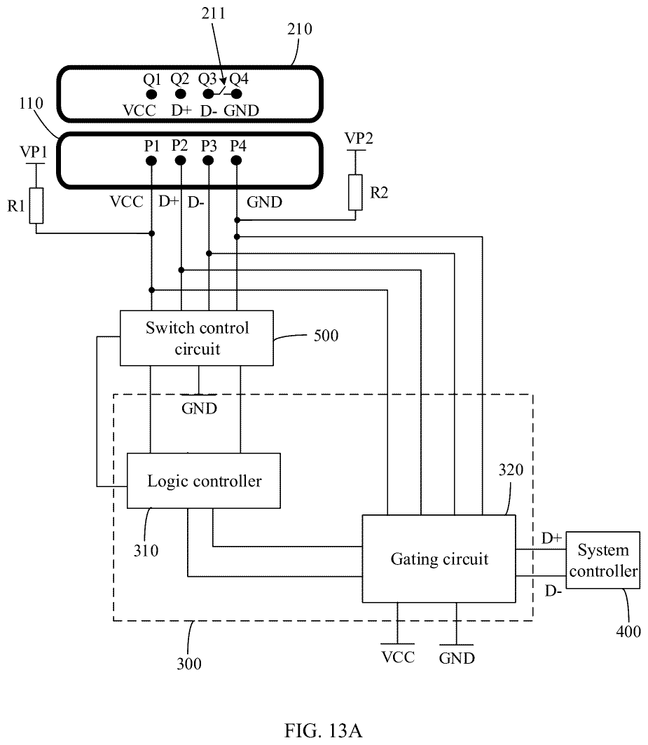

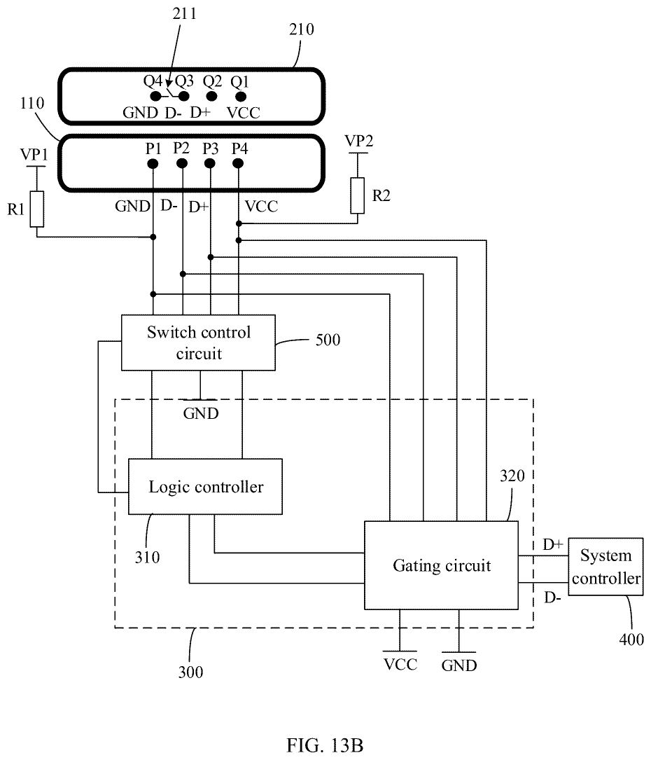

The embodiment of the disclosure provides another schematic diagram of some structures of the electronic device, as shown in FIG. 12, which is a variation of the implementations in the embodiments described above. Only the differences between the present embodiments and the above embodiments are described below, and the similarities are not repeated herein.

In the embodiments of the disclosure, as shown in FIG. 12, the detection control circuit 300 includes: a logic controller 310 and a gating circuit 320. The M^{th} connection contact is connected with the (M−1)^{th} connection contact via an electromagnetic switch 211. After the power is supplied to the camera module 200, the electromagnetic switch 211 is turned off. When the power is not supplied to the camera module 200, the electromagnetic switch 211 is turned on. Exemplarily, the electromagnetic switch includes, but is not limited to, a solenoid valve.

In the embodiments of the disclosure, as shown in FIG. 12, the display device 100 further includes: a first pull-up resistor R1, a second pull-up resistor R2, and a switch control circuit 500. A first pull-up voltage VP1 is provided to the 1^{st} connection pin P1 through the first pull-up resistor R1, so that the 1^{st} connection pin P1 can be pulled up at a high level by the first pull-up voltage VP1. The second pull-up voltage VP2 is provided to the N^{th} connection pin through the second pull-up resistor R2, so that the N^{th} connection pin P2 can be pulled up at a high level by the second pull-up voltage VP2.

Exemplarily, a resistance value of the first pull-up resistor R1 and a resistance value of the second pull-up resistor R2 may be the same or different, which are not limited herein.

Exemplarily, the first pull-up voltage VP1 and the second pull-up voltage VP2 may be the same or different, which are not limited herein.

Exemplarily, the first pull-up voltage VP1 and the second pull-up voltage VP2 may be inputted through a same one pull-up voltage terminal or may be inputted through two mutually independent pull-up voltage terminals, which are not limited herein.

In the embodiments of the disclosure, the logic controller 310 is connected with the 1^{st} connection pin P1 and the N^{th} connection pin via the switch control circuit 500, where the switch control circuit 500 may establish a conducting path between the 1^{st} connection pin P1 and the logic controller 310 and a conducting path between the N^{th} connection pin and the logic controller 310, respectively, or disconnect the 1^{st} connection pin P1 and the N^{th} connection pin from the logic controller 310, respectively. Exemplarily, taking N=M=4 as an example, as shown in FIG. 12, the logic controller 310 is connected with the 1^{st} connection pin P1 and the 4^{th} connection pin P4 via the switch control circuit 500, where the switch control circuit 500 may establish a conducting path between the 1^{st} connection pin P1 and the logic controller 310 as well as a conducting path between the 4^{th} connection pin P4 and the logic controller 310, respectively, or may disconnect the 1^{st} connection pin P1 and the 4^{th} connection pin P4 from the logic controller 310, respectively.

In the embodiments of the disclosure, the 2^{nd} connection pin P2 to the (N−1)^{th} connection pin each are connected with the ground terminal GND via the switch control circuit 500, and the switch control circuit 500 may establish a conducting path between each of the 2^{nd} connection pin P2 to the (N−1)^{th} connection pin with the ground terminal GND, respectively, or may disconnect the 2^{nd} connection pin P2 to the (N−1)^{th} connection pin from the ground terminal GND, respectively. Exemplarily, taking N=M=4 as an example, as shown in FIG. 12, the 2^{nd} connection pin P2 and the 3^{rd} connection pin P3 each are connected with the ground terminal GND via the switch control circuit 500, and the switch control circuit 500 may establish a conducting path between each of the 2^{nd} connection pin P2 and the 3^{rd} connection pin P3 with the ground terminal GND, respectively, or may disconnect the 2^{nd} connection pin P2 and the 3^{rd} connection pin P3 from the ground terminal GND.

In the embodiments of the disclosure, the switch control circuit 500 is further configured to: in response to the switch control enable signal, establish a conducting path between the 1^{st} connection pin P1 and the logic controller 310 and a conducting path between the N^{th} connection pin and the logic controller 310, and establish a conducting path between the ground terminal GND and each of the 2^{nd} connection pin P2 to the (N−1)^{th} connection pin.

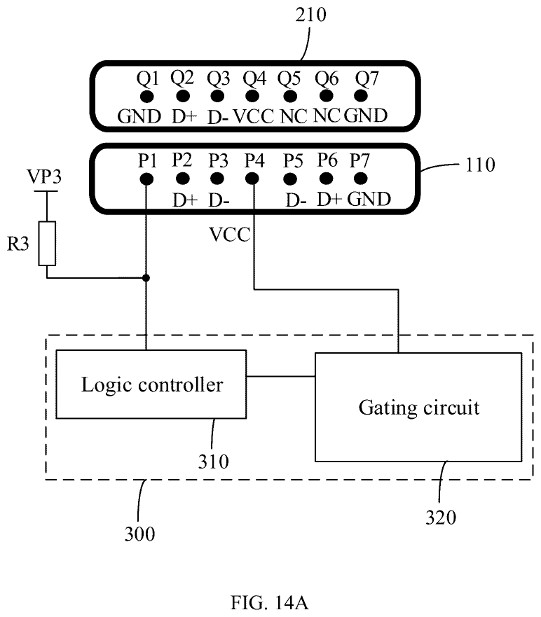

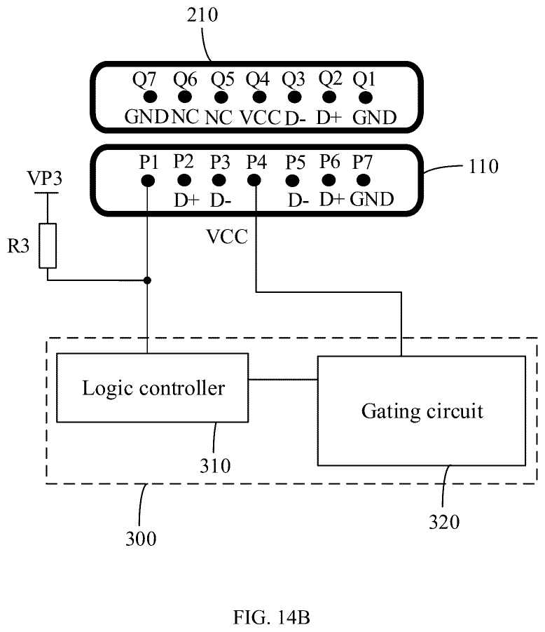

Exemplarily, as shown in FIGS. 12, 13A, and 13B, the switch control circuit 500 is further configured to: in response to the switch control enable signal, establish a conducting path between the 1^{st} connection pin P1 and the logic controller 310 and a conducting path between the 4^{th} connection pin P4 and the logic controller 310, and a conducting path between the 2^{nd} connection pin P2 and the ground terminal GND and a conducting path between the 3^{rd} connection pin P3 and the ground terminal GND.

In the embodiments of the disclosure, the switch control circuit 500 is further configured to: in response to the switch control disable signal, disconnect the 1^{st} connection pin P1 and the N^{th} connection pin from the logic controller 310, and disconnect the 2^{nd} connection pin P2 and the (N−1)^{th} connection pin from the ground terminal GND. Exemplarily, as shown in FIGS. 12 to 13B, the switch control circuit 500, in response to the switch control disable signal, disconnects the 1^{st} connection pin P1 and the 4^{th} connection pin P4 from the logic controller 310, and disconnects the 2^{nd} connection pin P2 and the 3^{rd} connection pin P3 from the ground terminal GND.

In embodiments of the disclosure, the logic controller 310 is further configured to: while the conducting path between the logic controller 310 and each of the 1^{st} connection pin P1 and the N^{th} connection pin is established via the switch control circuit 500, respectively, obtain a pin level signal of the 1^{st} connection pin P1 and a pin level signal of the N^{th} connection pin, and take the pin level signal of the 1^{st} connection pin and the pin level signal of the N^{th} connection pin as the camera detection signal; and when the pin level signal of the 1^{st} connection pin is a first level signal and the pin level signal of the N^{th} connection pin is a second level signal, determine that the camera detection signal is the forward access detection signal, and when the pin level signal of the 1^{st} connection pin is the second level signal and the pin level signal of the N^{th} connection pin is the first level signal, determine that the camera detection signal is the reverse access detection signal.

Exemplarily, taking N=M=4 as an example, as shown in 13A, the logic controller 310 is further configured to: while a conducting path between the logic controller 310 and each of the 1^{st} connection pin P1 and the 4^{th} connection pin P4 is established via the switch control circuit 500, respectively, obtain the pin level signal of the 1^{st} connection pin P1 and the pin level signal of the 4^{th} connection pin P4, and take the pin level signal of the 1^{st} connection pin P1 and the pin level signal of the 4^{th} connection pin P4 as the camera detection signal. Here, when the pin level signal of the 1^{st} connection pin P1 is a first level signal (e.g., a high level) and the pin level signal of the 4^{th} connection pin P4 is a second level signal (e.g., a low level), it is determined that the camera detection signal is the forward access detection signal. For example, if the camera module 200 is forward-mounted to the display device 100, the 3^{rd} connection contact Q3 and the 4^{th} connection contact Q4 of the camera module 200 form a current loop with the 3^{rd} connection pin P3 and the 4^{th} connection pin P4, so that the 4^{th} connection pin P4 is grounded, and the 4^{th} connection pin P4 is at a low level. The 1^{st} connection pin P1 is still pulled up at a high level by the first pull-up voltage VP1, so that the camera detection signal can be determined as the forward access detection signal.

Exemplarily, taking N=M=4 as an example, as shown in 13B, the logic controller 310 is further configured to: while the conducting path between the logic controller 310 and each of the 1^{st} connection pin P1 and the 4^{th} connection pin P4 is established via the switch control circuit 500, respectively, obtain the pin level signal of the 1^{st} connection pin P1 and the pin level signal of the 4^{th} connection pin P4, and take the pin level signal of the 1^{st} connection pin P1 and the pin level signal of the 4^{th} connection pin P4 as the camera detection signal. Here, when the pin level signal of the 1^{st} connection pin P1 is the second level signal (e.g., the low level) and the pin level signal of the 4^{th} connection pin P4 is the first level signal (e.g., the high level), it is determined that the camera detection signal is the reverse access detection signal. For example, if the camera module 200 is reverse-mounted to the display device 100, and the 3^{rd} connection contact Q3 and the 4^{th} connection contact Q4 of the camera module 200 form a current loop with the 1^{st} connection pin P1 and the 2^{nd} connection pin P2, so that the 1^{st} connection pin P1 is grounded, and the 1^{st} connection pin P1 is at a low level. The 4^{th} connection pin P4 is still pulled up at a high level by the second pull-up voltage VP2, so that the camera detection signal can be determined as the reverse access detection signal.

In the embodiments of the disclosure, the logic controller 310 is further configured to: in response to determining that the camera detection signal is the forward access detection signal and in response to determining that the camera detection signal is the reverse access detection signal, output the switch control disable signal to the switch control circuit 500, to control the switch control circuit 500 to disconnect the 1^{st} connection pin P1 and the N^{th} connection pin from the logic controller 310 and disconnect the 2^{nd} connection pin P2 to the (N−1)^{th} connection pin from the ground terminal GND.

In the embodiments of the disclosure, the system controller 400 is further configured to: based on recognizing that the first connector 210 is disconnected from the second connector 110, output a camera disconnect signal to the logic controller 310. The logic controller 310 is further configured to: in response to the camera disconnect signal, determine that the first connector 210 is disconnected from the second connector 110. Exemplarily, a state of connection between the first connector 210 and the second connector 110 is determined by an input/output module in the system controller 400, and based on recognizing that the first connector 210 is disconnected from the second connector 110, the camera disconnect signal is output to the logic controller 310. The logic controller 310 is further configured to: in response to the camera disconnect signal, determine that the first connector 210 is disconnected from the second connector 110.

Further, based on that the first connector 210 being connected with the second connector 110 is recognized, a camera connect signal is output to the logic controller 310. The logic controller 310 is further configured to: in response to the camera connect signal, determine that the first connector 210 is connected with the second connector 110.

In the embodiments of the disclosure, the logic controller 310 is further configured to: based on determining that the first connector 210 is disconnected from the second connector 110, output the switch control enable signal to the switch control circuit 500, to control the switch control circuit 500 to establish a conducting path between the 1^{st} connection pin P1 and the logic controller 310 and a conducting path between the N^{th} connection pin and the logic controller 310, and establish a conducting path between the ground terminal GND and each of the 2^{nd} connection pins P2 to the (N−1)^{th} connection pin. Further the logic controller 310 is further configured to: based on determining that the first connector 210 is connected with the second connector 110, obtain the camera detection signal.

The working process of the electronic device provided by embodiments of the disclosure is described below in conjunction with FIGS. 12 to 13B.

If the camera module 200 is forward-mounted to the display device 100, the 3^{rd} connection contact Q3 and the 4^{th} connection contact Q4 of the camera module 200 form a current loop with the 3^{rd} connection pin P3 and the 4^{th} connection pin P4, so that the 4^{th} connection pin P4 is grounded, and the 4^{th} connection pin P4 is at a low level. The 1^{st} connection pin P1 is still pulled up at a high level due to the first pull-up voltage VP1, so that the camera detection signal can be determined as the forward access detection signal. Additionally, the logic controller 310 outputs the switch control disable signal to the switch control circuit 500, to control the switch control circuit 500 to disconnect the 1^{st} connection pin P1 and the 4^{th} connection pin P4 from the logic controller 310 and disconnect the 2^{nd} connection pin P2 and the 3^{rd} connection pin P3 from the ground terminal GND. The logic controller 310 further outputs the first mode configuration signal to the gating circuit 320, to control the gating circuit 320 to provide the camera power supply voltage VCC to the 1^{st} connection pin P1, establish a conducting path between the 2^{nd} connection pin P2 and the first differential signal transmission terminal D+, establish a conducting path between the 3^{rd} connection pin P3 and the second differential signal transmission terminal D−, and establish a conducting path between the 4^{th} connection pin P4 and the ground terminal GND, so that the power is supplied to the camera module 200, and the electromagnetic switch 211 is turned off.

If the camera module 200 is reverse-mounted to the display device 100, the 3^{rd} connection contact Q3 and the 4^{th} connection contact Q4 of the camera module 200 form a current loop with the 1^{st} connection pin P1 and the 2^{nd} connection pin P2, so that the 1^{st} connection pin P1 is grounded, and the 1^{st} connection pin P1 is at a low level. The 4^{th} connection pin P4 is still pulled up at a high level due to the second pull-up voltage VP2, so that the camera detection signal can be determined as the reverse access detection signal. Additionally, the logic controller 310 outputs the switch control disable signal to the switch control circuit 500, to control the switch control circuit 500 to disconnect the 1^{st} connection pin P1 and the 4^{th} connection pin P4 from the logic controller 310, and disconnect the 2^{nd} connection pin P2 and the 3^{rd} connection pin P3 from the ground terminal GND. The logic controller 310 further outputs the second mode configuration signal to the gating circuit 320, to control the gating circuit 320 to provide the camera power supply voltage VCC to the 4^{th} connection pin P4, establish a conducting path between the 2^{nd} connection pin P2 and the second differential signal transmission terminal D−, establish a conducting path between the 3^{rd} connection pin P3 and the first differential signal transmission terminal D+, and establish a conducting path between the 1^{st} connection pin P1 and the ground terminal GND, so that the power is supplied to the camera module 200, and the electromagnetic switch 211 is turned off.

When the camera module 200 is removed or disconnected, the input/output module in the system controller 400 recognizes that the first connector 210 is disconnected from the second connector 110, and outputs the camera disconnect signal to the logic controller 310. The logic controller 310, based on the camera disconnect signal, can determine that the first connector 210 is disconnected from the second connector 110, and then outputs the switch control enable signal to the switch control circuit 500, to control the switch control circuit 500 to establish a conducting path between the logic controller 310 and each of the 1^{st} connection pin P1 and the 4^{th} connection pin P4, and establish a conducting path between the ground terminal GND and each of the 2^{nd} connection pin P2 and the 3^{rd} connection pin P3, so that the 1^{st} connection pin P1 is pulled up at a high level due to the first pull-up voltage VP1, the 4^{th} connection pin P4 is pulled up at a high level due to the second pull-up resistor R2, and both the 2^{nd} connection pin P2 and the 3^{rd} connection pin P3 are connected with the ground terminal GND.

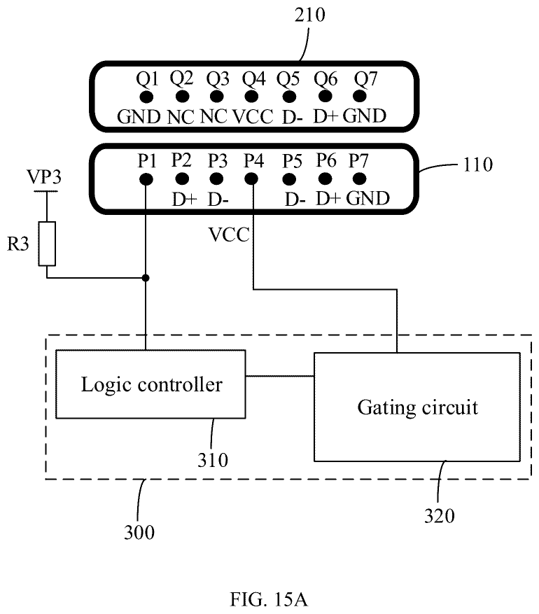

The embodiment of the disclosure provides another schematic diagram of some structures of the electronic device, as shown in FIG. 14A, which is a variation with respect to the implementations in the above-described embodiments. Only the differences between the present embodiments and the above embodiments are described below, and the similarities are not repeated herein.

In some embodiments of the disclosure, N may be set to an odd number, i.e., the number of connection pins on the second connector 110 is set to an odd number. Exemplarily, the N^{th} connection pin may be connected with the ground terminal GND. Here, the 2^{nd} connection pin P2 to the ((N−1)/2)^{th} connection pin and the ((N+3)/2)^{th} connection pin to the (N−1)^{th} connection pin are connected with the image data transmission terminal. Additionally, connection pins corresponding to the image data transmission terminal of the same performance, among the 2^{nd} connection pin P2 to the ((N−1)/2)^{th} connection pin and the (N+3)/2 connection pin to the (N−1)^{th} connection pin, are provided in mirror symmetry with respect to the ((N+1)/2)^{th} connection pin. Alternatively, the image data captured by the camera may be communicated based on the wireless communication technology. The camera module 200 may further include a first wireless communication component, and the camera module 200 may send the captured image data via the first wireless communication component. Further, the display device 100 further includes a second wireless communication component. The display device 100 communicates data with the first communication component via the second wireless communication component to obtain the image data sent from the first communication component.

Exemplarily, as shown in FIGS. 14A to 17B, the 7^{th} connection pin P7 may be connected with the ground terminal GND. The 2^{nd} connection pin P2, the 3^{rd} connection pin P3, the 5^{th} connection pin P5, and the 6^{th} connection pin P6 are connected with the image data transmission terminal. Optionally, the image data transmission terminal includes: the first differential signal transmission terminal D+ and the second differential signal transmission terminal D−, where the 2^{nd} connection pin P2 and the 6^{th} connection pin P6 are connected with the first differential signal transmission terminal D+, and the 3^{rd} connection pin P3 and the 5^{th} connection pin P5 are connected with the second differential signal transmission terminal D−.

In some embodiments of the disclosure, the number of connection contacts on the first connector 210 may be equal to the number of connection pins on the second connector 110, i.e., N=M, and N is set to an odd number. Exemplarily, the ((M+1)/2)^{th} connection contact is configured to be provided with the camera power supply voltage VCC, and the 1^{st} connection contact Q1 is connected with the M^{th} connection contact, which can be considered as that a conduction path is established between the 1^{st} connection contact Q1 and the M^{th} connection contact. Additionally, the M^{th} connection contact is configured to be connected with the ground terminal GND, so that after the conducting path between the M^{th} connection contact and the ground terminal GND is established, it means that the conducting path between the 1^{st} connection contact Q1 and the ground terminal GND is established.

In some examples, the 2^{nd} connection contact Q2 to the ((M−1)/2)^{th} connection contact are configured to be connected with the image data transmission terminal, and the ((M+3)/2))^{th} connection contact to the (N−1)^{th} connection contact are configured as virtual connection contacts. Here, the virtual connection contact means that the connection contact is in a floating state, i.e., it is not connected with other signal lines in the camera module 200 and does not transmit signals. Exemplarily, as shown in FIGS. 14A and 14B, taking N=M=7 as an example, the 4^{th} connection contact Q4 is configured to be provided with the camera power supply voltage VCC, and the 1^{st} connection contact Q1 is connected with the 7^{th} connection contact Q7, meaning that a conducting path is established between the 1^{st} connection contact Q1 and the 7^{th} connection contact Q7. Additionally, the 7^{th} connection contact Q7 is configured to be connected with the ground terminal GND, so that after the conducting path is established between the 7^{th} connection contact Q7 and the ground terminal GND, it means that the conducting path between the 1^{st} connection contact Q1 and the ground terminal GND is established. Additionally, the 2^{nd} connection contact Q2 and the 3^{rd} connection contact Q3 are configured to be connected with the image data transmission terminal, and the 5^{th} connection contact Q5 and the 6^{th} connection contact Q6 are configured as virtual connection contacts in a floating state (NC). Optionally, the image data transmission terminal includes: the first differential signal transmission terminal D+ and the second differential signal transmission terminal D−. The 2^{nd} connection contact Q2 is configured to be connected with the first differential signal transmission terminal D+, and the 3^{rd} connection contact Q3 is configured to be connected with the second differential signal transmission terminal D−. Further, the 2^{nd} connection pin P2 and the 6^{th} connection pin P6 are connected with the first differential signal transmission terminal D+, and the 3^{rd} connection pin P3 and the 5^{th} connection pin P5 are connected with the second differential signal transmission terminal D−.

Additionally, as shown in FIG. 14A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, the 5^{th} connection contact Q5 is mounted to the 5^{th} connection pin P5, the 6^{th} connection contact Q6 is mounted to the 6^{th} connection pin P6, and the 7^{th} connection contact Q7 is mounted to the 7^{th} connection pin P7.

As shown in FIG. 14B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, the 5^{th} connection contact Q5 is mounted to the 3^{rd} connection pin P3, the 6^{th} connection contact Q6 is mounted to the 2^{nd} connection pin P2, and the 7^{th} connection contact Q7 is mounted to the 1^{st} connection pin P1.

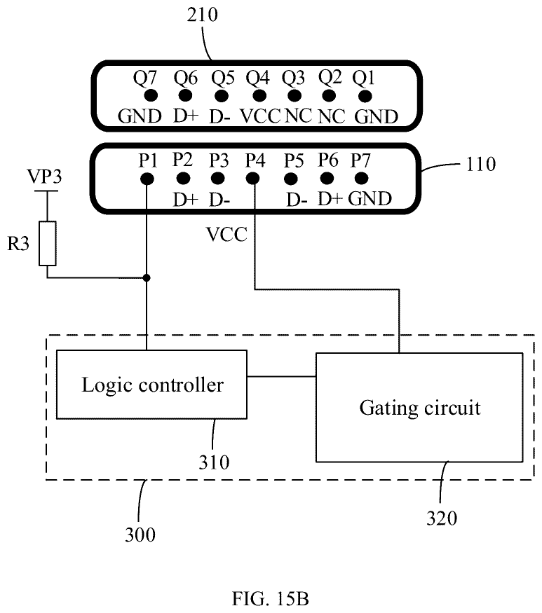

In some examples, the 2^{nd} connection contact Q2 to the ((M−1)/2)^{th} connection contact are configured as virtual connection contacts, and the ((M+3)/2))^{th} connection contact to the (N−1)^{th} connection contact are configured to be connected with the image data transmission terminal. Exemplarily, as shown in FIGS. 15A and 15B, taking N=M=7 as an example, the 4^{th} connection contact Q4 is configured to be provided with the camera power supply voltage VCC, and the 1^{st} connection contact Q1 is connected with the 7^{th} connection contact Q7, meaning that a conducting path is established between the 1^{st} connection contact Q1 and the 7^{th} connection contact Q7. Additionally, the 7^{th} connection contact Q7 is configured to be connected with the ground terminal GND, so that after the conducting path between the 7^{th} connection contact Q7 and the ground terminal GND is established, it means that the conducting path between the 1^{st} connection contact Q1 and the ground terminal GND is established. Additionally, the 2^{nd} connection contact Q2 and the 3^{rd} connection contact Q3 are configured as virtual connection contacts that are in a floating state (NC), and the 5^{th} connection contact Q5 and the 6^{th} connection contact Q6 are configured to be connected with the image data transmission terminal. Optionally, the image data transmission terminal includes: the first differential signal transmission terminal D+ and the second differential signal transmission terminal D−. The 6^{th} connection contact Q6 is configured to be connected with the first differential signal transmission terminal D+, and the 5^{th} connection contact Q5 is configured to be connected with the second differential signal transmission terminal D−. Further, the 2^{nd} connection pin P2 and the 6^{th} connection pin P6 are connected with the first differential signal transmission terminal D+, and the 3^{rd} connection pin P3 and the 5^{th} connection pin P5 are connected with the second differential signal transmission terminal D−.

As shown in FIG. 15A, when the camera module 200 is forward-mounted to the display device 100, the 1^{st} connection contact Q1 is connected to the 1^{st} connection pin P1, the 2^{nd} connection contact Q2 is connected to the 2^{nd} connection pin P2, the 3^{rd} connection contact Q3 is connected to the 3^{rd} connection pin P3, the 4^{th} connection contact Q4 is connected to the 4^{th} connection pin P4, the 5^{th} connection contact Q5 is connected to the 5^{th} connection pin P5, the 6^{th} connection contact Q6 is connected to the 6^{th} connection pin P6, and the 7^{th} connection contact Q7 is connected to the 7^{th} connection pin P7.

As shown in FIG. 15B, when the camera module 200 is reverse-mounted to the display device 100, the 1^{st} connection contact Q1 is connected to the 7^{th} connection pin P7, the 2^{nd} connection contact Q2 is connected to the 6^{th} connection pin P6, the 3^{rd} connection contact Q3 is connected to the 5^{th} connection pin P5, the 4^{th} connection contact Q4 is connected to the 4^{th} connection pin P4, the 5^{th} connection contact Q5 is connected to the 3^{rd} connection pin P3, the 6^{th} connection contact Q6 is connected to the 2^{nd} connection pin P2, and the 7^{th} connection contact Q7 is connected to the 1^{st} connection pin P1.

In some embodiments of the disclosure, the number of connection pins on the second connector 110 can be greater than the number of connection contacts on the first connector 210, i.e., N≥M. Exemplarily, the 1^{st} connection contact Q1 is connected with the M^{th} connection contact, meaning that a conducting path is established between the 1^{st} connection contact Q1 and the M^{th} connection contact. Additionally, the M^{th} connection contact is configured to be connected with the ground terminal GND, so that after the conducting path between the M¹n connection contact and the ground terminal GND is established, it means that the conducting path is established between the 1^{st} connection contact Q1 and the ground terminal GND. Further, the N^{th} connection pin is connected with the ground terminal GND, and the 2^{nd} connection pin P2 to the ((N−1)/2)^{th} connection pin and the ((N+3)/2)^{th} connection pin to the (N−1)^{th} connection pin are connected with the image data transmission terminal. Additionally, connection pins corresponding to the image data transmission terminal with the same performance, among the 2^{nd} connection pin P2 to the ((N−1)/2)^{th} connection pin and the ((N+3)/2)^{th} connection pin to the (N−1)^{th} connection pin, are provided in mirror symmetry with respect to the ((N+1)/2)^{th} connection pin.

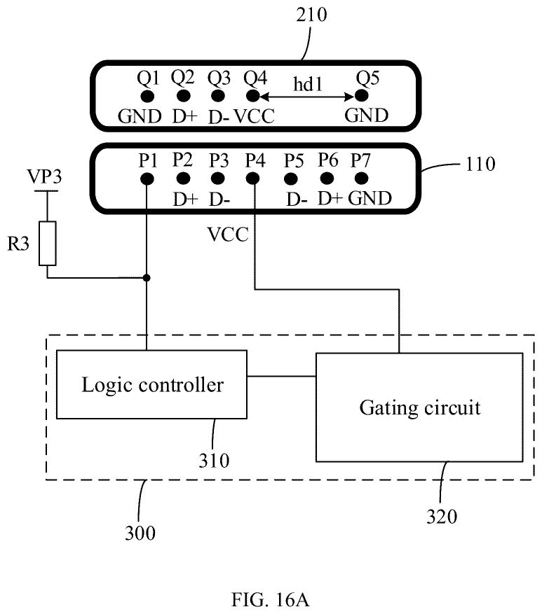

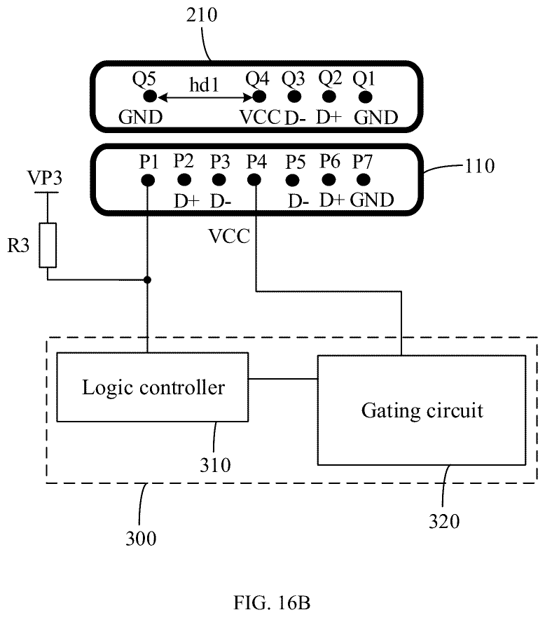

In some examples, the 2^{nd} connection contact Q2 to the (N−2)^{th} connection contact are configured to be connected with the image data transmission terminal, the (M−1)^{th} connection contact is configured to be provided with the camera power supply voltage VCC, a first spacing distance hd1 is provided between the (N−1)^{th} connection contact and the N^{th} connection contact, the first spacing distance hd1 is substantially (N−M+1)*h, and h is a spacing distance between two adjacent connection contacts. Exemplarily, as shown in FIGS. 16A and 16B, taking M=5 and N=7 as an example, the 4^{th} connection contact Q4 is configured to be provided with the camera power supply voltage VCC, and the 1^{st} connection contact Q1 is connected with the 5^{th} connection contact Q5, meaning that a conducting path is established between the 1^{st} connection contact Q1 and the 5^{th} connection contact Q5. Additionally, the 5^{th} connection contact Q5 is configured to be connected with the ground terminal GND, so that after the conducting path between the 5^{th} connection contact Q5 and the ground terminal GND is established, it means that the conducting path is established between the 1^{st} connection contact Q1 and the ground terminal GND. Additionally, the 2^{nd} connection contact Q2 and the 3^{rd} connection contact Q3 are configured to be connected with the image data transmission terminal, and a first spacing distance hd1 is provided between the 4^{th} connection contact Q4 and the 5^{th} connection contact Q5, where the first spacing distance hd1 is substantially 3*h. Optionally, the image data transmission terminal includes: the first differential signal transmission terminal D+ and the second differential signal transmission terminal D−. The 2^{nd} connection contact Q2 is configured to be connected with the first differential signal transmission terminal D+, and the 3^{rd} connection contact Q3 is configured to be connected with the second differential signal transmission terminal D−. Further, the 2^{nd} connection pin P2 and the 6^{th} connection pin P6 are connected with the first differential signal transmission terminal D+, and the 3^{rd} connection pin P3 and the 5^{th} connection pin P5 are connected with the second differential signal transmission terminal D−.

Additionally, as shown in FIG. 16A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, and the 5^{th} connection contact Q5 is mounted to the 7^{th} connection pin P7.

As shown in FIG. 16B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, and the 5^{th} connection contact Q5 is mounted to the 1^{st} connection pin P1.

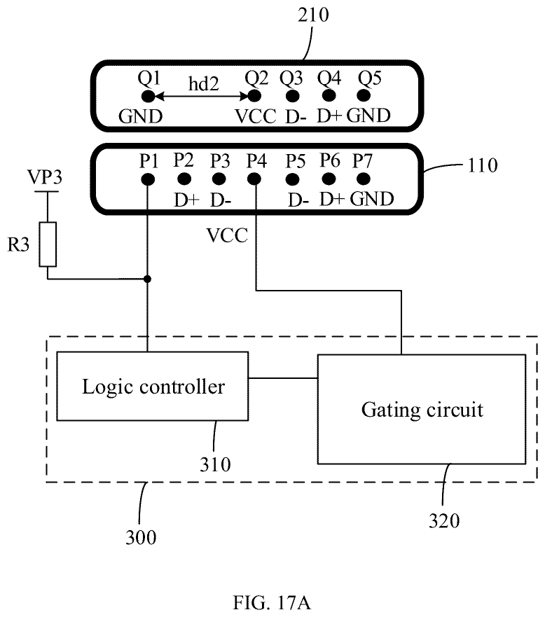

In some examples, the 3^{rd} connection contact Q3 to the (N−1)^{th} connection contact are configured to be connected with the image data transmission terminal, the 2^{nd} connection contact Q2 is configured to be provided with the camera power supply voltage VCC, a second spacing distance hd2 is provided between the 1^{st} connection contact Q1 and the 2^{nd} connection contact Q2, the second spacing distance hd2 is substantially (N−M+1)*h, and h is a spacing distance between two adjacent connection contacts. Exemplarily, as shown in FIGS. 17A and 17B, taking M=5 and N=7 as an example, the 2^{nd} connection contact Q2 is configured to be provided with the camera power supply voltage VCC, and the 1^{st} connection contact Q1 is connected with the 5^{th} connection contact Q5, meaning that a conducting path is established between the 1^{st} connection contact Q1 and the 5^{th} connection contact Q5. Additionally, the 5^{th} connection contact Q5 is configured to be connected with the ground terminal GND, so that after the conducting path between the 5^{th} connection contact Q5 and the ground terminal GND is established, it means that the conducting path between the 1^{st} connection contact Q1 and the ground terminal GND is established. Additionally, the 3^{rd} connection contact Q3 and the 4^{th} connection contact Q4 are configured to be connected with the image data transmission terminal, and a second spacing distance hd2 is provided between the 1^{st} connection contact Q1 and the 2^{nd} connection contact Q2, where the second spacing distance hd2 is substantially 3*h. Optionally, the image data transmission terminal includes: a first differential signal transmission terminal D+ and a second differential signal transmission terminal D−. The 4^{th} connection contact Q4 is configured to be connected with the first differential signal transmission terminal D+, and the 3^{rd} connection contact Q3 is configured to be connected with the second differential signal transmission terminal D−. Further, the 2^{nd} connection pin P2 and the 6^{th} connection pin P6 are connected with the first differential signal transmission terminal D+, and the 3^{rd} connection pin P3 and the 5^{th} connection pin P5 are connected with the second differential signal transmission terminal D−.

Additionally, as shown in FIG. 17A, when the camera module 200 is forward-mounted to the display device 100, the 1^{st} connection contact Q1 is mounted to the 1^{st} connection pin P1, the 2^{nd} connection contact Q2 is mounted to the 4^{th} connection pin P4, the 3^{rd} connection contact Q3 is mounted to the 5^{th} connection pin P5, the 4^{th} connection contact Q4 is mounted to the 6^{th} connection pin P6, and the 5^{th} connection contact Q5 is mounted to the 7^{th} connection pin P7.

As shown in FIG. 17B, when the camera module 200 is reverse-mounted to the display device 100, the 1^{st} connection contact Q1 is mounted to the 7^{th} connection pin P7, the 2^{nd} connection contact Q2 is mounted to the 4^{th} connection pin P4, the 3^{rd} connection contact Q3 is mounted to the 3^{rd} connection pin P3, the 4^{th} connection contact Q4 is mounted to the 2^{nd} connection pin P2, and the 5^{th} connection contact Q5 is mounted to the 1^{st} connection pin P1.

In the embodiments of the disclosure, the detection control circuit 300 includes: a logic controller 310 and a gating circuit 320. Here, the gating circuit 320 is connected with the logic controller 310 and the ((N+1)/2)^{th} connection pin, respectively. Additionally, the logic controller 310 is configured to: based on determining that the display device 100 is in an operating state, obtain a camera presence detection signal, and based on determining that the camera presence detection signal is a valid signal indicating that the camera is mounted on the display device 100, output a voltage output enable signal. The gating circuit 320 is configured to receive the voltage output enable signal, and in response to the voltage output enable signal, provide the camera power supply voltage VCC to the ((N+1)/2)^{th} connection pin to supply power to the camera module 200. Exemplarily, as shown in FIGS. 14A to 17B, the gating circuit 320 may, in response to the voltage output enable signal, provide the camera power supply voltage VCC to the 4^{th} connection pin P4 to supply power to the camera module 200.

In the embodiments of the disclosure, the logic controller 310 is configured to: based on determining that the camera presence detection signal is an invalid signal, output a voltage output disable signal. The gating circuit 320 receives the voltage output disable signal, and in response to the voltage output disable signal, stops providing the camera power supply voltage VCC to the ((N+1)/2)^{th} connection pin. Exemplarily, as shown in FIGS. 14A to 17B, the gating circuit 320 may, in response to the voltage output disable signal, stop providing the camera power supply voltage VCC to the 4^{th} connection pin P4 to stop supplying power to the camera module 200, so as to reduce power consumption.

In the embodiments of the disclosure, the display device 100 further includes: a third pull-up resistor R3, and a third pull-up voltage VP3 is provided to the 1^{st} connection pin P1 via the third pull-up resistor R3. The logic controller 310 is further connected with the 1^{st} connection pin P1, and the logic controller 310 is further configured to obtain a third pin level signal of the 1^{st} connection pin P1, and take the third pin level signal as the camera presence detection signal. Exemplarily, as shown in FIGS. 14A to 15B, the third pull-up voltage VP3 is provided to the 1^{st} connection pin P1 through the third pull-up resistor R3, and when the camera module 200 is not connected with the display device 100, the 1^{st} connection pin P1 is pulled up through the third pull-up voltage VP3, and in this case, the third pin level signal of the 1^{st} connection pin P1 obtained by the logic controller 310 is a high level signal. Since the third pin level signal serves as the camera presence detection signal, when the camera presence detection signal is the high level signal, it indicates that the camera presence detection signal is an invalid signal. When the camera module 200 is forward-mounted on the display device 100, the conducting path between the 1^{st} connection pin P1 and the ground terminal GND is established through the 1^{st} connection contact Q1, the 7^{th} connection contact Q7, and the 7^{th} connection pin P7, so that the 1^{st} connection pin P1 is pulled down by the ground terminal GND, and at this time, the third pin level signal of the 1^{st} connection pin P1 obtained by the logic controller 310 is a low level signal. Since the third pin level signal serves as the camera presence detection signal, when the camera presence detection signal is the low level signal, it indicates that the camera presence detection signal is a valid signal.

In some embodiments of the disclosure, the system controller 400 is configured to: based on recognizing that the display device 100 is in the sleep state, output a sleep recognition signal to the logic controller 310, and the logic controller 310 is further configured to: based on receiving the sleep recognition signal, determine that the display device 100 is in the sleep state, and based on determining that the display device 100 is in the sleep state, send the voltage output disable signal to the gating circuit 320. The gating circuit 320 receives the voltage output disable signal, and in response to the voltage output disable signal, stops providing the camera power supply voltage VCC to the ((N+1)/2)^{th} connection pin. This can be configured to have a first priority, regardless of whether the first connector 210 is mounted to the second connector 110, as long as determining that the display device 100 is in the sleep state, the voltage output disable signal can be sent to the gating circuit 320 to cause the gating circuit 320 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

In some embodiments of the disclosure, the system controller 400 is configured to: based on recognizing that the display device 100 is in the hibernate state, output a hibernate recognition signal to the logic controller 310, and the logic controller 310 is further configured to: based on receiving the hibernate recognition signal, determine that the display device 100 is in the hibernate state, and based on determining that the display device 100 is in the hibernate state, send the voltage output disable signal to the gating circuit 320. The gating circuit 320 receives the voltage output disable signal, and in response to the voltage output disable signal, stops providing the camera power supply voltage VCC to the ((N+1)/2)^{th} connection pin. This can be configured to have a first priority, regardless of whether the first connector 210 is mounted to the second connector 110, as long as determining that the display device 100 is in the hibernate state, the voltage output disable signal can be sent to the gating circuit 320, to cause the gating circuit 320 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

In the embodiments of the disclosure, the system controller 400 is configured to: based on recognizing that the display device 100 is in an operating state, output an operation recognition signal to the logic controller 310. The logic controller 310 is further configured to: based on receiving the operation recognition signal, determine whether the display device 100 is in a closed state. Here, the logic controller 310, based on determining that the display device 100 is in the closed state, sends the voltage output disable signal to the gating circuit 320. The gating circuit 320 receives the voltage output disable signal, and in response to the voltage output disable signal, stops providing the camera power supply voltage VCC to the ((N+1)/2)^{th} connection pin. This can be configured to have a second priority, regardless of whether the first connector 210 is mounted to the second connector 110, as long as determining that the display device 100 is in the closed state, the voltage output disable signal can be sent to the gating circuit 320, to cause the gating circuit 320 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

Further, the logic controller 310, based on determining that the display device 100 is not in a closed state, may obtain the camera presence detection signal, and determines whether the gating circuit 320 needs to be turned on according to the camera presence detection signal.

The working process in the embodiments of the disclosure based on determining that the display screen is in the closed state and determining that the display screen is not in the closed state can be referred to the working process of the mutual combination of the second magnetic field sensor and the closure magnet as described above, which will not be repeated herein.

The working process of the electronic device provided by the embodiments of the disclosure is described below in conjunction with FIGS. 14A and 14B.

If the camera module 200 is forward-mounted to the display device 100, the 1^{st} connection contact Q1 and the 7^{th} connection contact Q7 of the camera module 200 form a current loop with the 1^{st} connection pin P1 and the 7^{th} connection pin P7, so that the 1^{st} connection pin P1 is grounded, and the 1^{st} connection pin P1 is at a low level. The logic controller 310 obtains the third pin level signal of the 1^{st} connection pin P1 as a low level signal, determines that the camera presence detection signal is a valid signal indicating that the camera is mounted on the display device 100, outputs the voltage output enable signal, and controls the gating circuit to provide the camera power supply voltage VCC to the 4^{th} connection pin P4 to supply power to the camera module 200.

If the system controller recognizes that the display device 100 is in a sleep state when the camera module 200 is forward-mounted to the display device 100, the system controller outputs a sleep recognition signal to the logic controller 310. The logic controller 310, based on receiving the sleep recognition signal, determines that the display device 100 is in the sleep state, and then sends the voltage output disable signal to the gating circuit 320 to cause the gating circuit 320 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

If the system controller recognizes that the display device 100 is in a hibernate state when the camera module 200 is forward-mounted to the display device 100, the system controller outputs a hibernate recognition signal to the logic controller 310. The logic controller 310, based on receiving the hibernate recognition signal, determines that the display device 100 is in the hibernate state, and then sends the voltage output disable signal to the gating circuit 320 to force the gating circuit 320 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved.

If the system controller recognizes that the display device 100 is in an operating state when the camera module 200 is forward-mounted to the display device 100, the system controller outputs an operation recognition signal to the logic controller 310. The logic controller 310, if it receives the first screen state recognition signal when it receives the operation recognition signal, can determine that the display device 100 is in a closed state, and then sends a voltage output disable signal to the gating circuit 320 to force the gating circuit 320 to be turned off, thereby stopping providing the camera power supply voltage VCC to the camera module 200. In this way, the power supply of the camera module 200 can be intelligently controlled, current protection capability can be improved, user experience can be enhanced, and the reliability and safety of the power supply of the camera module 200 can be improved. When the display screen changes from the closed state to a non-closed state, the closure magnet 130 is far away from the first magnetic field sensor 120, and the second magnetic field sensor 140 is not triggered by the closure magnet 130 and outputs the second screen state recognition signal to the logic controller 310. The logic controller 310, based on receiving the second screen state recognition signal, can determine that the display device 100 is not in the closed state. The logic controller 310 may obtain the camera presence detection signal again, and determine whether the gating circuit 320 needs to be turned on according to the camera presence detection signal.

Similarly, the working process of the camera module 200 reverse mounted to the display device 100 can be followed in an analogous manner, which will not be repeated herein.

The embodiment of the disclosure provides another schematic diagram of some structures of the electronic device, as shown in FIG. 18, which is a variation with respect to the implementations in the above-described embodiments. Only the differences between the present embodiments and the above embodiments are described below, and the similarities are not repeated herein.

In some embodiments of the disclosure, connection pins corresponding to the same function are mirror symmetric with respect to the ((N+1)/2)^{th} connection pin. In some examples, the number of connection contacts on the first connector 210 may be equal to the number of connection pins on the second connector 110, i.e., N=M, and N is set to an odd number. Of course, it is also possible to make N≥M, which is not limited herein.

Exemplarily, the ((N+1)/2)^{th} connection contact is configured to be connected with the ground terminal GND, the M^{th} connection contact is configured to be provided with the camera power supply voltage VCC, and the 1^{st} connection contact Q1 and the ((M+1)/2)^{th} connection contact are configured to be connected with the ground terminal GND, meaning that a conducting path is established between the 1^{st} connection contact Q1 and the ((M+1)/2)^{th} connection contact. After the conducting path is established between the ((M+1)/2)^{th} connection contact and the ground terminal GND, it means that the conducting path is established between the 1^{st} connection contact Q1 and the ground terminal GND. Further, the ((N+1)/2)^{th} connection pin is connected with the ground terminal GND, and the 2^{nd} connection pin P2 to the ((N−1)/2)^{th} connection pin and the ((N+3)/2)^{th} connection pin to the (N−1)^{th} connection pin are connected with the image data transmission terminal. Additionally, connection pins corresponding to the image data transmission terminal with the same performance, among the 2^{nd} connection pin P2 to the ((N−1)/2)^{th} connection pin and the ((N+3)/2)^{th} connection pin to the (N−1)^{th} connection pin, are provided in mirror symmetry with respect to the ((N+1)/2)^{th} connection pin. Of course, the image data captured by the camera may be communicated based on the wireless communication technology. The camera module 200 may further include a first wireless communication component, and the camera module 200 may send the captured image data via the first wireless communication component. Further, the display device 100 further includes a second wireless communication component. The display device 100 communicates data with the first communication component via the second wireless communication component to obtain the image data sent by the first communication component.

In some examples, the 2^{nd} connection contact Q2 to the ((M−1)/2)^{th} connection contact are configured to be connected the image data transmission terminal, and the ((M+3)/2))^{th} connection contact to the (N−1)^{th} connection contact are configured to be connected the image data transmission terminal. Exemplarily, as shown in FIG. 18, taking N=M=5 as an example, the 1^{st} connection contact Q1 and the 3^{rd} connection contact Q3 are configured to be connected with the ground terminal GND, meaning that a conduction path is established between the 1^{st} connection contact Q1 and the 3^{rd} connection contact Q3. Additionally, after the conducting path between the 3^{rd} connection contact Q3 and the ground terminal GND is established, it means that the conducting path between the 1^{st} connection contact Q1 and the ground terminal GND is established. The 5^{th} connection contact Q5 is configured to be provided with the camera power supply voltage VCC, and the 2^{nd} connection contact Q2 and the 4^{th} connection contact Q4 are configured to be connected with the image data transmission terminal. Optionally, the image data transmission terminal includes: the first differential signal transmission terminal D+ and the second differential signal transmission terminal D−. The 2^{nd} connection contact Q2 is configured to be connected with the first differential signal transmission terminal D+, and the 3^{rd} connection contact Q3 is configured to be connected with the second differential signal transmission terminal D−.

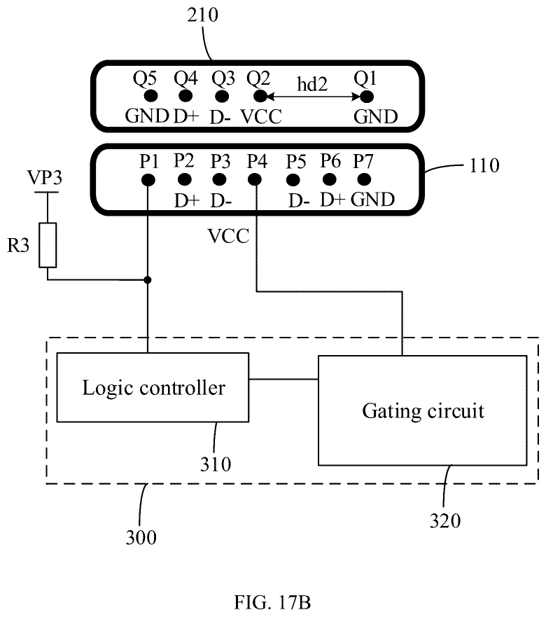

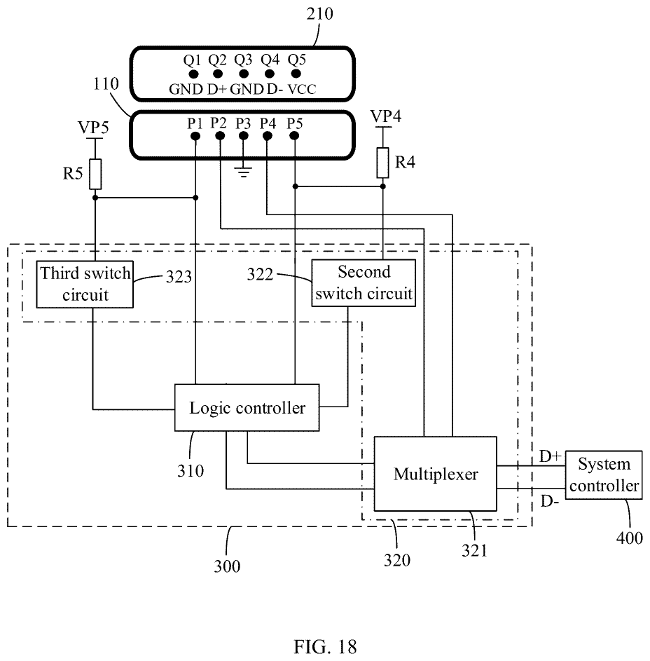

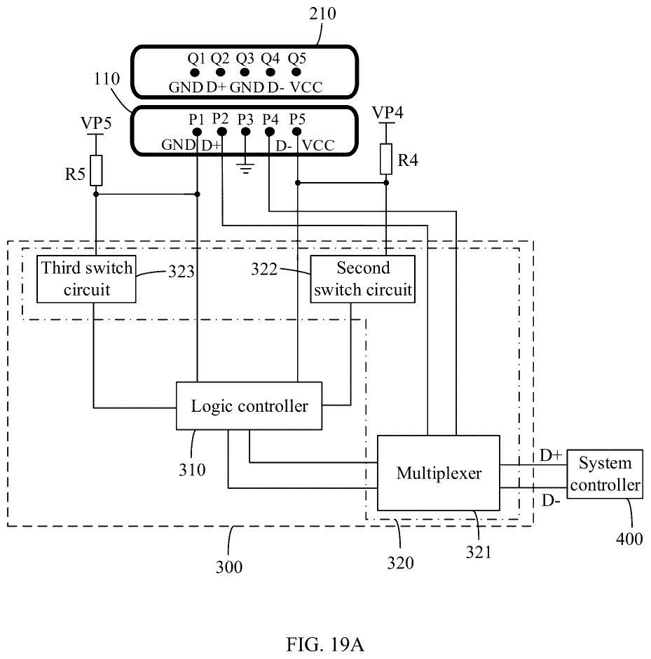

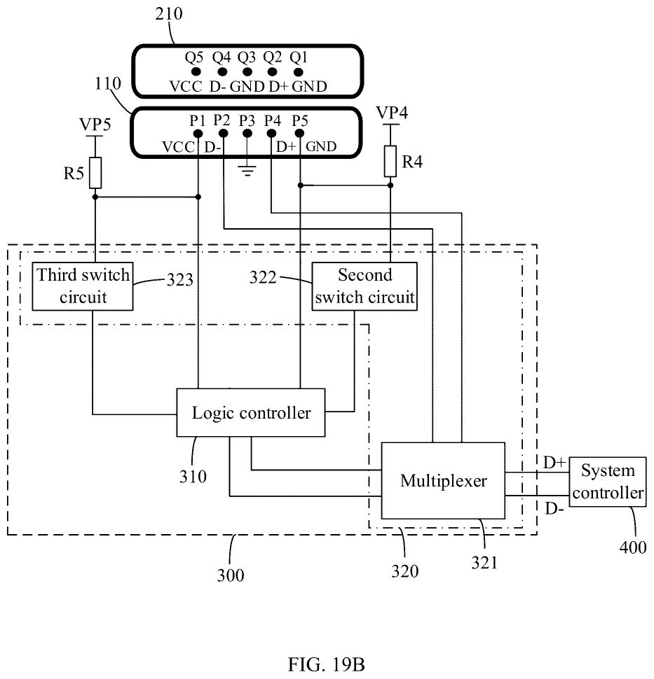

Additionally, as shown in FIG. 19A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, and the 5^{th} connection contact Q5 is mounted to the 5^{th} connection pin P5.

As shown in FIG. 19B, when the camera module 200 is reverse-mounted to the display device 100, the 1^{st} connection contact Q1 is mounted to the 5^{th} connection pin P5, the 2^{nd} connection contact Q2 is mounted to the 4^{th} connection pin P4, the 3^{rd} connection contact Q3 is mounted to the 3^{rd} connection pin P3, the 4^{th} connection contact Q4 is mounted to the 2^{nd} connection pin P2, and the 5^{th} connection contact Q5 is mounted to the 1^{st} connection pin P1.

In embodiments of the disclosure, the detection control circuit 300 includes: a logic controller 310 and a gating circuit 320. The gating circuit 320 is connected with the logic controller 310, the (a+M−1)^{th} connection pin, and the b^{th} connection pin, respectively. Additionally, the logic controller 310 is configured to: obtain the camera detection signal, and based on determining that the camera detection signal is the forward access detection signal, output the first mode configuration signal and the voltage output enable signal. The gating circuit 320 is configured to receive the first mode configuration signal and the voltage output enable signal, and in response to the first mode configuration signal and the voltage output enable signal, provide the camera power supply voltage VCC to the (a+M−1)^{th} connection pin. Exemplarily, as shown in FIG. 19A, the gating circuit 320 is configured to receive the first mode configuration signal and the voltage output enable signal, and in response to the first mode configuration signal and the voltage output enable signal, provide the camera power supply voltage VCC to the 5^{th} connection pin P5.

Exemplarily, the gating circuit 320 includes: a second switch circuit. The second switch circuit is connected with the logic controller 310 and the (a+M−1)^{th} connection pin, respectively, and is configured to: receive the voltage output enable signal, and in response to the voltage output enable signal, provide the camera power supply voltage VCC to the (a+M−1)^{th} connection pin. Exemplarily, as shown in FIG. 19A, the second switch circuit is configured to receive the voltage output enable signal, and in response to the voltage output enable signal, provide the camera power supply voltage VCC to the 5^{th} connection pin P5.

Exemplarily, a control terminal of the second switch circuit is configured to receive the voltage output enable signal and the voltage output disable signal, and a first terminal thereof is configured to receive the camera power supply voltage VCC, and a second terminal thereof is connected with the (a+M−1)^{th} connection pin. The second switch circuit is turned on under the control of the voltage output enable signal to provide the camera power supply voltage VCC to the (a+M−1)^{th} connection pin. Further, the second switch circuit is turned off under the control of the voltage output disable signal to stop providing the camera power supply voltage VCC to the (a+M−1)^{th} connection pin. Optionally, the second switch circuit includes, but is not limited to, a transistor(s), a triode(s), a digital switch(es), an analog switch(es).

In the embodiments of the disclosure, the logic controller 310 is configured to: based on determining that the camera detection signal is the reverse access detection signal, output the second mode configuration signal and the voltage output enable signal. The gating circuit 320 is configured to receive the second mode configuration signal and the voltage output enable signal, and in response to the second mode configuration signal and the voltage output enable signal, provide the camera power supply voltage VCC to the b^{th} connection pin.

Exemplarily, as shown in FIG. 19B, the gating circuit 320 is configured to receive the first mode configuration signal and the voltage output enable signal, and in response to the first mode configuration signal and the voltage output enable signal, provide the camera power supply voltage VCC to the 1^{st} connection pin P1.

Exemplarily, the gating circuit 320 includes: a third switch circuit. The third switch circuit is connected with the logic controller 310 and the b^{th} connection pin, respectively, and is configured to: receive the voltage output enable signal, and in response to the voltage output enable signal, provide the camera power supply voltage VCC to the b^{th} connection pin. Exemplarily, as shown in FIG. 19B, the third switch circuit is configured to receive the voltage output enable signal, and in response to the voltage output enable signal, provide the camera power supply voltage VCC to the 1^{st} connection pin P1.

Exemplarily, a control terminal of the third switch circuit is configured to receive the voltage output enable signal and the voltage output disable signal, and a first terminal thereof is configured to receive the camera power supply voltage VCC, and a second terminal thereof is connected with the b^{th} connection pin. The third switch circuit is turned on under the control of the voltage output enable signal to provide the camera power supply voltage VCC to the b^{th} connection pin. Further, the third switch circuit is turned off under the control of the voltage output disable signal to stop providing the camera power supply voltage VCC to the b^{th} connection pin. Optionally, the third switch circuit includes, but is not limited to, a transistor(s), a triode(s), a digital switch(es), an analog switch(es).

In embodiments of the disclosure, the logic controller 310 is configured to: based on determining that the camera detection signal is an un-access detection signal, output the third mode configuration signal and the voltage output disable signal. The gating circuit 320 is configured to: receive the third mode configuration signal and the voltage output disable signal, and in response to the third mode configuration signal and the voltage output disable signal, stop providing the camera power supply voltage VCC to the b^{th} connection pin. Exemplarily, as shown in FIG. 19A with FIG. 19B, the gating circuit 320 is configured to receive the third mode configuration signal and the voltage output disable signal, and in response to the third mode configuration signal and the voltage output disable signal, stop providing the camera power supply voltage VCC to the 1^{st} connection pin P1 and the 5^{th} connection pin P5.

Exemplarily, the second switch circuit is configured to: receive the voltage output disable signal, and in response to the voltage output disable signal, stop providing the camera power supply voltage VCC to the (a+M−1)^{th} connection pin. Further, the third switch circuit is configured to: receive the voltage output disable signal, and in response to the voltage output disable signal, stop providing the camera power supply voltage VCC to the b^{th} connection pin. Exemplarily, as shown in FIG. 19A, the second switch circuit is configured to: receive the voltage output disable signal, and in response to the voltage output disable signal, stop providing the camera power supply voltage VCC to the 5^{th} connection pin P5. As shown in FIG. 19B, the third switch circuit is configured to: receive the voltage output disable signal, and in response to the voltage output disable signal, stop providing the camera power supply voltage VCC to the 1^{st} connection pin P1.

In embodiments of the disclosure, the gating circuit 320 further includes: a multiplexer 321. The multiplexer 321 is connected with the logic controller 310, the (a+1)^{th} connection pin to the ((N−1)/2)^{th} connection pin, and the ((N+3)/2)^{th} connection pin to the (N−1)^{th} connection pin, respectively. Additionally, the multiplexer 321 is configured to receive the first mode configuration signal, and in response to the first mode configuration signal, connect the (a+1)^{th} connection pin to the ((N−1)/2)^{th} connection pin and the ((N+3)/2)^{th} connection pin to the (N−1)^{th} connection pin with the image data transmission terminal. Exemplarily, as shown in FIG. 19A, the image data transmission terminal includes: the first differential signal transmission terminal D+ and the second differential signal transmission terminal D−. The multiplexer 321 may, in response to the first mode configuration signal, establish a conducting path between the 2^{nd} connection pin P2 and the first differential signal transmission terminal D+, and establish a conducting path between the 4^{th} connection pin P4 and the second differential signal transmission terminal D−.

In embodiments of the disclosure, the multiplexer 321 is configured to receive the second mode configuration signal, and in response to the second mode configuration signal, connect the (a+1)^{th} connection pin to the ((N−1)/2)^{th} connection pin and the ((N+3)/2)^{th} connection pin to the (N−1)^{th} connection pin with the image data transmission terminal. Exemplarily, as shown in FIG. 19B, the image data transmission terminal includes: the first differential signal transmission terminal D+ and the second differential signal transmission terminal D−. The multiplexer 321 may, in response to the second mode configuration signal, establish a conducting path between the 2^{nd} connection pin P2 and the second differential signal transmission terminal D− and establish a conducting path between the 4^{th} connection pin P4 and the first differential signal transmission terminal D+.

Further, the multiplexer 321 receives the third mode configuration signal, and in response to the third mode configuration signal, disconnect the (a+1)^{th} connection pin to the ((N−1)/2)^{th} connection pin and the ((N+3)/2)^{th} connection pin to the (N−1)^{th} connection pin from the image data transmission terminal.

In embodiments of the disclosure, the display device 100 further includes: a fourth pull-up resistor R4 and a fifth pull-up resistor R5. A fourth pull-up voltage VP4 is provided to the (a+M−1)^{th} connection pin via the fourth pull-up resistor R4, and a fifth pull-up voltage VP5 is provided to the b^{th} connection pin via the fifth pull-up resistor R5. The logic controller 310 is further configured to obtain a pin level signal of the (a+M−1)^{th} connection pin and a pin level signal of the b^{th} connection pin, and take the pin level signal of the (a+M−1)^{th} connection pin and the pin level signal of the b^{th} connection pin as the camera detection signal. Exemplarily, as shown in FIG. 18, the fourth pull-up voltage VP4 is provided to the 5^{th} connection pin P5 through the fourth pull-up resistor R4, and the fifth pull-up voltage VP5 is provided to the 1^{st} connection pin P1 through the fifth pull-up resistor R5. The logic controller 310 is further configured to obtain the pin level signal of the 1^{st} connection pin and the pin level signal of the 5^{th} connection pin, and take the pin level signal of the 1^{st} connection pin and the pin level signal of the 5^{th} connection pin as the camera detection signal.

Exemplarily, the resistance value of the fourth pull-up resistor R4 and the resistance value of the fifth pull-up resistor R5 may be the same or different, which are not limited herein.

Exemplarily, the fourth pull-up voltage VP4 and the fifth pull-up voltage VP5 may be the same or different, which are not limited herein.

Exemplarily, the fourth pull-up voltage VP4 and the fifth pull-up voltage VP5 may be inputted through a same one pull-up voltage terminal or may be inputted through two mutually independent pull-up voltage terminals respectively, which are not limited herein.

Exemplarily, as shown in FIG. 18, when the camera module 200 is not connected with the display device 100, the fourth pull-up voltage VP4 is provided to the 5^{th} connection pin P5 through the fourth pull-up resistor R4, and the fifth pull-up voltage VP5 is provided to the 1^{st} connection pin P1 through the fifth pull-up resistor R5. When the camera module 200 is not connected with the display device 100, the 1^{st} connection pin P1 is pulled up at a high level due to the fifth pull-up voltage VP5, and the 5^{th} connection pin P5 is pulled up at a high level due to the fourth pull-up voltage VP4. At this time, the level signal of the 1^{st} connection pin P1 and the level signal of the 5^{th} connection pin P5 obtained by the logic controller 310 are both high level signals. Since the obtained level signal of the 1^{st} connection pin P1 and the obtained level signal of the 5^{th} connection pin P5 are taken as the camera presence detection signal, it can indicate that the current camera presence detection signal is an un-access detection signal.

Exemplarily, as shown in FIG. 19A, when the camera module 200 is forward-mounted to the display device 100, the 5^{th} connection pin P5 is pulled up at a high level due to the fourth pull-up voltage VP4, and a conducting path is established between the 1^{st} connection pin P1 and the ground terminal GND through the 1^{st} connection contact Q1, the 3^{rd} connection contact Q3, and the 3^{rd} connection pin P3, so that the 1^{st} connection pin P1 is pulled down by the ground terminal GND. At this time, the level signal of the 1^{st} connection pin P1 obtained by the logic controller 310 is a low level signal, and the level signal of the 5^{th} connection pin P5 obtained by the logic controller 310 is a high level signal, and since the obtained level signal of the 1^{st} connection pin P1 and the obtained level signal of the 5^{th} connection pin P5 are taken as the camera presence detection signal, indicating that the camera presence detection signal is currently a forward access detection signal.

Exemplarily, as shown in FIG. 19B, when the camera module 200 is reverse-mounted to the display device 100, the 1^{st} connection pin P1 is pulled up at a high level due to the fifth pull-up voltage VP5, and the 5^{th} connection pin P5 connects the ground terminal GND through the 1^{st} connection contact Q1, the 3^{rd} connection contact Q3, and the 3^{rd} connection pin P3, so that the 5^{th} connection pin P5 is pulled down by the ground terminal GND. At this time, the level signal of the 1^{st} connection pin P1 obtained by the logic controller 310 is a high level signal, and the level signal of the 5^{th} connection pin P5 obtained by the logic controller 310 is a low level signal, and since the obtained level signal of the 1^{st} connection pin P1 and the obtained level signal of the 5^{th} connection pin P5 are taken as the camera presence detection signal, indicating that the camera presence detection signal is a reverse access detection signal currently.

The working process of the electronic device provided in the embodiments of the disclosure is described below in connection with FIGS. 18 to 19B.

When the camera is not connected with the display device 100, the logic controller 310 outputs a third mode configuration signal and a voltage output disable signal. The second switch circuit, in response to the voltage output disable signal, stops providing the camera power supply voltage VCC to the 5^{th} connection pin P5. The third switch circuit, in response to the voltage output disable signal, stops providing the camera power supply voltage VCC to the 1^{st} connection pin P1. The multiplexer 321, in response to the third mode configuration signal, disconnects the 2^{nd} connection pin P2 and the 4^{th} connection pin P4 from the second differential signal transmission terminal D− and the first differential signal transmission terminal D+, respectively.

The camera module 200 is forward-mounted to the display device 100. The logic controller 310 outputs a first mode configuration signal, outputs a voltage output enable signal to the second switch circuit, and outputs a voltage output disable signal to the third switch circuit. The second switch circuit, in response to the voltage output enable signal, provides the camera power supply voltage VCC to the 5^{th} connection pin P5. The third switch circuit, in response to the voltage output disable signal, stops providing the camera power supply voltage VCC to the 1^{st} connection pin P1. The multiplexer 321, in response to the first mode configuration signal, establishes a conducting path between the 2^{nd} connection pin P2 and the first differential signal transmission terminal D+, and establishes a conducting path between the 4^{th} connection pin P4 and the second differential signal transmission terminal D−.

The camera module 200 is reverse-mounted to the display device 100. The logic controller 310 outputs a second mode configuration signal, and outputs a voltage output enable signal to the third switch circuit, and outputs a voltage output disable signal to the second switch circuit. The second switch circuit, in response to the voltage output disable signal, stops providing the camera power supply voltage VCC to the 5^{th} connection pin P5. The third switch circuit, in response to the voltage output enable signal, provides the camera power supply voltage VCC to the 1^{st} connection pin P1. The multiplexer 321, in response to the second mode configuration signal, establishes a conducting path between the 4^{th} connection pin P4 and the first differential signal transmission terminal D+, and establishes a conducting path between the 2^{nd} connection pin P2 and the second differential signal transmission terminal D−.

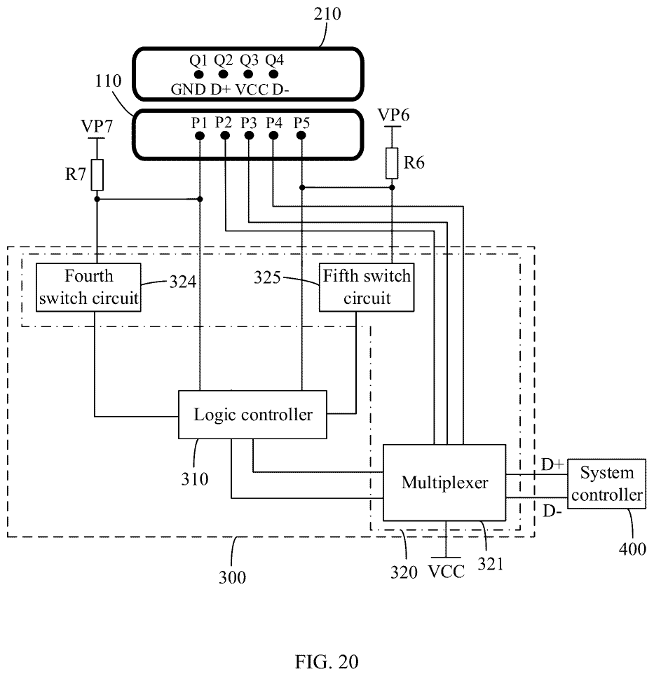

The embodiment the disclosure provides a schematic diagram of some structures of the electronic device, as shown in FIG. 20, which is a variation with respect to the implementations in the above-described embodiments. Only the differences between the present embodiments and the above embodiments are described below, and the similarities are not repeated herein.

In some embodiments of the disclosure, N is set to an odd number, and N can be greater than M. Exemplarily, the 1^{st} connection contact Q1 is configured to be connected with the ground terminal GND, the (M−1)^{th} connection contact is configured to be provided with the camera power supply voltage VCC, and the rest of the connection contacts are connected with the image data transmission terminal. Of course, the image data captured by the camera may be transmitted based on the wireless communication technology. The camera module 200 may further include a first wireless communication component, and the camera module 200 may send the captured image data via the first wireless communication component. Further, the display device 100 further includes a second wireless communication component. The display device 100 communicates data with the first communication component via the second wireless communication component to obtain the image data sent by the first communication component.

Exemplarily, as shown in FIG. 20, taking M=4 and N=5 as an example, the 1^{st} connection contact Q1 is configured to be connected with the ground terminal GND, the 3^{rd} connection contact Q3 is configured to be provided with the camera power supply voltage VCC, and the 2^{nd} connection contact Q2 and the 4^{th} connection contact Q4 are configured to be connected with the image data transmission terminal. Optionally, the image data transmission terminal includes: a first differential signal transmission terminal D+ and a second differential signal transmission terminal D−. The 2^{nd} connection contact Q2 is configured to be connected with the first differential signal transmission terminal D+, and the 4^{th} connection contact Q4 is configured to be connected with the second differential signal transmission terminal D−.

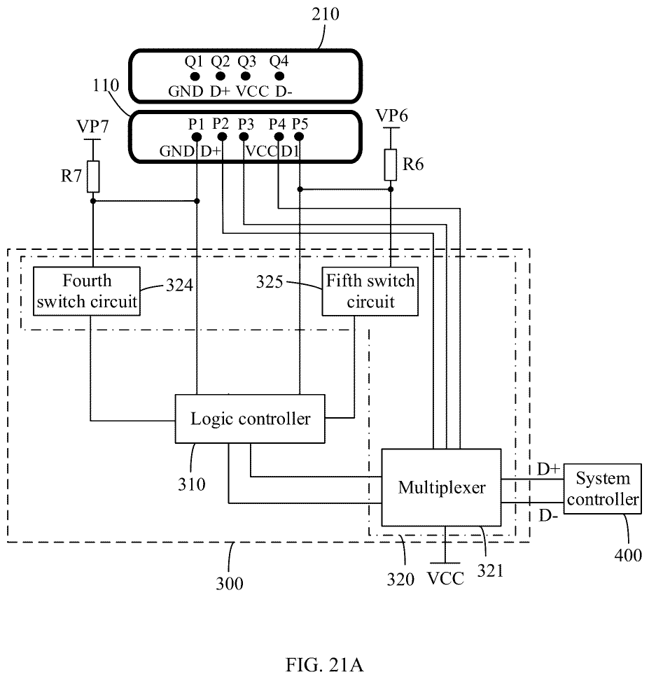

Additionally, as shown in FIG. 21A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, and the 4^{th} connection contact Q4 is mounted to the 4^{th} connection pin P4.

As shown in FIG. 21B, when the camera module 200 is reverse-mounted to the display device 100, the 1^{st} connection contact Q1 is mounted to the 5^{th} connection pin P5, the 2^{nd} connection contact Q2 is mounted to the 4^{th} connection pin P4, the 3^{rd} connection contact Q3 is mounted to the 3^{rd} connection pin P3, and the 4^{th} connection contact Q4 is mounted to the 2^{nd} connection pin P2.

In the embodiments of the disclosure, the detection control circuit 300 includes: a logic controller 310 and a gating circuit 320. The gating circuit 320 is connected with the logic controller 310 and the 1^{st} connection pin P1 to the N^{th} connection pin, respectively. Moreover, the logic controller 310 is configured to: obtain the camera detection signal, and based on determining that the camera detection signal is the forward access detection signal, output the first mode configuration signal and the voltage output enable signal. The gating circuit 320 is configured to: receive the first mode configuration signal and the voltage output enable signal, and in response to the first mode configuration signal and the voltage output enable signal, provide the camera power supply voltage VCC to the ((N+1)/2)^{th} connection pin, and connect the a^{th} connection pin with the ground terminal GND. Exemplarily, as shown in FIG. 21A, the gating circuit 320 is configured to: receive the first mode configuration signal and the voltage output enable signal, and in response to the first mode configuration signal and the voltage output enable signal, provide the camera power supply voltage VCC to the 3^{rd} connection pin P3, and connect the 1^{st} connection pin P1 with the ground terminal GND.

Exemplarily, the gating circuit 320 includes: a fourth switch circuit 324. The fourth switch circuit 324 is connected with the logic controller 310 and the a^{th} connection pin, respectively, and is configured to: receive the voltage output enable signal, and in response to the voltage output enable signal, connect the a^{th} connection pin with the ground terminal GND. Exemplarily, as shown in FIG. 21A, the fourth switch circuit 324 is configured to: receive the voltage output enable signal, and in response to the voltage output enable signal, connect the 1^{st} connection pin P1 with the ground terminal GND.

Exemplarily, a control terminal of the fourth switch circuit is configured to receive the voltage output enable signal and the voltage output disable signal, and a first terminal thereof is connected with the ground terminal GND, and a second terminal thereof is connected with the a^{th} connection pin. The fourth switch circuit is turned on under the control of the voltage output enable signal to connect the a^{th} connection pin with the ground terminal GND. Further, the fourth switch circuit is turned off under the control of the voltage output disable signal to disconnect the a^{th} connection pin from the ground terminal GND. Optionally, the fourth switch circuit includes, but is not limited to, a transistor(s), a triode(s), a digital switch(es), an analog switch(es).

In the embodiments of the disclosure, the logic controller 310 is configured to: based on determining that the camera detection signal is a reverse access detection signal, output a second mode configuration signal and a voltage output enable signal. The gating circuit 320 is configured to: receive the second mode configuration signal and the voltage output enable signal, and in response to the second mode configuration signal and the voltage output enable signal, provide the camera power supply voltage VCC to the ((N+1)/2)^{th} connection pin and connect the (b+M−1)^{th} connection pin with the ground terminal GND. Exemplarily, as shown in FIG. 21B, the gating circuit 320 is configured to: receive the second mode configuration signal and the voltage output enable signal, and in response to the second mode configuration signal and the voltage output enable signal, provide the camera power supply voltage VCC to the 3^{rd} connection pin P3, and connect the 5^{th} connection pin P5 with the ground terminal GND.

Exemplarily, the gating circuit 320 includes: a fifth switch circuit 325. The fifth switch circuit 325 is connected with the logic controller 310 and the (b+M−1)^{th} connection pin, respectively, and is configured to: receive the voltage output enable signal, and in response to the voltage output enable signal, connect the (b+M−1)^{th} connection pin with the ground terminal GND. Exemplarily, as shown in FIG. 21B, the fifth switch circuit 325 is configured to receive the voltage output enable signal, and in response to the voltage output enable signal, connect the 5^{th} connection pin P5 with the ground terminal GND.

Exemplarily, a control terminal of the fifth switch circuit is configured to receive the voltage output enable signal and the voltage output disable signal, and a first terminal thereof is connected with the ground terminal GND, and a second terminal thereof is connected with the (b+M−1)^{th} connection pin. The fifth switch circuit is turned on under the control of the voltage output enable signal to connect the (b+M−1)^{th} connection pin with the ground terminal GND. Further, the fifth switch circuit is turned off under the control of the voltage output disable signal to disconnect the (b+M−1)^{th} connection pin from the ground terminal GND. Optionally, the fifth switch circuit includes, but is not limited to, a transistor(s), a triode(s), a digital switch(es), an analog switch(es).

In embodiments of the disclosure, the logic controller 310 is configured to: based on determining that the camera detection signal is an un-access detection signal, output a third mode configuration signal and a voltage output disable signal. The gating circuit 320 is configured to: receive the third mode configuration signal and the voltage output disable signal, and in response to the third mode configuration signal and the voltage output disable signal, stop providing the camera power supply voltage VCC to the ((N+1)/2)^{th} connection pin, disconnect the (b+M−1)^{th} connection pin from the ground terminal GND, and disconnect the a^{th} connection pin from the ground terminal GND. Exemplarily, as shown in FIG. 21A with FIG. 21B, the gating circuit 320 is configured to: receive the third mode configuration signal and the voltage output disable signal, and in response to the third mode configuration signal and the voltage output disable signal, stop providing the camera power supply voltage VCC to the 3^{rd} connection pin P3, disconnect the 5^{th} connection pin P5 from the ground terminal GND, and disconnect the 1^{st} connection pin P1 from the ground terminal GND.

Exemplarily, the fourth switch circuit 324 is configured to: receive the voltage output disable signal, and in response to the voltage output disable signal, disconnect the a^{th} connection pin from the ground terminal GND. Further, the fifth switch circuit 325 is configured to: receive the voltage output disable signal, and in response to the voltage output disable signal, disconnect the (b+M−1)^{th} connection pin from the ground terminal GND. Exemplarily, as shown in FIG. 21A, the fourth switch circuit 324 is configured to: receive the voltage output disable signal, and in response to the voltage output disable signal, disconnect the 1^{st} connection pin P1 from the ground terminal GND. As shown in FIG. 21B, the fifth switch circuit 325 is configured to: receive the voltage output disable signal, and in response to the voltage output disable signal, disconnect the 5^{th} connection pin P5 from the ground terminal GND.

In embodiments of the disclosure, the display device 100 further includes: a sixth pull-up resistor R6 and a seventh pull-up resistor R7. A sixth pull-up voltage VP6 is provided to the a^{th} connection pin via the sixth pull-up resistor R6, and a seventh pull-up voltage VP7 is provided to the (b+M−1)^{th} connection pin via the seventh pull-up resistor R7. The logic controller 310 is further configured to: obtain a pin level signal of the a^{th} connection pin and a pin level signal of the (b+M−1)^{th} connection pin, and take the pin level signal of the a^{th} connection pin and the pin level signal of the (b+M−1)^{th} connection pin as the camera detection signal.

Exemplarily, as shown in FIG. 20, when the camera module 200 is not connected with the display device 100, the sixth pull-up voltage VP6 is provided to the 5^{th} connection pin P5 through the sixth pull-up resistor R6, and the seventh pull-up voltage VP7 is provided to the 1^{st} connection pin P1 through the seventh pull-up resistor R7. When the camera module 200 is not connected with the display device 100, the 1^{st} connection pin P1 is pulled up at a high level due to the seventh pull-up voltage VP7, and the 5^{th} connection pin P5 is pulled up at a high level due to the sixth pull-up voltage VP6. At this time, the level signal of the 1^{st} connection pin P1 and the level signal of the 5^{th} connection pin P5 obtained by the logic controller 310 are both high level signals. Since the obtained level signal of the 1^{st} connection pin P1 and the obtained level signal of the 5^{th} connection pin P5 are taken as the camera presence detection signal, indicating that the camera presence detection signal is currently an un-access detection signal.

Exemplarily, as shown in FIG. 21A, when the camera module 200 is forward-mounted to the display device 100, the 5^{th} connection pin P5 is pulled up at a high level by the sixth pull-up voltage VP6, and the 1^{st} connection pin P1 is pulled down by the 1^{st} connection contact Q1. At this time, the level signal of the 1^{st} connection pin P1 obtained by the logic controller 310 is a low level signal, and the level signal of the 5^{th} connection pin P5 obtained by the logic controller 310 is a high level signal, and since the obtained level signal of the 1^{st} connection pin P1 and the obtained level signal of the 5^{th} connection pin P5 are taken as the camera presence detection signal, indicating that the camera presence detection signal is currently a forward access detection signal.

Exemplarily, as shown in FIG. 21B, when the camera module 200 is reverse-mounted to the display device 100, the 1^{st} connection pin P1 is pulled up at a high level due to the seventh pull-up voltage VP7, and the 5^{th} connection pin P5 is pulled down through the 1^{st} connection contact Q1. At this time, the level signal of the 1^{st} connection pin P1 obtained by the logic controller 310 is a high level signal, and the level signal of the 5^{th} connection pin P5 obtained by the logic controller 310 is a low level signal, and since the obtained level signal of the 1^{st} connection pin P1 and the obtained level signal of the 5^{th} connection pin P5 are taken as the camera presence detection signal, indicating that the camera presence detection signal is currently a reverse access detection signal.

The working process of the electronic device provided in the embodiments of the disclosure is described below in connection with FIGS. 20 to 21B.

When the camera is not connected with the display device 100, the logic controller 310 outputs a third mode configuration signal and a voltage output disable signal, and the fifth switch circuit 325, in response to the voltage output disable signal, disconnects the ground terminal GND from the 5^{th} connection pin P5. The fourth switch circuit 324, in response to the voltage output disable signal, disconnects the ground terminal GND from the 1^{st} connection pin P1. The multiplexer 321, in response to the third mode configuration signal, disconnects the 2^{nd} connection pin P2 and the 4^{th} connection pin P4 from the second differential signal transmission terminal D− and the first differential signal transmission terminal D+, respectively.

The camera module 200 is forward-mounted to the display device 100. The logic controller 310 outputs the first mode configuration signal, outputs a voltage output enable signal to the fourth switch circuit 324, and outputs a voltage output disable signal to the fifth switch circuit 325. The fourth switch circuit 324, in response to the voltage output enable signal, connects the ground terminal GND with the 1^{st} connection pin P1. The fifth switch circuit 325, in response to the voltage output disable signal, disconnects the ground terminal GND from the 5^{th} connection pin P5. The multiplexer 321, in response to the first mode configuration signal, establishes a conducting path between the 2^{nd} connection pin P2 and the first differential signal transmission terminal D+, and establishes a conducting path between the 4^{th} connection pin P4 with the second differential signal transmission terminal D−.

The camera module 200 is reverse-mounted to the display device 100. The logic controller 310 outputs the second mode configuration signal, outputs a voltage output enable signal to the fifth switch circuit 325, and outputs a voltage output disable signal to the fourth switch circuit 324. The fifth switch circuit 325, in response to the voltage output disable signal, connects the ground terminal GND with the 5^{th} connection pin P5. The fourth switch circuit 324, in response to the voltage output enable signal, disconnects the ground terminal GND from the 1^{st} connection pin P1. The multiplexer 321, in response to the second mode configuration signal, establishes a conducting path between the 4^{th} connection pin P4 and the first differential signal transmission terminal D+, and establishes a conducting path between the 2^{nd} connection pin P2 and the second differential signal transmission terminal D−.

The embodiment of the disclosure provides another schematic diagram of some structures of the electronic device, as shown in FIG. 22A, which is a variation with respect to the implementations in the above-described embodiments. Only the differences between the present embodiments and the above embodiments are described below, and the similarities are not repeated herein.

In the embodiments, the power supply to the camera module 200 and the image data transmission after the camera module 200 is forward-mounted to the display module or the camera module 200 is reverse-mounted to the display module can be realized by merely setting the positions of the connection contacts in the first connector 210 and setting the symmetrical setting of the connection pins with the same performance in the second connector 110 without obtaining a camera detection signal.

In some embodiments of the disclosure, N may be set to an odd number, i.e., the number of connection pins on the second connector 110 is set to an odd number. Exemplarily, the ((N+1)/2)^{th} connection pin may be provided with the camera power supply voltage VCC, and the 1^{st} connection pin P1 and the N^{th} connection pin to be connected with the ground terminal GND. Here, connection pins the 2^{nd} connection pin P2 to the ((N−1)/2)^{th} connection pin and the ((N+3)/2)^{th} connection pin to the (N−1)^{th} connection pin are connected with the image data transmission terminal. Additionally, connection pins corresponding to the image data transmission terminal with the same performance, among the 2^{nd} connection pin P2 to the ((N−1)/2)^{th} connection pin and the (N+3)/2 connection pin to the (N−1)^{th} connection pin, are provided in mirror symmetry with respect to the ((N+1)/2)^{th} connection pin. Alternatively, the image data captured by the camera may be communicated based on the wireless communication technology. The camera module 200 may further include a first wireless communication component, and the camera module 200 may send the captured image data via the first wireless communication component. Further, the display device 100 further includes a second wireless communication component. The display device 100 communicates data with the first communication component via the second wireless communication component to obtain the image data sent by the first communication component.

Exemplarily, as shown in FIGS. 22A to 25B, the 4^{th} connection pin P4 may be provided with the camera power supply voltage VCC, and the 1^{st} connection pin P1 and the 7^{th} connection pin P7 are connected with the ground terminal GND. The 2^{nd} connection pin P2, the 3^{rd} connection pin P3, the 5^{th} connection pin P5, and the 6^{th} connection pin P6 are connected with the image data transmission terminal. Optionally, the image data transmission terminal includes: a first differential signal transmission terminal D+ and a second differential signal transmission terminal D−. The 2^{nd} connection pin P2 and the 6^{th} connection pin P6 are connected with the first differential signal transmission terminal D+, and the 3^{rd} connection pin P3 and the 5^{th} connection pin P5 are connected with the second differential signal transmission terminal D−.

In some embodiments of the disclosure, the number of connection contacts on the first connector 210 may be equal to the number of connection pins on the second connector 110, i.e., N=M. In some examples, the 1^{st} connection contact Q1 and the M^{th} connection contact are configured to be connected with the ground terminal GND, and the ((M+1)/2)^{th} connection contact is configured to be provided with the camera power supply voltage VCC. The 2^{nd} connection contact Q2 to the ((M−1)/2)^{th} connection contact are configured to be connected with the image data transmission terminal, and the ((M+3)/2))^{th} connection contact to the (N−1)^{th} connection contact are configured as virtual connection contacts. Here, the virtual connection contact means that the connection contact is in a floating state, i.e., it is not connected with other signal lines in the camera module 200 and does not transmit signals.

Exemplarily, as shown in FIGS. 22A and 22B, taking N=M=7 as an example, the 4^{th} connection contact Q4 is configured to be provided with the camera power supply voltage VCC, the 1^{st} connection contact Q1 and the 7^{th} connection contact Q7 are configured to be connected with the ground terminal GND, the 2^{nd} connection contact Q2 and the 3^{rd} connection contact Q3 are configured to be connected with the image data transmission terminal, and the 5^{th} connection contact Q5 and the 6^{th} connection contact Q6 are configured as virtual connection contacts that are in a floating state (NC). Optionally, the image data transmission terminal includes: a first differential signal transmission terminal D+ and a second differential signal transmission terminal D−. The 2^{nd} connection contact Q2 is configured to be connected with the first differential signal transmission terminal D+, and the 3^{rd} connection contact Q3 is configured to be connected with the second differential signal transmission terminal D−.

Additionally, as shown in FIG. 22A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, the 5^{th} connection contact Q5 is mounted to the 5^{th} connection pin P5, the 6^{th} connection contact Q6 is mounted to the 6^{th} connection pin P6, and the 7^{th} connection contact Q7 is mounted to the 7^{th} connection pin P7.

As shown in FIG. 22B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, the 5^{th} connection contact Q5 is mounted to the 3^{rd} connection pin P3, the 6^{th} connection contact Q6 is mounted to the 2^{nd} connection pin P2, and the 7^{th} connection contact Q7 is mounted to the 1^{st} connection pin P1.

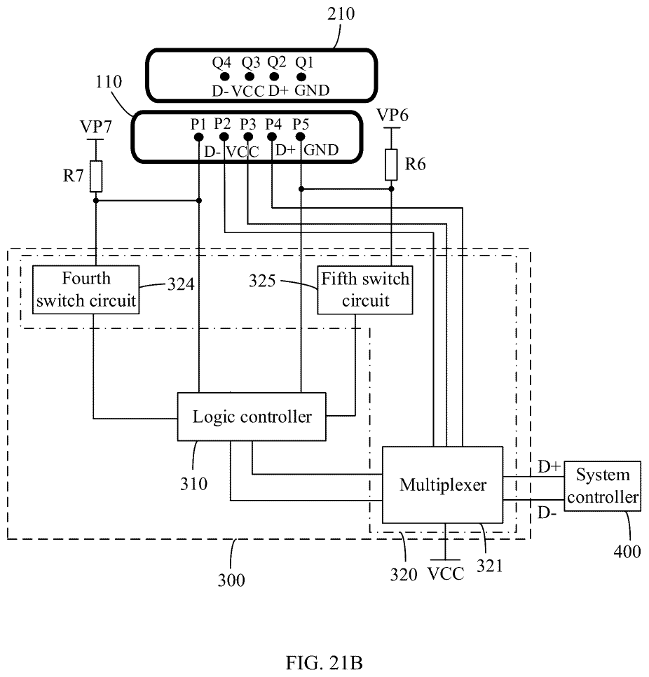

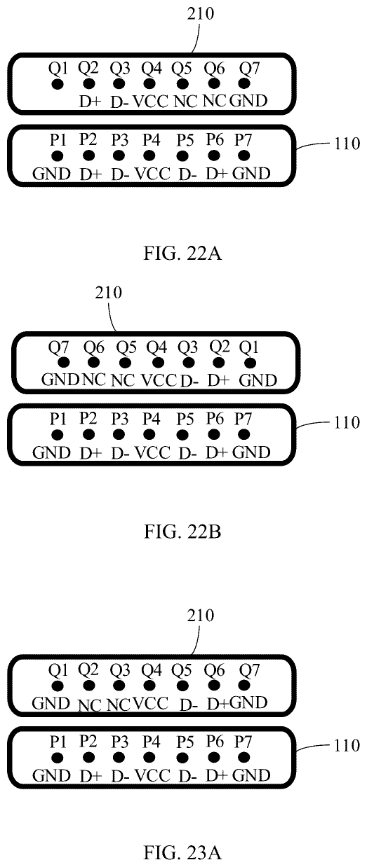

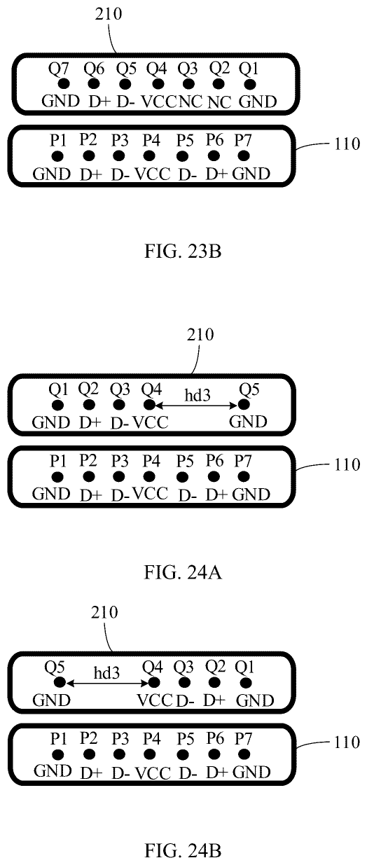

In some examples, the 1^{st} connection contact Q1 and the M^{th} connection contact are configured to be connected with the ground terminal GND, and the ((M+1)/2)^{th} connection contact is configured to be provided with the camera power supply voltage VCC. Additionally, the 2^{nd} connection contact Q2 to the ((M−1)/2)^{th} connection contact can be configured as virtual connection contacts, and the ((M+3)/2))^{th} connection contact to the (N−1)^{th} connection contact can be configured to be connected with the image data transmission terminal. Exemplarily, as shown in FIGS. 23A and 23B, taking N=M=7 as an example, the 4^{th} connection contact Q4 is configured to be provided with the camera power supply voltage VCC, and the 1^{st} connection contact Q1 and the 7^{th} connection contact Q7 are configured to be connected with the ground terminal GND. Additionally, the 2^{nd} connection contact Q2 and the 3^{rd} connection contact Q3 are configured as virtual connection contacts that are in a floating state (NC), and the 5^{th} connection contact Q5 and the 6^{th} connection contact Q6 are configured to be connected with the image data transmission terminal. Optionally, the image data transmission terminal includes: the first differential signal transmission terminal D+ and the second differential signal transmission terminal D−. The 6^{th} connection contact Q6 is configured to be connected with the first differential signal transmission terminal D+, and the 5^{th} connection contact Q5 is configured to be connected with the second differential signal transmission terminal D−.

Additionally, as shown in FIG. 23A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, the 5^{th} connection contact Q5 is mounted to the 5^{th} connection pin P5, the 6^{th} connection contact Q6 is mounted to the 6^{th} connection pin P6, and the 7^{th} connection contact Q7 is mounted to the 7^{th} connection pin P7.

As shown in FIG. 23B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, the 5^{th} connection contact Q5 is mounted to the 3^{rd} connection pin P3, the 6^{th} connection contact Q6 is mounted to the 2^{nd} connection pin P2, and the 7^{th} connection contact Q7 is mounted to the 1^{st} connection pin P1.

In some embodiments of the disclosure, the number of connection pins on the second connector 110 can be greater than the number of connection contacts on the first connector 210, i.e., N≥M. In some examples, the 1^{st} connection contact Q1 and the M^{th} connection contact are configured to be connected with the ground terminal GND, and the (M−1)^{th} connection contact is configured to be provided with the camera power supply voltage VCC. The 2^{nd} connection contact Q2 to the (N−2)^{th} connection contact are configured to be connected with the image data transmission terminal, and a third spacing distance hd3 is provided between the (N−1)^{th} connection contact and the N^{th} connection contact, and the third spacing distance hd3 is substantially (N−M+1)*h, and h is a spacing distance between two adjacent connection contacts. Exemplarily, as shown in FIGS. 24A and 24B, taking M=5 and N=7 as an example, the 4^{th} connection contact Q4 is configured to be loaded with the camera power supply voltage VCC, and the 1^{st} connection contact Q1 and the 5^{th} connection contact Q5 are configured to be connected with the ground terminal GND. Additionally, the 2^{nd} connection contact Q2 and the 3^{rd} connection contact Q3 are configured to be connected with the image data transmission terminal, and a third spacing distance hd3 is provided between the 4^{th} connection contact Q4 and the 5^{th} connection contact Q5, and the third spacing distance hd3 is substantially 3*h. Optionally, the image data transmission terminal includes: a first differential signal transmission terminal D+ and a second differential signal transmission terminal D−. The 2^{nd} connection contact Q2 is configured to be connected with the first differential signal transmission terminal D+, and the 3^{rd} connection contact Q3 is configured to be connected with the second differential signal transmission terminal D−.

Additionally, as shown in FIG. 24A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, and the 5^{th} connection contact Q5 is mounted to the 7^{th} connection pin P7.

As shown in FIG. 24B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, and the 5^{th} connection contact Q5 is mounted to the 1^{st} connection pin P1.

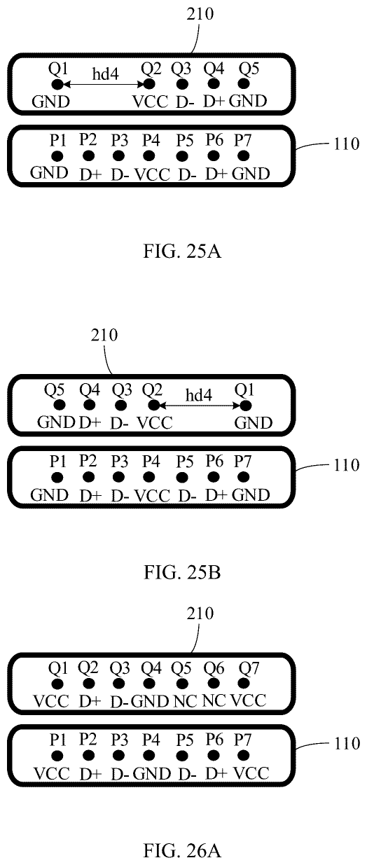

In some embodiments of the disclosure, the number of connection pins on the second connector 110 can be greater than the number of connection contacts on the first connector 210, i.e., N≥M. In some examples, the 1^{st} connection contact Q1 and the M^{th} connection contact are configured to be connected with the ground terminal GND, and the 2^{nd} connection contact Q2 is configured to be provided with the camera power supply voltage VCC. Further, the 3^{rd} connection contact Q3 to the (N−1)^{th} connection contact are configured to be connected with the image data transmission terminal, and a fourth spacing distance hd4 is provided between the 1^{st} connection contact Q1 and the 2^{nd} connection contact Q2, the fourth spacing distance hd4 is substantially (N−M+1)*h, and h is a spacing distance between two adjacent connection contacts. Exemplarily, as shown in FIGS. 25A and 25B, taking M=5 and N=7 as an example, the 4^{th} connection contact Q4 is configured to be loaded with the camera power supply voltage VCC, and the 1^{st} connection contact Q1 and the 5^{th} connection contact Q5 are configured to be connected with the ground terminal GND. Additionally, the 3^{rd} connection contact Q3 and the 4^{th} connection contact Q4 are configured to be connected with the image data transmission terminal, a fourth spacing distance hd4 is provided between the 1^{st} connection contact Q1 and the 2^{nd} connection contact Q2, and the fourth spacing distance hd4 is substantially 3*h. Optionally, the image data transmission terminal includes: a first differential signal transmission terminal D+ and a second differential signal transmission terminal D−. The 4^{th} connection contact Q4 is configured to be connected with the first differential signal transmission terminal D+, and the 3^{rd} connection contact Q3 is configured to be connected with the second differential signal transmission terminal D−.

Additionally, as shown in FIG. 25A, when the camera module 200 is forward-mounted to the display device 100, the 1^{st} connection contact Q1 is mounted to the 1^{st} connection pin P1, the 2^{nd} connection contact Q2 is mounted to the 4^{th} connection pin P4, the 3^{rd} connection contact Q3 is mounted to the 5^{th} connection pin P5, the 4^{th} connection contact Q4 is mounted to the 6^{th} connection pin P6, and the 5^{th} connection contact Q5 is mounted to the 7^{th} connection pin P7.

As shown in FIG. 25B, when the camera module 200 is reverse-mounted to the display device 100, the 1^{st} connection contact Q1 is mounted to the 7^{th} connection pin P7, the 2^{nd} connection contact Q2 is mounted to the 4^{th} connection pin P4, the 3^{rd} connection contact Q3 is mounted to the 5^{th} connection pin P5, the 4^{th} connection contact Q4 is mounted to the 6^{th} connection pin P6, and the 5^{th} connection contact Q5 is mounted to the 7^{th} connection pin P7.

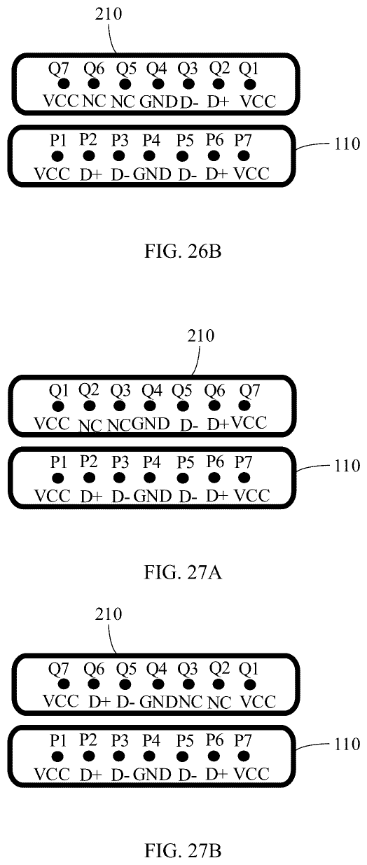

Embodiments of the disclosure provide another schematic diagram of some structures of the electronic device, as shown in FIG. 26A, which is a variation with respect to the implementations in the above-described embodiments. Only the differences between the present embodiments and the above embodiments are described below, and the similarities are not repeated herein.

In the embodiments, the power supply to the camera module 200 and the image data transmission after the camera module 200 is forward-mounted to the display module or the camera module 200 is reverse-mounted to the display module can be realized by merely setting the positions of the connection contacts in the first connector 210 and setting the symmetrical setting of the connection pins with the same performance in the second connector 110 without obtaining a camera detection signal.

In some embodiments of the disclosure, N may be set to an odd number, i.e., the number of connection pins on the second connector 110 is set to an odd number. Exemplarily, the ((N+1)/2)^{th} connection pin may be connected with the ground terminal GND, and the 1^{st} connection pin P1 and the N^{th} connection pin are loaded with the camera power supply voltage VCC. The 2^{nd} connection pin P2 to the ((N−1)/2)^{th} connection pin and the ((N+3)/2)^{th} connection pin to the (N−1)^{th} connection pin are connected with the image data transmission terminal. Additionally, connection pins corresponding to the image data transmission terminal with the same performance, among the 2^{nd} connection pin P2 to the ((N−1)/2)^{th} connection pin and the (N+3)/2 connection pin to the (N−1)^{th} connection pin, are provided in mirror symmetry with respect to the ((N+1)/2)^{th} connection pin. Alternatively, the image data captured by the camera may be communicated based on the wireless communication technology. The camera module 200 may further include a first wireless communication component, and the camera module 200 may send the captured image data via the first wireless communication component. Further, the display device 100 further includes a second wireless communication component. The display device 100 communicates data with the first communication component via the second wireless communication component to obtain the image data sent by the first communication component.

Exemplarily, as shown in FIGS. 26A to 29B, the 4^{th} connection pin P4 may be connected with the ground terminal GND, and the 1^{st} connection pin P1 and the 7^{th} connection pin P7 are provided with the camera power supply voltage VCC. The 2^{nd} connection pin P2, the 3^{rd} connection pin P3, the 5^{th} connection pin P5, and the 6^{th} connection pin P6 are connected with the image data transmission terminal. Optionally, the image data transmission terminal includes: a first differential signal transmission terminal D+ and a second differential signal transmission terminal D−. The 2^{nd} connection pin P2 and the 6^{th} connection pin P6 are connected with the first differential signal transmission terminal D+, and the 3^{rd} connection pin P3 and the 5^{th} connection pin P5 are connected with the second differential signal transmission terminal D−.

In some embodiments of the disclosure, the number of connection contacts on the first connector 210 may be equal to the number of connection pins on the second connector 110, i.e., N=M. In some examples, the 1^{st} connection contact Q1 and the M^{th} connection contact are configured to be connected with the ground terminal GND, and the ((M+1)/2)^{th} connection contact is configured to be provided with the camera power supply voltage VCC. The 2^{nd} connection contact Q2 to the ((M−1)/2)^{th} connection contact are configured to be connected with the image data transmission terminal, and the ((M+3)/2))^{th} connection contact to the (N−1)^{th} connection contact are configured as virtual connection contacts. The virtual connection contact means that the connection contact is in a floating state, i.e., it is not connected with other signal lines in the camera module 200 and does not transmit signals. Exemplarily, as shown in FIGS. 26A and 26B, taking N=M=7 as an example, the 4^{th} connection contact Q4 is configured to be connected with the ground terminal GND, the 1^{st} connection contact Q1 and the 7^{th} connection contact Q7 are configured to be connected with the ground terminal GND, the 2^{nd} connection contact Q2 and the 3^{rd} connection contact Q3 are configured to be connected with the image data transmission terminal, and the 5^{th} connection contact Q5 and the 6^{th} connection contact Q6 are configured as virtual connection contacts that are in a floating state (NC). Optionally, the image data transmission terminal includes: a first differential signal transmission terminal D+ and a second differential signal transmission terminal D−. The 2^{nd} connection contact Q2 is configured to be connected with the first differential signal transmission terminal D+, and the 3^{rd} connection contact Q3 is configured to be connected with the second differential signal transmission terminal D−.

Additionally, as shown in FIG. 26A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, the 5^{th} connection contact Q5 is mounted to the 5^{th} connection pin P5, the 6^{th} connection contact Q6 is mounted to the 6^{th} connection pin P6, and the 7^{th} connection contact Q7 is mounted to the 7^{th} connection pin P7.

As shown in FIG. 26B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, the 5^{th} connection contact Q5 is mounted to the 3^{rd} connection pin P3, the 6^{th} connection contact Q6 is mounted to the 2^{nd} connection pin P2, and the 7^{th} connection contact Q7 is mounted to the 1^{st} connection pin P1.

In some examples, the 1^{st} connection contact Q1 and the M^{th} connection contact are configured to be loaded with the camera power supply voltage VCC, and the ((M+1)/2)^{th} connection contact is configured to be connected with the ground terminal GND. Additionally, the 2^{nd} connection contact Q2 to the ((M−1)/2)^{th} connection contact can be configured as virtual connection contacts, and the ((M+3)/2))^{th} connection contact to the (N−1)^{th} connection contact can be configured to be connected with the image data transmission terminal. Exemplarily, as shown in FIGS. 27A and 27B, taking N=M=7 as an example, the 4^{th} connection contact Q4 is configured to be connected with the ground terminal GND, and the 1^{st} connection contact Q1 and the 7^{th} connection contact Q7 are configured to be loaded with the camera power supply voltage VCC. Additionally, the 2^{nd} connection contact Q2 and the 3^{rd} connection contact Q3 are configured as virtual connection contacts that are in a floating state (NC), and the 5^{th} connection contact Q5 and the 6^{th} connection contact Q6 are configured to be connected with the image data transmission terminal. Optionally, the image data transmission terminal includes: a first differential signal transmission terminal D+ and a second differential signal transmission terminal D−. The 6^{th} connection contact Q6 is configured to be connected with the first differential signal transmission terminal D+, and the 5^{th} connection contact Q5 is configured to be connected with the second differential signal transmission terminal D−.

Additionally, as shown in FIG. 27A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, the 5^{th} connection contact Q5 is mounted to the 5^{th} connection pin P5, the 6^{th} connection contact Q6 is mounted to the 6^{th} connection pin P6, and the 7^{th} connection contact Q7 is mounted to the 7^{th} connection pin P7.

As shown in FIG. 27B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, the 5^{th} connection contact Q5 is mounted to the 3^{rd} connection pin P3, the 6^{th} connection contact Q6 is mounted to the 2^{nd} connection pin P2, and the 7^{th} connection contact Q7 is mounted to the 1^{st} connection pin P1.

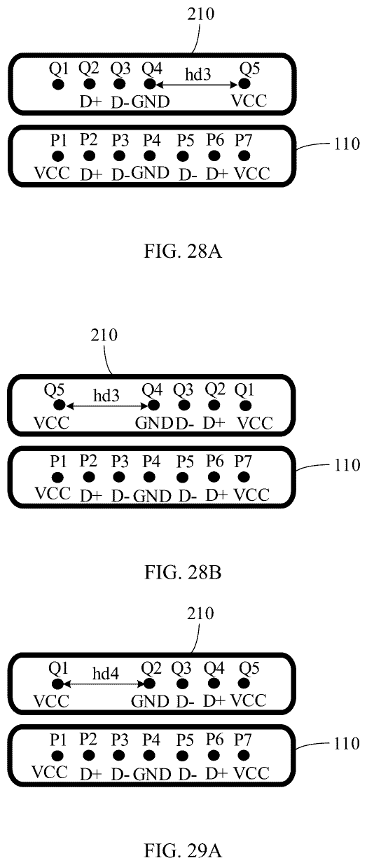

In some embodiments of the disclosure, the number of connection pins on the second connector 110 can be greater than the number of connection contacts on the first connector 210, i.e., N≥M. In some examples, the 1^{st} connection contact Q1 and the M^{th} connection contact are configured to be provided with the camera power supply voltage VCC, and the (M−1)^{th} connection contact is configured to be connected with the ground terminal GND. Further, the 2^{nd} connection contact Q2 to the (N−2)^{th} connection contact are configured to be connected with the image data transmission terminal, and a third spacing distance hd3 is provided between the (N−1)^{th} connection contact and the N^{th} connection contact, the third spacing distance hd3 is substantially (N−M+1)*h, and h is a spacing distance between two adjacent connection contacts. Exemplarily, as shown in FIGS. 28A and 28B, taking M=5 and N=7 as an example, the 4^{th} connection contact Q4 is configured to be connected with the ground terminal GND, and the 1^{st} connection contact Q1 and the 5^{th} connection contact Q5 are configured to be loaded with the camera power supply voltage VCC. Additionally, the 2^{nd} connection contact Q2 and the 3^{rd} connection contact Q3 are configured to be connected with the image data transmission terminal, a third spacing distance hd3 is provided between the 4^{th} connection contact Q4 and the 5^{th} connection contact Q5, and the third spacing distance hd3 is substantially 3*h. Optionally, the image data transmission terminal includes: a first differential signal transmission terminal D+ and a second differential signal transmission terminal D−. The 2^{nd} connection contact Q2 is configured to be connected with the first differential signal transmission terminal D+, and the 3^{rd} connection contact Q3 is configured to be connected with the second differential signal transmission terminal D−.

Additionally, as shown in FIG. 28A, when the camera module 200 is forward-mounted to the display device 100, the 1^{st} connection contact Q1 is mounted to the 1^{st} connection pin P1, the 2^{nd} connection contact Q2 is mounted to the 2^{nd} connection pin P2, the 3^{rd} connection contact Q3 is mounted to the 3^{rd} connection pin P3, the 4^{th} connection contact Q4 is mounted to the 4^{th} connection pin P4, and the 5^{th} connection contact Q5 is mounted to the 7^{th} connection pin P7.

As shown in FIG. 28B, when the camera module 200 is reverse-mounted to the display device 100, the 1^{st} connection contact Q1 is mounted to the 7^{th} connection pin P7, the 2^{nd} connection contact Q2 is mounted to the 6^{th} connection pin P6, the 3^{rd} connection contact Q3 is mounted to the 5^{th} connection pin P5, the 4^{th} connection contact Q4 is mounted to the 4^{th} connection pin P4, and the 5^{th} connection contact Q5 is mounted to the 1^{st} connection pin P1.

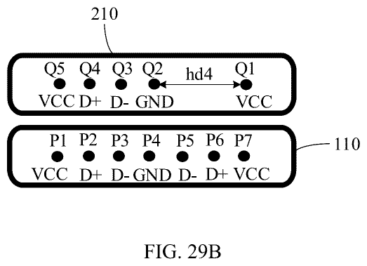

In some embodiments of the disclosure, the number of connection pins on the second connector 110 can be greater than the number of connection contacts on the first connector 210, i.e., N>M. In some examples, the 1^{st} connection contact Q1 and the M^{th} connection contact are configured to be loaded with the camera power supply voltage VCC, and the 2^{nd} connection contact Q2 is configured to be connected with the ground terminal GND. Further, the 3^{rd} connection contact Q3 to the (N−1)^{th} connection contact are configured to be connected with the image data transmission terminal, a fourth spacing distance hd4 is provided between the 1^{st} connection contact Q1 and the 2^{nd} connection contact Q2, the fourth spacing distance hd4 is substantially (N−M+1)*h, and h is a spacing distance between two adjacent connection contacts. Exemplarily, as shown in FIGS. 29A and 29B, taking M=5 and N=7 as an example, the 2^{nd} connection contact Q2 is configured to be connected with the ground terminal GND, and the 1^{st} connection contact Q1 and the 5^{th} connection contact Q5 are configured to be loaded with the camera power supply voltage VCC. Additionally, the 3^{rd} connection contact Q3 and the 4^{th} connection contact Q4 are configured to be connected with the image data transmission terminal, a fourth spacing distance hd4 is provided between the 1^{st} connection contact Q1 and the 2^{nd} connection contact Q2, and the fourth spacing distance hd4 is substantially 3*h. Optionally, the image data transmission terminal includes: a first differential signal transmission terminal D+ and a second differential signal transmission terminal D−. The 4^{th} connection contact Q4 is configured to be connected with the first differential signal transmission terminal D+, and the 3^{rd} connection contact Q3 is configured to be connected with the second differential signal transmission terminal D−.

Additionally, as shown in FIG. 29A, when the camera module 200 is forward-mounted to the display device 100, the 1^{st} connection contact Q1 is mounted to the 1^{st} connection pin P1, the 2^{nd} connection contact Q2 is mounted to the 4^{th} connection pin P4, the 3^{rd} connection contact Q3 is mounted to the 5^{th} connection pin P5, the 4^{th} connection contact Q4 is mounted to the 6^{th} connection pin P6, and the 5^{th} connection contact Q5 is mounted to the 7^{th} connection pin P7.

As shown in FIG. 29B, when the camera module 200 is reverse-mounted to the display device 100, the 1^{st} connection contact Q1 is mounted to the 7^{th} connection pin P7, the 2^{nd} connection contact Q2 is mounted to the 4^{th} connection pin P4, the 3^{rd} connection contact Q3 is mounted to the 5^{th} connection pin P5, the 4^{th} connection contact Q4 is mounted to the 6^{th} connection pin P6, and the 5^{th} connection contact Q5 is mounted to the 7^{th} connection pin P7.

It should be appreciated by those skilled in the art that the embodiments of the disclosure may be provided as methods, systems, or computer program products. Thus, the disclosure may take the form of a fully hardware embodiment, a fully software embodiment, or an embodiment that combines software and hardware aspects. Further, the disclosure may take the form of a computer program product implemented on one or more computer-usable storage media (including, but not limited to, disk memory, CD-ROM, optical memory, and the like) that contain computer-usable program codes therein.

The disclosure is described with reference to flowcharts and/or block diagrams of methods, devices (systems), and computer program products according to the embodiments of the disclosure. It should be understood that each of the processes and/or blocks in the flowcharts and/or block diagrams, and combinations of the processes and/or blocks in the flowcharts and/or block diagrams, may be implemented by computer program instructions. These computer program instructions may be provided to a processor of a general-purpose computer, a special-purpose computer, an embedded processor, or other programmable data processing device to produce a machine, such that the instructions executed by the processor of the computer or other programmable data processing device produce a device for carrying out the functions specified in the one or more processes of the flowchart and/or one or more blocks of the block diagram.

These computer program instructions may also be stored in a computer-readable memory capable of directing the computer or other programmable data processing device to operate in a particular manner, such that the instructions stored in the computer-readable memory produce an article of manufacture including an instruction device that implements the function specified in the flowchart one or more processes and/or the block diagram one or more blocks.

These computer program instructions may also be loaded onto a computer or other programmable data processing device, such that a series of operational steps are performed on the computer or other programmable device to produce computer-implemented processing, thereby the instructions executed on the computer or other programmable device provide steps for implementing the functionality specified in the flowchart one or more processes and/or the block diagram one or more blocks.

Although preferred embodiments of the disclosure have been described, those skilled in the art may make additional changes and modifications to these embodiments once the underlying inventive concepts are known. Therefore, the appended claims are intended to be construed to include the preferred embodiments as well as all changes and modifications that fall within the scope of the disclosure.

Obviously, those skilled in the art can make various changes and variations to the embodiments of the disclosure without departing from the spirit and scope of the embodiments of the disclosure. Thus, if such modifications and variations of the embodiments of the disclosure fall within the scope of the presently disclosed claims and their technical equivalents, the disclosure is intended to include such modifications and variations.

1. An electronic device, comprising:
a camera module, comprising a camera and a first connector, wherein the first connector comprises a 1^{st} connection contact to an M^{th} connection contact, and M is an integer and M≥1;
a display device, comprising a second connector, wherein the second connector comprises a 1^{st} connection pin to an N^{th} connection pin, and N is an integer and N≥1; and
a detection control circuit, connected with the second connector, and configured to:
in response to that the 1^{st} connection contact to the M^{th} connection contact are mounted to an a^{th} connection pin to an (a+M−1)^{th} connection pin among the 1st connection pin to the N^{th} connection pin, determine that the camera is forward-mounted to the display device; and
in response to that the M^{th} connection contact to the 1^{st} connection contact are mounted to a b^{th} connection pin to a (b+M−1)^{th} connection pin among the 1^{st} connection pin to the N^{th} connection pin, determine that the camera is reverse-mounted to the display device; wherein a is an integer and 1≤a≤N, and b is an integer and 1≤b≤N.

2. The electronic device according to claim 1, wherein the detection control circuit is further configured to:
obtain a camera detection signal;
based on determining that the camera detection signal is a forward access detection signal, determine that the 1^{st} connection contact to the M^{th} connection contact are mounted to the a^{th} connection pin to the (a+M−1)^{th} connection pin; and
based on determining that the camera detection signal is a reverse access detection signal, determine that the M^{th} connection contact to the 1^{st} connection contact are mounted to the b^{th} connection pin to the (b+M−1)^{th} connection pin.

3. The electronic device according to claim 2, wherein M=N and the detection control circuit comprises: a logic controller, and a gating circuit; wherein
the logic controller is configured to: obtain the camera detection signal, output a first mode configuration signal based on determining that the camera detection signal is the forward access detection signal, and output a second mode configuration signal based on determining that the camera detection signal is the reverse access detection signal; and
the gating circuit is connected with the logic controller and the 1^{st} connection pin to the N^{th} connection pin, respectively, and is configured to:
receive the first mode configuration signal, and in response to the first mode configuration signal, provide a camera power supply voltage to the a^{th} connection pin and connect the (a+M−1)^{th} connection pin with a ground terminal; and
receive the second mode configuration signal, and in response to the second mode configuration signal, provide the camera power supply voltage to the (b+M−1)^{th} connection pin and connect the b^{th} connection pin with the ground terminal.

4. The electronic device according to claim 3, wherein the gating circuit is further configured to:
in response to the first mode configuration signal, connect an (a+1)^{th} connection pin to an (a+M−2)^{th} connection pin with an image data transmission terminal; and
in response to the second mode configuration signal, connect a (b+1)^{th} connection pin to a (b+M−2)^{th} connection pin with the image data transmission terminal.

5. The electronic device according to claim 4, wherein the image data transmission terminal comprises: a first differential signal transmission terminal and a second differential signal transmission terminal;
N=4, and the gating circuit is further configured to:
in response to the first mode configuration signal, provide the camera power supply voltage to the 1^{st} connection pin, establish a conducting path between a 2^{nd} connection pin and the first differential signal transmission terminal, establish a conducting path between a 3^{rd} connection pin and the second differential signal transmission terminal, and connect the 4^{th} connection pin with the ground terminal; and
in response to the second mode configuration signal, provide the camera power supply voltage to the 4^{th} connection pin, establish a conducting path between the 2^{nd} connection pin and the second differential signal transmission terminal, establish a conducting path between the 3^{rd} connection pin and the first differential signal transmission terminal, and connect the 1^{st} connection pin with the ground terminal.

6. (canceled)

7. The electronic device according to claim 3, wherein the gating circuit comprises: a multiplexer and a first switch circuit;
the logic controller is further configured to output a voltage output enable signal;
the first switch circuit is connected with the logic controller and the multiplexer, respectively, and is configured to: receive the voltage output enable signal, and in response to the voltage output enable signal, provide the camera power supply voltage to the multiplexer; and
the multiplexer is connected with the logic controller and the 1^{st} connection pin to the N^{th} connection pin, respectively, and is configured to:
receive the first mode configuration signal, and in response to the first mode configuration signal, provide the camera power supply voltage to the a^{th} connection pin, connect an (a+1)^{th} connection pin to an (a+M−2)^{th} connection pin with the image data transmission terminal, and connect the (a+M−1)^{th} connection pin with the ground terminal; and
receive the second mode configuration signal; and in response to the second mode configuration signal, provide the camera power supply voltage to the (b+M−1)^{th} connection pin, connect a (b+1)^{th} connection pin to a (b+M−2)^{th} connection pin with the image data transmission terminal, and connect the b^{th} connection pin with the ground terminal.

8. The electronic device according to claim 7, wherein the logic controller is further configured to, based on determining that the camera detection signal is an un-access detection signal, output a third mode configuration signal and a voltage output disable signal;
the first switch circuit is further configured to receive the voltage output disable signal, and in response to the voltage output disable signal, stop operation; and
the multiplexer is further configured to receive the third mode configuration signal, and in response to the third mode configuration signal, stop operation.

9. The electronic device according to claim 8, wherein the logic controller is further configured to, based on determining that the display device is in a sleep state or a hibernate state, send the voltage output disable signal to the first switch circuit.

10. The electronic device according to claim 9, further comprising: a system controller, wherein the system controller is connected with the logic controller;
the system controller is configured to: based on recognizing that the display device is in the sleep state, output a sleep recognition signal to the logic controller, and based on recognizing that the display device is in the hibernate state, output a hibernate recognition signal to the logic controller; and
the logic controller is further configured to: based on receiving the sleep recognition signal, determine that the display device is in the sleep state, and based on receiving the hibernate recognition signal, determine that the display device is in the hibernate state.

11. The electronic device according to claim 8, wherein the logic controller is further configured to: based on determining that the display device is in a closed state, send the voltage output disable signal to the first switch circuit, and based on determining that the display device is not in the closed state, obtain the camera detection signal.

12. The electronic device according to claim 11, wherein the display device further comprises: a second magnetic field sensor and a closure magnet;
the second magnetic field sensor is configured to: in response to the closure magnet, output a first screen state recognition signal to the logic controller, and output, by default, a second screen state recognition signal to the logic controller; and
the logic controller is further configured to: based on determining that the first screen state recognition signal is received, determine that the display device is in the closed state, and based on determining that the second screen state recognition signal is received, determine that the display device is not in the closed state.

13. (canceled)

14. The electronic device according to claim 11, further comprising: a system controller, wherein the system controller is connected with the logic controller;
the system controller is configured to: based on recognizing that the display device is in an operating state, output an operation recognition signal to the logic controller; and
the logic controller is further configured to: based on receiving the operation recognition signal, determine whether the display device is in a closed state.

15. The electronic device according to claim 2, wherein the display device further comprises: a first magnetic field sensor;
the camera module further comprises: a first camera magnet and a second camera magnet, wherein a north pole (N pole) of the first camera magnet is provided facing the second connector and a south pole (S pole) of the second camera magnet is provided facing the second connector; and
the first magnetic field sensor is configured to: when the first connector is mounted to the second connector, in response to the N pole of the first camera magnet, output a camera detection signal corresponding to the forward access detection signal to the detection control circuit and in response to the S pole of the second camera magnet, output a camera detection signal corresponding to the reverse access detection signal to the detection control circuit.

16. The electronic device according to claim 3, wherein the M^{th} connection contact is connected with the (M−1)^{th} connection contact via an electromagnetic switch;
the display device further comprises: a first pull-up resistor, a second pull-up resistor, and a switch control circuit;
wherein a first pull-up voltage is provided to the 1st connection pin through the first pull-up resistor, and a second pull-up voltage is provided to the N^{th} connection pin through the second pull-up resistor; and the 1^{st} connection pin and the N^{th} connection pin are connected with the logic controller through the switch control circuit, and the 2^{nd} connection pin to the (N−1)^{th} connection pin is connected with the ground terminal through the switch control circuit; and
the logic controller is further configured to: when a conducting path is established between the logic controller and the 1^{st} connection pin and a conducting path is established between the logic controller and the N^{th} connection pin, via the switch control circuit respectively, obtain a pin level signal of the 1^{st} connection pin and a pin level signal of the N^{th} connection pin, and take the pin level signal of the 1^{st} connection pin and the pin level signal of the N^{th} connection pin as the camera detection signal; when the pin level signal of the 1^{st} connection pin is a first level signal and the pin level signal of the N^{th} connection pin is a second level signal, determine that the camera detection signal is the forward access detection signal, and when the pin level signal of the 1^{st} connection pin is the second level signal and the pin level signal of the N^{th} connection pin is the first level signal, determine that the camera detection signal is the reverse access detection signal.

17. The electronic device according to claim 16, wherein the switch control circuit is further configured to: in response to a switch control enable signal, establish the conducting path between the 1^{st} connection pin and the logic controller as well as the conducting path between the N^{th} connection pin and the logic controller, and establish a conducting path between each of the 2^{nd} connection pin to (N−1)^{th} connection pin and the ground terminal; and in response to a switch control disable signal, disconnect the 1^{st} connection pin and the N^{th} connection pin from the logic controller, and disconnect the 2^{nd} connection pin to the (N−1)^{th} connection pin from the ground terminal.

18. The electronic device according to claim 17, wherein the logic controller is further configured to: based on determining that the camera detection signal is the forward access detection signal and based on determining that the camera detection signal is the reverse access detection signal, output the switch control disable signal to the switch control circuit.

19. The electronic device according to claim 17, wherein the logic controller is further configured to: based on determining that the first connector is disconnected from the second connector, output the switch control enable signal to the switch control circuit.

20. The electronic device according to claim 19, further comprising: a system controller, wherein the system controller is configured to: based on recognizing that the first connector is disconnected from the second connector, output a camera disconnect signal to the logic controller; and
the logic controller is further configured to: in response to the camera disconnect signal, determine that the first connector is disconnected from the second connector.

21. The electronic device according to claim 2, wherein N≥M, N is an odd number, and the detection control circuit comprises: a logic controller, and a gating circuit; wherein
the logic controller is configured to: obtain a camera presence detection signal based on determining that the display device is in an operating state, output a voltage output enable signal based on determining that the camera presence detection signal is a valid signal, and output a voltage output disable signal based on determining that the camera presence detection signal is an invalid signal; and
the gating circuit is connected with the logic controller and a ((N+1)/2)^{th} connection pin, respectively, and is configured to:
receive the voltage output enable signal, and in response to the voltage output enable signal, provide the camera power supply voltage to the ((N+1)/2)^{th} connection pin; and
receive the voltage output disable signal, and in response to the voltage output disable signal, stop providing the camera power supply voltage to the ((N+1)/2)^{th} connection pin.

22-31. (canceled)

32. The electronic device according to claim 2, wherein N≥M, N is an odd number, and connection pins corresponding to the same function are in mirror symmetric with respect to a ((N+1)/2)^{th} connection pin.

33-49. (canceled)
